(19) United States
(12) Patent Application Publication
(10) Pub. No.: US 2025/0310943 A1
(43) Pub. Date: Oct. 2, 2025

(54) METHOD AND APPARATUS FOR HANDLING FREQUENCY RESOURCES IN ACCESS PROCEDURE IN A WIRELESS COMMUNICATION SYSTEM

(71) Applicant: ASUS Technology Licensing Inc., Taipei City (TW)

(72) Inventors: Ming-Che Li, Taipei City (TW); Yi-Hsuan Huang, Taipei City (TW); Meng-Hui Ou, Taipei City (TW); Yu-Hsuan Guo, Taipei City (TW); Wei-Han Lai, Taipei City (TW)

(21) Appl. No.: 19/086,507

(22) Filed: Mar. 21, 2025

Related U.S. Application Data
(60) Provisional application No. 63/572,059, filed on Mar. 29, 2024.

(51) Int. Cl. H04W 72/0453; H04W 4/70; H04W 4/80

(52) U.S. Cl. CPC H04W 72/0453; H04W 4/70; H04W 4/80

(57) ABSTRACT

Methods, systems, and apparatuses are provided for handling frequency resources in access procedures in a wireless communication system, wherein a method of a first device comprises monitoring or receiving a first Reader-to-Device (R2D) transmission, comprising a first message for triggering a random access procedure, in a first R2D frequency resource, wherein the first message indicates multiple Device-to-Reader (D2R) frequency resources, determining a first D2R frequency resource from the multiple D2R frequency resources, performing a first D2R transmission on the (determined) first D2R frequency resource, and monitoring a second R2D transmission for a response in a second R2D frequency resource in response to (performing) the first D2R transmission, wherein the second R2D frequency resource is overlapped with the first R2D frequency resource in frequency domain.

### CROSS-REFERENCE TO RELATED APPLICATIONS

The present application claims priority to and the benefit of U.S. Provisional Patent Application Ser. No. 63/572,059, filed Mar. 29, 2024, which is fully incorporated herein by reference.

### FIELD

This disclosure generally relates to wireless communication networks and, more particularly, to a method and apparatus for handling frequency resources in access procedures in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling frequency resources in access procedures in a wireless communication system. Accordingly, a User Equipment (UE) can perform access procedures and/or communications with Frequency Division Multiplexing (FDM).

In various embodiments, a method of a first device comprises monitoring or receiving a first Reader-to-Device (R2D) transmission, comprising a first message for triggering a random access procedure, in a first R2D frequency resource, wherein the first message indicates multiple Device-to-Reader (D2R) frequency resources, determining a first D2R frequency resource from the multiple D2R frequency resources, performing a first D2R transmission on the (determined) first D2R frequency resource, and monitoring a second R2D transmission for a response in a second R2D frequency resource in response to (performing) the first D2R transmission, wherein the second R2D frequency resource is overlapped with the first R2D frequency resource in frequency domain.

In various embodiments, a method of a reader comprises transmitting a first R2D transmission, comprising a first message for triggering a random access procedure, in a first R2D frequency resource, wherein the first message indicates multiple D2R frequency resources, receiving one or more first D2R transmissions from the multiple D2R frequency resources, and transmitting one or more second R2D transmissions for one or more responses in a second R2D frequency resource in response to (receiving) the one or more first D2R transmissions, wherein the second R2D frequency resource is overlapped with the first R2D frequency resource in frequency domain.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6-18: Link timing, from EPC® Radio-Frequency Identity Generation-2 UHF RFID Standard.

FIG. 6 is a reproduction of Table 6-30: Select command, from EPC® Radio-Frequency Identity Generation-2 UHF RFID Standard.

FIG. 7 is a reproduction of Table 6-33: Query command, from EPC® Radio-Frequency Identity Generation-2 UHF RFID Standard.

FIG. 8 is a reproduction of Table 6-34: Tag reply to a Query command, from EPC® Radio-Frequency Identity Generation-2 UHF RFID Standard.

FIG. 9 is a reproduction of Figure E-1: Example diagram of RFID design for Tag inventory and access, from EPC® Radio-Frequency Identity Generation-2 UHF RFID Standard, where inventory operation utilizes slot-based ALOHA, in accordance with embodiments of the present invention.

FIG. 10 is a reproduction of FIG. 3: Frequency resource for Ambient IoT DL transmission, from R1-2400563.

FIG. 11 is a reproduction of FIG. 1: Example of A-IoT time-domain frame structure, from R1-2401446.

FIG. 12A is a reproduction of FIG. 3(a): Topology 1 Option 1, from R1-2401446.

FIG. 12B is a reproduction of FIG. 3(b): Topology 1 Option 2, from R1-2401446.

FIG. 12C is a reproduction of FIG. 3(c): Topology 1 Option 3, from R1-2401446.

FIG. 13 is a reproduction of FIG. 13: Group-common FL command and FDM of multiple BL transmission/backscattering for random access procedures for multiple A-IoT devices, from R1-2401446.

FIG. 14 is a reproduction of FIG. 4.2.1.1-1: Topology 1, from 3GPP TR 38.848 V18.0.0 (2023-09).

FIG. 15 is a reproduction of FIG. 4.2.1.2-1: Topology 2, from 3GPP TR 38.848 V18.0.0 (2023-09).

FIG. 16 is an example diagram showing that a network/intermediate node may in parallel/separately/independently perform/support a 1st access procedure in a 1st (pair of) frequency bandwidth, a 2nd access procedures in a 2nd (pair of) frequency bandwidth, and a 3rd access procedure in a 3rd (pair of) frequency bandwidth, in accordance with embodiments of the present invention.

FIG. 17 is an example diagram showing that a network/intermediate node may perform/support a 1st access procedure in a 1st (pair of) frequency bandwidth, a 2nd (pair of) frequency bandwidth, and a 3rd (pair of) frequency bandwidth, in accordance with embodiments of the present invention.

FIG. 18 is an example diagram showing that a network/intermediate node may perform/support one or multiple access procedures in a 1st access procedure in a 1st (pair of) frequency bandwidth, a 2nd (pair of) frequency bandwidth, and a 3rd (pair of) frequency bandwidth, in accordance with embodiments of the present invention.

FIG. 19 is a flow diagram of a method of a UE comprising receiving a first signaling indicating/initiating an access procedure in a first (pair of) frequency bandwidths, receiving a second signaling indicating/initiating the access procedure in a second (pair of) frequency bandwidth, selecting/determining a (pair of) frequency bandwidth from the first (pair of) frequency bandwidth and the second (pair of) frequency bandwidth for performing/initiating the access procedure, and performing the access procedure on the selected/determined (pair of) frequency bandwidth, in accordance with embodiments of the present invention.

FIG. 20 is a flow diagram of a method of a UE comprising receiving a signaling(s) indicating/initiating an access procedure, wherein the signaling(s) indicates multiple (pair of) frequency bandwidths, selecting/determining a (pair of) frequency bandwidth from the multiple (pair of) frequency bandwidths, and performing the access procedure on the selected/determined (pair of) frequency bandwidth, in accordance with embodiments of the present invention.

FIG. 21 is a flow diagram of a method of a UE comprising performing/initiating an access procedure in a first (pair of) frequency bandwidth, receiving a specific indication/signaling for switching the first (pair of) frequency bandwidth to a third (pair of) frequency bandwidth, and performing a (data or control) communication operation in the third (pair of) frequency bandwidth, in accordance with embodiments of the present invention.

FIG. 22 is a flow diagram of a method of a first device comprising monitoring or receiving a first R2D transmission, comprising a first message for triggering a random access procedure, in a first R2D frequency resource, wherein the first message indicates multiple D2R frequency resources, determining a first D2R frequency resource from the multiple D2R frequency resources, performing a first D2R transmission on the (determined) first D2R frequency resource, and monitoring a second R2D transmission for a response in a second R2D frequency resource in response to (performing) the first D2R transmission, wherein the second R2D frequency resource is overlapped with the first R2D frequency resource in frequency domain, in accordance with embodiments of the present invention.

FIG. 23 is a flow diagram of a method of a reader comprising transmitting a first R2D transmission, comprising a first message for triggering a random access procedure, in a first R2D frequency resource, wherein the first message indicates multiple D2R frequency resources, receiving one or more first D2R transmissions from the multiple D2R frequency resources, and transmitting one or more second R2D transmissions for one or more responses in a second R2D frequency resource in response to (receiving) the one or more first D2R transmissions, wherein the second R2D frequency resource is overlapped with the first R2D frequency resource in frequency domain, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] EPC® Radio-Frequency Identity Generation-2 UHF RFID Standard, Specification for RFID Air Interface Protocol for Communications at 860 MHz-930 MHz, Release 3.0, Ratified, January 2024; [2] RP-234058, “Study on solutions for Ambient IoT (Internet of Things) in NR.”; [3] RAN1 Chair's Notes for 3GPP TSG RAN WG1 #106 (Athens, Greece, Feb. 26-Mar. 1, 2024); [4] 3GPP TS 38.211 V17.6.0 (2023-09) 3GPP; TSG RAN; NR; Physical channels and modulation (Release 17); [5] R1-2400563, “Discussion on frame structure and timing aspects for Ambient IoT”, Xiaomi; [6] R1-2401446, “Frame structure and timing aspects”, Qualcomm Incorporated; and [7] 3GPP TR 38.848 V18.0.0 (2023-09) 3GPP; TSG RAN; Study on Ambient IoT (Internet of Things) in RAN (Release 18). The standards and documents listed above are hereby expressly and fully incorporated herein by reference in their entirety.

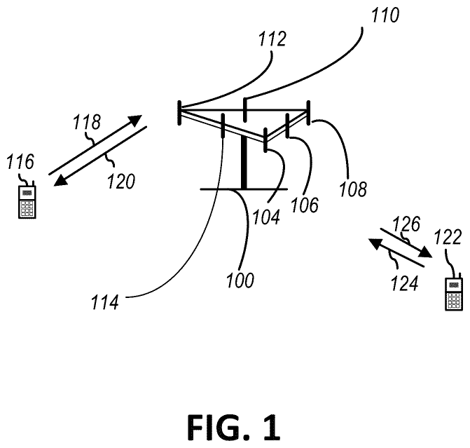

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

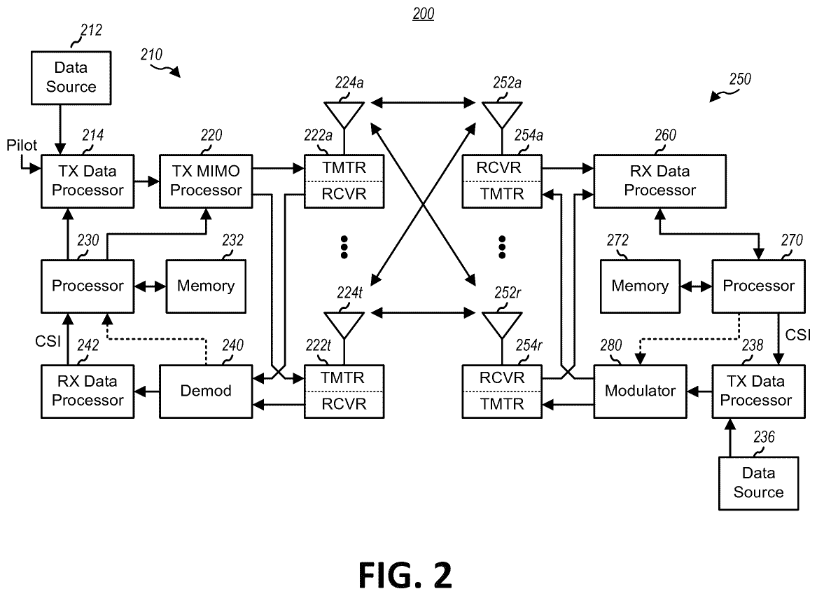

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

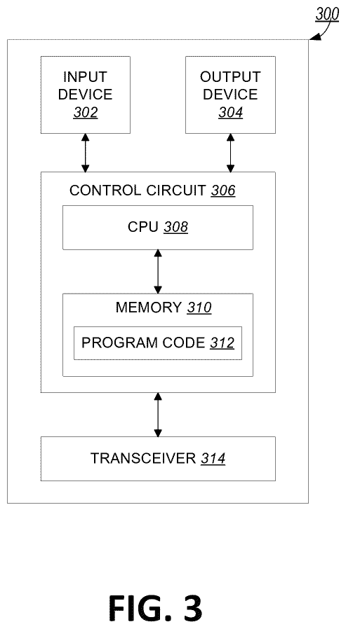

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

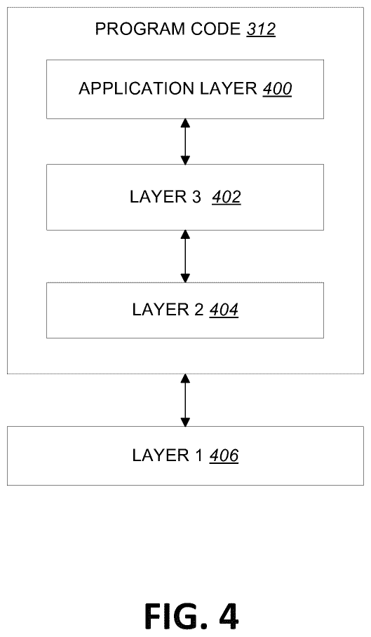

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] EPC® Radio-Frequency Identity Generation-2 UHF RFID Standard, it specifies link timing and Tag population management, including select, inventory, and access.

### Quotation [1] Start

### 6.3.1.6 Link Timing

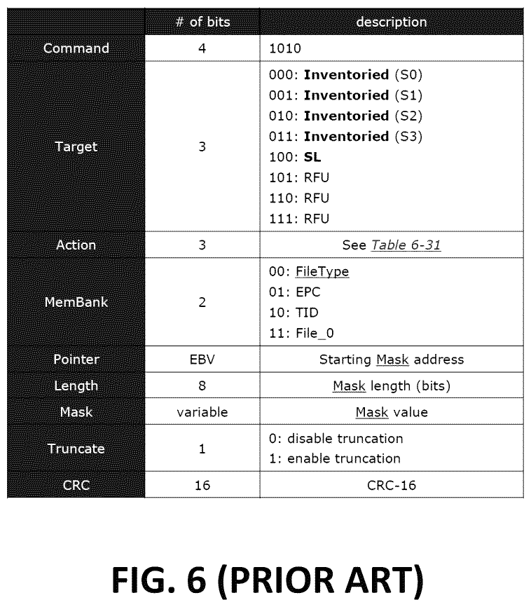

FIG. 6-18 illustrates R=>T and T=>R link timing. The figure (not drawn to scale) defines Interrogator interactions with a Tag population . . . . FIG. 6-18 illustrates three types of Tag reply timing denoted immediate, delayed, and in-process . . . . FIG. 6-18 also illustrates timing for QueryX and for QueryX followed by QueryY that may start a T₈ timeout as defined in 6.3.1.6.5.

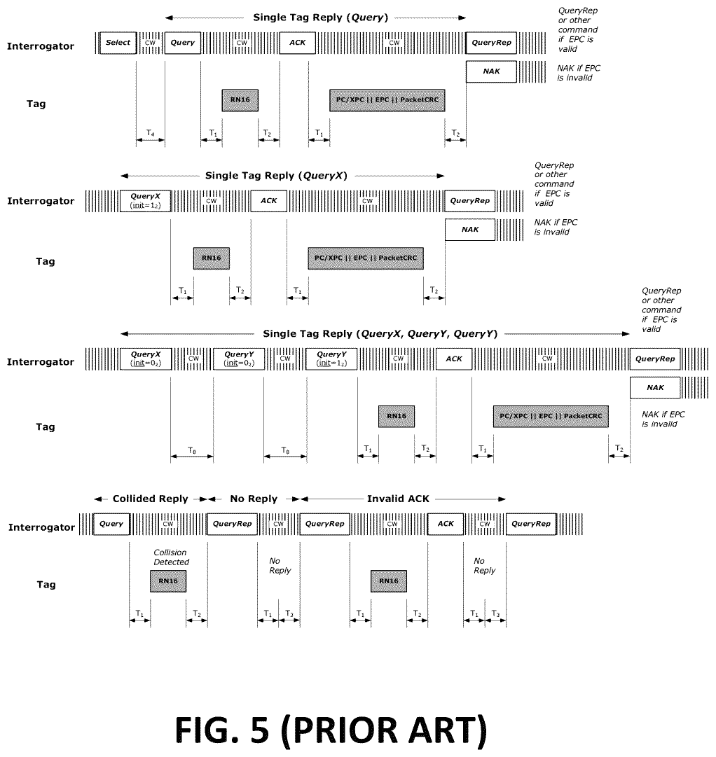

FIG. 5 is a Reproduction of FIG. 6-18: Link Timing, from EPC® Radio-Frequency Identity Generation-2 UHF RFID Standard.

### 6.3.2.6.8 Slot Counter

Tags shall implement a 15-bit slot counter. Upon receiving a Query, QueryX with Init=1₂, QueryY with Init=1₂ or QueryAdjust command a Tag shall load into its slot counter a value between 0 and 2_{Q}−1, drawn from the Tag's RNG (see 6.3.2.7). Q is an integer in the range (0, 15). A Query or QueryX specifies Q; a QueryAdjust may modify Q from the prior Query or QueryX.

Tags in the arbitrate state decrement their slot counter every time they receive a QueryRep with matching Session, transitioning to the reply state and backscattering an RN16 (or RN16∥CRC-5) when their slot counter reaches 0000ₕ. Tags whose slot counter reached 0000ₕ, who replied, and who were not acknowledged (including Tags that responded to an original Query, QueryX or QueryY and that were not acknowledged) shall return to arbitrate with a slot value of 0000ₕ and shall decrement this slot value from 0000ₕ to 7FFFₕ at the next QueryRep. The slot counter shall be capable of continuous counting, meaning that, after the slot counter rolls over to 7FFFₕ it begins counting down again, thereby effectively preventing subsequent replies until the Tag loads a new random value into its slot counter. See also Annex J.

### 6.3.2.8 Managing Tag Populations

Interrogators manage Tag populations using the three basic operations shown in FIG. 6-22. Each of these operations comprises multiple commands. The operations are defined as follows:
a. Select: The process by which an Interrogator selects a Tag population for subsequent inventory or cryptographically challenges a Tag population for subsequent authentication. Select comprises the Select and Challenge commands. An Interrogator may also use QueryX command followed by zero or more QueryY commands to select a population of Tags based on a value or values in Tag memory.
b. Inventory: The process by which an Interrogator identifies Tags. An Interrogator begins an inventory round by transmitting a Query or QueryX command in one of four sessions. If the Interrogator sends a QueryX, the Interrogator can continue filtering Tags participating in the inventory round using one or more QueryY commands. After beginning an inventory round, one or more Tags may reply. The Interrogator detects a single Tag reply and requests the PC, optional XPC word(s), EPC (Query or QueryX) or TID (QueryX), and CRC-16 from the Tag. An inventory round operates in one and only one session at a time. Annex E shows an example of an Interrogator inventorying and accessing a single Tag. Inventory comprises multiple commands.
c. Access: The process by which an Interrogator transacts with (reads, writes, authenticates, or otherwise engages with) an individual Tag. An Interrogator singulates and uniquely identifies a Tag prior to access. Access comprises multiple commands.

### 6.3.2.9 Selecting Tag Populations

The select process comprises two commands, Select and Challenge. Select allows an Interrogator to select a Tag population for subsequent inventorying. Challenge allows an Interrogator to challenge a Tag population for subsequent authentication. Select and Challenge are the only two commands that an Interrogator may issue prior to inventory, and they are not mutually exclusive (i.e. an Interrogator may issue both a Select and a Challenge prior to starting an inventory round). Select is a mandatory command; Challenge is optional.

An Interrogator may also use QueryX command followed by zero or more QueryY commands to select a population of Tags based on a value or values in Tag memory.

A Select command allows an Interrogator to select a particular Tag population prior to inventorying. The selection is based on user-defined criteria, enabling union (∪), intersection (∩), and negation (˜) based Tag partitioning. Interrogators perform U and n operations by issuing successive Select commands. Select can assert or deassert a Tag's SL flag, or it can set a Tag's inventoried flag to either A or B in any one of the four sessions.

Upon receiving a Select, a not-killed Tag returns to the ready state, evaluates the criteria, and depending on the evaluation may modify the indicated SL or inventoried flag. A Query, QueryX or QueryY command uses these flags to choose which Tags participate in a subsequent inventory round. An Interrogator may inventory and access SL or ˜SL Tags, or it may choose to not use the SL flag at all. Select may begin with a Tag in any state except killed, and ends with a Tag in ready.

Select contains the parameters Target, Action, MemBank, Pointer, Length, Mask, and Truncate.
Target and Action indicate whether and how a Select modifies a Tag's SL or inventoried flag, and in the case of an inventoried flag, for which session. A Select that modifies the SL flag does not modify an inventoried flag, and vice versa.
MemBank specifies if the Mask applies to EPC, TID, or User memory. Select commands apply to a single memory bank. Successive Selects may apply to different memory banks.
Pointer, Length, and Mask: Pointer and Length describe a memory range. Mask, which is Length bits long, contains a bit string that a Tag compares against the specified memory range.
Truncate specifies whether a Tag backscatters its entire EPC, or only that portion of the EPC immediately following Mask, when replying to an ACK.

### 6.3.2.10 Inventorying Tag Populations

The inventory command set includes Query, QueryX, QueryY, QueryAdjust, QueryRep, ACK, and NAK. Query, QueryX, and QueryY begin an inventory round and decide which Tags participate in the round (“inventory round” is defined in 4.1).

An inventory round starts with initialization.
Query begins and completes initialization of an inventory round.
QueryX begins initializing an inventory round, and the same QueryX or a subsequent QueryY completes initialization of an inventory round using the Init=1₂ parameter (see 6.3.2.12.2.2 and 6.3.2.12.2.3). While initializing an inventory round, an Interrogator may filter a population of Tags with user-defined criteria in QueryX and QueryY.

Tags participate in an inventory round if they match the criteria in the Query, QueryX, or QueryX/QueryY(s) that completed initialization of the inventory round. Query and QueryX contain a slot-count parameter Q, and a QueryY uses the Q value from the QueryX that preceded the QueryY. Upon receiving a Query, QueryX with Init=1₂, or QueryY with Init=1₂, participating Tags pick a random value in the range (0, 2_{Q}−1), inclusive, and load this value into their slot counter. Participating Tags that pick a slot counter value that is:
zero, transition to the reply state and reply immediately; or
nonzero, transition to the arbitrate state and await a QueryAdjust or QueryRep command.

Assuming a single Tag replies, the inventorying proceeds as follows:
a. The Tag backscatters an RN16 or an RN16∥CRC-5 as it enters reply,
b. The Interrogator acknowledges the Tag with an ACK containing this same RN16,
c. The acknowledged Tag transitions to the acknowledged state, backscattering a reply as in Table 6-18, and
d. The Interrogator issues a QueryAdjust or QueryRep, causing the identified Tag to invert its inventoried flag (i.e. A→B or B—+A) and transition to ready, and potentially causing another Tag to initiate a query-response dialog with the Interrogator, starting in step (a), above.

If the Tag fails to receive the ACK in step (b) within time T₂₍ₘₐₓ₎ (see FIG. 6-18), or receives the ACK with an erroneous RN16, then it returns to arbitrate.

If multiple Tags reply in step (a) but the Interrogator, by detecting and resolving collisions at the waveform level, can resolve an RN16 from one of the Tags, the Interrogator can ACK the resolved Tag. Unresolved Tags receive erroneous RN16s and return to arbitrate without backscattering the reply shown in Table 6-18.

If the Interrogator sends a valid ACK (i.e. an ACK containing the correct RN16) to the Tag in the acknowledged state, the Tag re-backscatters the reply shown in Table 6-18.

At any point the Interrogator may issue a NAK, in response to which all Tags in the inventory round that receive the NAK return to arbitrate without changing their inventoried flag.

After issuing a Query, QueryX with Init=1₂, or QueryY with Init=1₂ to initialize an inventory round, the Interrogator typically issues one or more QueryAdjust or QueryRep commands. Without introducing new Tags into the round, QueryAdjust instructs a Tag to load the slot counter with a new random value in the range (0, 2_{Q}−1) with Q incremented or decremented as specified by QueryAdjust. QueryRep decrements the slot counter without changing any parameters and without introducing new Tags into the round. An inventory round can contain multiple QueryAdjust or QueryRep commands. At some point the Interrogator will issue a new Query or QueryX, thereby starting a new inventory round.

Tags in the arbitrate or reply states that receive a QueryAdjust first adjust Q (increment, decrement, or leave unchanged), then pick a random value in the range (0, 2_{Q}−1), inclusive, and load this value into their slot counter. Tags that pick zero transition to the reply state and reply immediately. Tags that pick a nonzero value transition to the arbitrate state and await a QueryAdjust or a QueryRep command. Tags in the arbitrate state decrement their slot counter when they receive a QueryRep and if a Tag's slot counter reaches 0000ₕ, then the Tag transitions to the reply state and backscatters an RN16 (or an RN16∥CRC-5). Tags whose slot counter reached 0000ₕ, who replied, and who were not acknowledged (including Tags that responded to the original Query, QueryX, or QueryY and that were not acknowledged) return to arbitrate with a slot value of 0000ₕ and decrement this slot value from 0000ₕ to 7FFFₕ at the next QueryRep, thereby effectively preventing subsequent replies until the Tag loads a new random value into its slot counter.

Although Tag inventory is based on a random protocol, the Q-parameter affords network control by allowing an Interrogator to regulate the probability of Tag responses. Q is an integer in the range (0,15); thus, the associated Tag-response probabilities range from 2₀=1 to 2₋₁₅=0.000031.

Annex D describes an exemplary Interrogator algorithm for choosing Q.

The scenario outlined above assumed a single Interrogator operating in a single session. However, as described in 6.3.2.2, an Interrogator can inventory a Tag population in one of four sessions. Furthermore, as described in 6.3.2.12.2, the Query, QueryX, QueryY, QueryAdjust, and QueryRep commands each contain a Session parameter. How a Tag responds to these commands varies with the command, Session parameter, and Tag state, as follows:
Query, QueryX: A Query or QueryX command begins an inventory round and chooses the session for the round. Tags in any state except killed execute a Query or QueryX. A Query, QueryX with Init=1₂, or QueryY with Init=1₂ completes initialization of an inventory round in the specified session and the Tag transitions to ready, arbitrate, or reply, as appropriate (see FIG. 6-21).
   . . .
QueryAdjust, QueryRep: Tags in any state except ready or killed execute a QueryAdjust or QueryRep command if, and only if, (i) the Session parameter in the command matches the Session parameter in the Query or QueryX that began the round, and (ii) the Tag is not in the middle of a Kill- or Access-command sequence (see 6.3.2.12.3.5 or 6.3.2.12.3.7, respectively). Tags ignore a QueryAdjust or QueryRep with mismatched session.
   . . .

To illustrate an inventory operation, consider a specific example: Assume a population of 64 powered Tags in the ready state. An Interrogator first issues a Select to select a subpopulation of Tags. Assume that 16 Tags match the selection criteria. Further assume that 12 of the 16 selected Tags have their inventoried flag set to A in session S0. The Interrogator issues a Query specifying (SL, Q=4, S0, A). Each of the 12 Tags picks a random number in the range (0,15) and loads the value into its slot counter. Tags that pick a zero respond immediately. The Query has 3 possible outcomes:
a. No Tags reply: The Interrogator may issue a QueryX or another Query, or it may issue a QueryAdjust or QueryRep.
b. One Tag replies (see FIG. 6-23): The Tag transitions to the reply state and backscatters an RN16. The Interrogator acknowledges the Tag by sending an ACK. If the Tag receives the ACK with a correct RN16 it backscatters the reply shown in Table 6-18 and transitions to the state. If the Tag receives the ACK with an incorrect RN16 it transitions to arbitrate. Assuming a successful ACK, the Interrogator may either access the acknowledged Tag or issue a QueryAdjust or QueryRep with matching Session parameter to invert the Tag's inventoried flag from A→B and send the Tag to ready (a Query or QueryX with matching prior-round Session parameter will also invert the inventoried flag from A→B).
c. Multiple Tags reply: The Interrogator observes a backscattered waveform comprising multiple RN16s. It may try to resolve the collision and issue an ACK; not resolve the collision and issue a QueryAdjust, QueryRep, or NAK; or quickly identify the collision and issue a QueryAdjust or QueryRep before the collided Tags have finished backscattering. In the latter case the collided Tags, not observing a valid reply within time T₂₍ₘₐₓ₎ (see FIG. 6-18), return to arbitrate and await the next Query, QueryX or QueryAdjust command

As with other examples of one tag reply (see FIG. 6-23), a QueryX begins an inventory round with a filtering criterion to inventory a subpopulation of tags. If a Tag receives a QueryX with ReplyCRC=1₂ that starts an inventory round, the Tag will backscatter RN16∥CRC-5 if the Tag replies. If a Tag receives a QueryX with AckData=10₂ that starts an inventory round, the Tag will backscatter the traceable part of TID memory starting at address 00ₕ and ending at the last word of serialization.

### 6.3.2.11 Accessing Individual Tags

An Interrogator may choose to access a Tag after acknowledging it. The access commands are Req_RN, Read, ReadVar, Write, Lock, Kill, Access, BlockWrite, BlockErase, BlockPermalock, Authenticate, ReadBuffer, SecureComm, AuthComm, KeyUpdate, Untraceable, FileOpen, FileList, FilePrivilege, FileSetup, and TagPrivilege. A Tag shall execute access commands only in the states shown in Table 6-28. A Tag shall treat as invalid (see Table C-34) optional access commands that it does not support. See Annex K for an example of a data-flow exchange during which an Interrogator accesses a Tag and reads its kill password.

Access always begins with an Interrogator moving a Tag from the acknowledged state to either the open or the secured state as follows:
Step 1: The Interrogator issues a Req_RN to the acknowledged Tag.
Step 2: The Tag generates and stores a new RN16 (denoted handle), backscatters the handle, and transitions to the open state if its access password is nonzero, or to the secured state if its access password is zero. The Interrogator may now issue further access commands.

All access commands include a Tag's handle. Upon receiving an access command a Tag verifies that the handle is correct prior to executing the command, and does not execute access commands with an incorrect handle. The handle value is fixed for the entire duration of a Tag access.

An Interrogator may issue an ACK to a Tag in the open or secured states, with the Tag's handle as the RN in the command, thereby causing the Tag to backscatter the reply shown in Table 6-18.

As shown in Table 6-28, some access commands require a prior Req_RN and some a prior authentication before execution. A Tag's response to an access command includes, at a minimum, the Tag's handle; the response may include other information as well (for example, the result of a Read). An Interrogator shall verify the correctness of the handle in a Tag's response to an access command.

The Authenticate and Access commands provide the only means to transition a Tag from the open state to the secured state. The Authenticate command or a faulty security command provide the only means to transition a Tag from the secured state back to the open state. See Table C-21 and Table C-34. The privileges that a Tag in the open state grants to an Interrogator depend on the authorization level of the open state. The privileges that a Tag in the secured state grants to an Interrogator depend on the authorization level of the access or authentication that most recently moved the Tag to that state. An Interrogator that moved a Tag to the secured state using one means (for example, an Access command) may later cause the Tag to re-enter the secured state using a different means (for example, an Authenticate command), affording the Interrogator different privileges. See 6.3.2.11.2 for a discussion of privileges and keys.

A Tag may enter the secured state by means of a:
Req_RN: If a Tag's access password is zero then the Tag transitions from the acknowledged state to the secured state at the beginning of access (i.e. upon receiving a Req_RN), bypassing the open state.
Access: A Tag whose access password is nonzero transitions from the open or secured state to the secured state upon successfully executing an Access-command sequence.
Authenticate: A Tag transitions from the open or secured state to the secured state upon successfully executing an Interrogator or mutual authentication.

A Tag may limit an Interrogator's access to the secured state via one or more physical mechanisms. For example, a Tag may require that its received RF power exceed a threshold before it will enter the secured state. This protocol does not specify such physical mechanisms but allows them at a Tag manufacturer's discretion.

An Interrogator and a Tag can communicate indefinitely in the open or secured states. The Interrogator may end the communications at any time by issuing a Select, Challenge, Query, QueryX, QueryAdjust, QueryRep, or NAK. The Tag's response to a Query, QueryX, QueryY, QueryAdjust, or QueryRep is described in 6.3.2.10. A NAK causes all Tags in the inventory round to return to arbitrate without changing their inventoried flag(s).

Interrogators in some regulatory regions are required to hop frequency at periodic intervals, ending the inventory round and any access operations. Unfortunately, some cryptographic operations take longer than a hop interval to complete. This protocol allows a cryptographic suite to specify that a Tag retain one or more cryptographic state variables during a temporary power loss such as a frequency hop, and allows an Interrogator to re-acquire the Tag in a subsequent inventory round and resume the cryptographic operation.

This protocol recommends that Interrogators avoid powering-off while a Tag is in the reply, acknowledged, open or secured states. Rather, Interrogators should end (or in the case of a long cryptographic operation, suspend) their dialog with a Tag before powering off, leaving the Tag in either the ready or arbitrate state.

This protocol partitions the access commands into the subclasses Core, Security, and File Management (see also Table 6-28). The purpose of this subclass partitioning is solely for ease of discussion and the particular subclass does not convey or deny requirements to or from any access command.

### 6.3.2.12.1 Select Commands

The select command set comprises Select and Challenge.

### 6.3.2.12.1.1 Select (Mandatory)

Interrogators and Tags shall implement the Select command shown in Table 6-30. A Select allows an Interrogator to select a Tag subpopulation based on user-defined criteria, enabling union (∪), intersection (∩), and negation (˜) based Tag partitioning. Interrogators perform U and n operations by issuing successive Select commands. An Interrogator may also select a Tag subpopulation using QueryX and QueryY commands. Select can assert or deassert a Tag's SL flag, which applies across all four sessions, or it can set a Tag's inventoried flag to either A or B in any one of the four sessions. A Tag executes a Select from any state except killed. Select passes the following parameters from Interrogator to Tags:
Target indicates whether the Select modifies a Tag's SL flag or its inventoried flag, and in the case of inventoried it further specifies one of four sessions. A Select that modifies the SL flag shall not modify an inventoried flag, and vice versa . . . .

A Tag shall not reply to a Select.

FIG. 6 is a Reproduction of Table 6-30: Select Command, from EPC® Radio-Frequency Identity Generation-2 UHF RFID Standard.

### 6.3.2.12.2 Inventory Commands

The inventory command set comprises Query, QueryX, QueryY, QueryAdjust, QueryRep, ACK, and NAK.

### 6.3.2.12.2.1 Query (Mandatory)

Interrogators and Tags shall implement the Query command shown in Table 6-33. Query initiates and specifies an inventory round. Query includes the following fields:
DR (TRcal divide ratio) sets the T=>R backscatter link frequency as described in 6.3.1.2.8 and Table 6-9.
M (cycles per symbol) sets the T=>R data rate and modulation format as shown in Table 6-10.
TRext chooses whether a Tag prepends the T=>R preamble with a pilot tone as described in 6.3.1.3.2.2 and 6.3.1.3.2.4. A Tag's reply to a command that uses a delayed or an in-process reply (see 6.3.1.6) always uses an extended preamble regardless of the TRext value.
Sel (select SL flag) chooses which Tags respond to the Query (see 6.3.2.12.1.1 and 6.3.2.10).
Session chooses a session for the inventory round (see 6.3.2.10).
Target selects whether Tags whose inventoried flag is A or B participate in the inventory round. Tags may change their inventoried flag from A to B (or vice versa) as a result of being singulated.
Q sets the number of slots in the round (see 6.3.2.10).

An Interrogator shall prepend a Query with a preamble (see 6.3.1.2.8).

An Interrogator shall not encapsulate a Query in a SecureComm or AuthComm (see Table 6-29).

The CRC-5 that protects a Query is calculated over the first command-code bit to the last Q bit. If a Tag receives a Query with a CRC-5 error then it shall treat the command as invalid (see Table C-34).

Upon receiving a Query, Tags with matching Sel and Target shall pick a random value in the range (0, 2_{Q}−1), inclusive, and shall load this value into their slot counter. If a Tag, in response to the Query, loads its slot counter with zero, then its reply to a Query shall be as shown in Table 6-34 using the immediate reply type specified in 6.3.1.6.1; otherwise the Tag shall remain silent.

A Query may initiate an inventory round in a new session or in the prior session. If a Tag in the acknowledged, open, or secured states receives a Query whose Session parameter matches the prior session it shall invert its inventoried flag (i.e. A→B or B→A) for the session before it evaluates whether to transition to ready, arbitrate, or reply. If a Tag in the acknowledged, open, or secured states receives a Query whose Session parameter does not match the prior session it shall leave its inventoried flag for the prior session unchanged when beginning the new round.

A Tag shall support all DR and M values specified in Table 6-9 and Table 6-10, respectively.

A Tag in any state other than killed shall execute a Query command, starting a new round in the specified session and transitioning to ready, arbitrate, or reply, as appropriate (see FIG. 6-21). A Tag in the killed state shall ignore a Query.

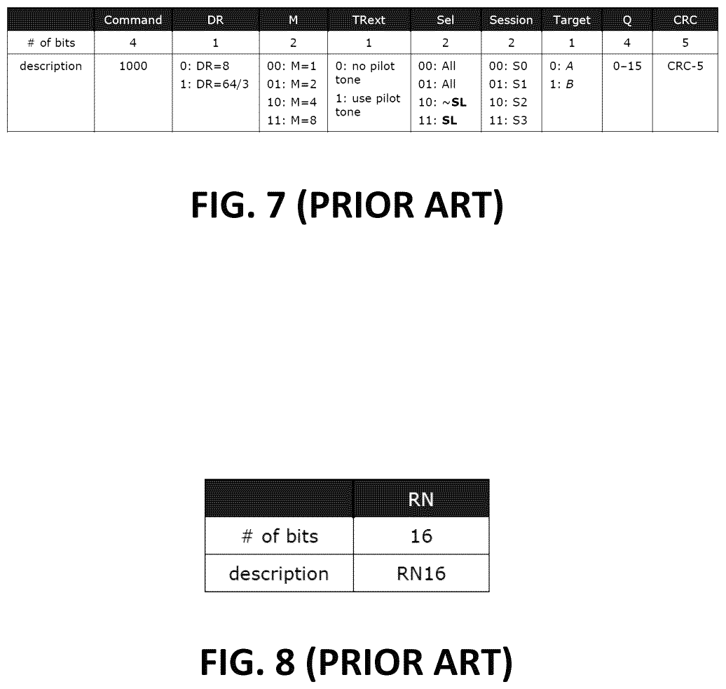

FIG. 7 is a Reproduction of Table 6-33: Query Command, from EPC® Radio-Frequency Identity Generation-2 UHF RFID Standard.
FIG. 8 is a Reproduction of Table 6-34: Tag Reply to a Query Command, from EPC® Radio-Frequency Identity Generation-2 UHF RFID Standard.

### E.1 Example Inventory and Access of a Single Tag

Figure E-1 shows the steps by which an Interrogator inventories and accesses a single Tag using Query.

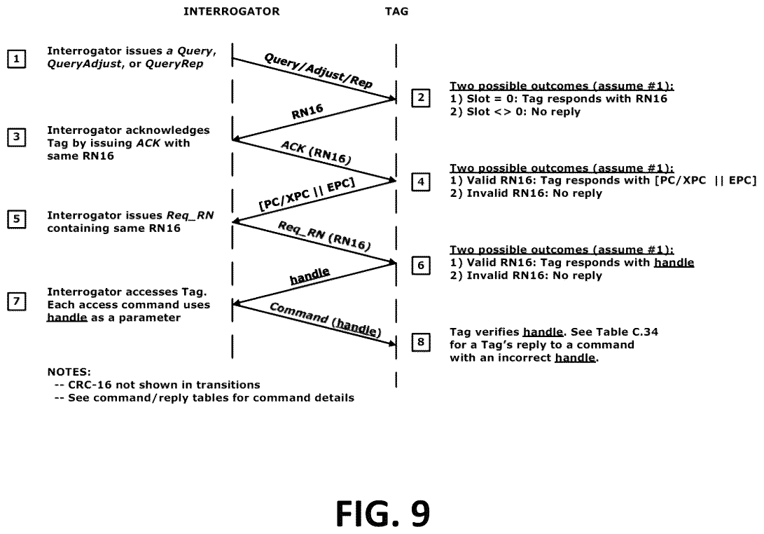

FIG. 9 is a Reproduction of Figure E-1: Example Diagram of RFID Design for Tag Inventory and Access, from EPC® Radio-Frequency Identity Generation-2 UHF RFID Standard, where Inventory Operation Utilizes Slot-Based ALOHA, in Accordance with Embodiments of the Present Invention.

### Quotation [1] End

The study item of ambient Internet of Things (IoT) has been approved in the RAN plenary #102 meeting. The description is specified in [2] RP-234058, as provided below:

### Quotation [2] Start

### 3 Justification

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting batteryless devices with no energy storage capability or devices with energy storage that do not need to be replaced or recharged manually. The form factor of such devices must be reasonably small to convey the validity of target use cases.

TR 22.840 is being developed by SA1 to capture use cases, traffic scenarios, device constraints of ambient power-enabled Internet of Things and identify new potential service requirements as well as new KPIs. SAL are considering devices being either battery-less or with limited energy storage capability (i.e., using a capacitor) and the energy is provided through the harvesting of radio waves, light, motion, heat, or any other power source that could be seen suitable. Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

An example type of application in TR 22.840 is asset identification, which presently has to resort mainly to barcode and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

TSG RAN has completed a Rel-18 RAN-level SI on Ambient IoT, which provides a terminological and scoping framework for future discussions of Ambient IoT. This has defined representative use cases, deployment scenarios, connectivity topologies, Ambient IoT devices, design targets, and required functionalities; it also conducted a preliminary feasibility assessment, and gave recommendations for down-selection in setting the scope of a further WG-level study.

### 4 Objective

### 4.1 Objective of SI or Core Part WI or Testing Part WI

This study targets a further assessment at RAN WG-level of Ambient IoT, a new 3GPP IoT technology, suitable for deployment in a 3GPP system, which relies on ultra-low complexity devices with ultra-low power consumption for the very-low end IoT applications. The study shall provide clear differentiation, i.e. addressing use cases and scenarios that cannot otherwise be fulfilled based on existing 3GPP LPWA IoT technology e.g. NB-IoT including with reduced peak Tx power.

### General Scope

The definitions provided in TR 38.848 are taken into this SI, and the following are the exclusive general scope:
A. The overall objective shall be to study a harmonized air interface design with minimized differences (where necessary) for Ambient IoT to enable the following devices:
   i. ˜1 μW peak power consumption, has energy storage, initial sampling frequency offset (SFO) up to 104 ppm, neither DL nor UL amplification in the device. The device's UL transmission is backscattered on a carrier wave provided externally.
   ii. ≤a few hundred μW peak power consumption¹, has energy storage, initial sampling frequency offset (SFO) up to 10 ppm, both DL and/or UL amplification in the device. The device's UL transmission may be generated internally by the device, or be backscattered on a carrier wave provided externally.
   X is to be decided in WGs.
   Coverage design target: Maximum distance of 10-50 m with device indoors as per TR 38.848: “ . . . a range that WGs can sub-select within”.
   For Topologies 1 & 2 (UE as intermediate node under NW control) per TR 38.848, with no RRC states, no mobility (i.e. at least no cell selection/re-selection-like function), no HARQ, no ARQ.
   NOTE 1: It is to be understood that “≤a few hundred μW” means WGs are not tasked with setting a particular value, and that it will be for WG discussions to determine if a presented design with corresponding power consumption satisfies the “≤a few hundred μW” requirement.
B. Deployment Scenarios with the following characteristics, referenced to the tables in Clause 4.2.2 of TR 38.848:
   Deployment scenario 1 with Topology 1
      Basestation and coexistence characteristics: Micro-cell, co-site
   Deployment scenario 2 with Topology 2 and UE as intermediate node, under network control
      Basestation and coexistence characteristics: Macro-cell, co-site
      The location of intermediate node is indoor
C. FR1 licensed spectrum in FDD.
D. Spectrum deployment in-band to NR, in guard-band to LTE/NR, in standalone band(s).
E. Traffic types DO-DTT, DT, with focus on rUC1 (indoor inventory) and rUC4 (indoor command).
   From RAN #104, the study will assess whether the harmonized air interface design (per bullet ‘A’ above) can address the DO-A (Device-originated autonomous) use case, only to identify which part(s) of the harmonized air interface design (per bullet ‘A’ above) is/are not sufficient for the DO-A use case.

Transmission from Ambient IoT device (including backscattering when used) can occur at least in UL spectrum.

The following objectives are set, within the General Scope:

### 1. Evaluation Assumptions

a) Conclude at least the following aspects of design targets left to WGs in Clause 5 (RAN design targets) of TR 38.848 [RAN1].
   Clause 5.3: Applicable maximum distance target values(s)
   Clause 5.6: Refine the definition of latency suitable for use in RAN WGs
   Clause 5.8: 2D distribution of devices
b) Define necessary further evaluation assumptions of deployment scenarios for coverage and coexistence evaluations [RAN1, RAN4]
c) Identify basic blocks/components of possible Ambient IoT device architectures, taking into account state of the art implementations of low-power low-complexity devices which meet the RAN design target for power consumption and complexity. [RAN1]

2. Study necessary and feasible solutions for Ambient IoT as prescribed in the General Scope, including decisions on which functions, procedures, etc. are needed and not needed, and ensuring at least the required functionalities in Section 6.2 of TR 38.848.
Study of positioning in Rel-19 is RAN3-led, limited to functionalities which would have no, or minimal, specification impact (note: this does not imply any decision relating to WI creation).
Study the feasibility and required functionalities for proximity determination (coordination with SA3 is required for privacy aspects).
RAN1-led:
   For the Ambient IoT DL and UL:
      Frame structure, synchronization and timing, random access
      Numerologies, bandwidths, and multiple access
      Waveforms and modulations
      Channel coding
      Downlink channel/signal aspects
      Uplink channel/signal aspects
      Scheduling and timing relationships
      Study necessary characteristics of carrier-wave waveform for a carrier wave provided externally to the Ambient IoT device, including for interference handling at Ambient IoT UL receiver, and at N_{R} basestation.
         For Topology 2, no difference in physical layer design from Topology 1.
RAN2-led:
   Study and decide which functions are needed for an Ambient IoT compact protocol stack and lightweight signalling procedure to enable DO-DTT and DT data transmission, and study those functions.
      For example:
         Paging
         Random access
         Data transmission, including necessary radio resource control aspects, respecting the limitation in the General Scope

### Quotation [2] End

In the 3GPP RAN1 #116 meeting ([3] RAN1 Chair's Notes for 3GPP TSG RAN WG1 #106), there are some agreements on Ambient IoT:

### Quotation [3] Start

For the purpose of the study, RAN1 uses the following terminologies:
Device 1: ˜1 μW peak power consumption, has energy storage, initial sampling frequency offset (SFO) up to 10^{X} ppm, neither DL nor UL amplification in the device. The device's UL transmission is backscattered on a carrier wave provided externally.
Device 2a: ≤a few hundred u W peak power consumption, has energy storage, initial sampling frequency offset (SFO) up to 10^{X} ppm, both DL and/or UL amplification in the device. The device's UL transmission is backscattered on a carrier wave provided externally.
Device 2b: ≤a few hundred μW peak power consumption, has energy storage, initial sampling frequency offset (SFO) up to 10^{X} ppm, both DL and/or UL amplification in the device. The device's UL transmission is generated internally by the device.
   . . .

At least the following bandwidths for R2D are defined for the purpose of the study:
Transmission bandwidth, B_{tx,R2D} from a Reader perspective: The frequency resources used for transmitting R2D
Occupied bandwidth, B_{occ,R2D} from a Reader perspective: The frequency resources used for transmitting R2D, and potential guard band.

$${B}_{occ , R 2 D} \geq {B}_{tx , R 2 D}$$

FFS: Further constraint(s) e.g. B_{occ,R2D}=B_{tx,R2D}.

From RAN1 perspective, at least when a response is expected from multiple devices that are intended to be identified, an A-IoT contention-based access procedure initiated by the reader is used.

For A-IoT contention-based access procedure, at least slotted-ALOHA based access is studied.

At least the following time domain frame structure is studied for A-IoT R2D and D2R transmission.
For R2D transmission,
   A R2D timing acquisition signal (e.g. R2D preamble) is included at least for timing acquisition and for indicating the start of the R2D transmission in time domain.
For D2R transmission,
   A D2R timing acquisition signal (e.g. D2R preamble) is included at least for timing acquisition and for indicating the start of the D2R transmission in time domain.
FFS other necessary component(s), e.g. midamble, postamble, periodic sync signal, control fields, guard period
   . . .

For further discussion, the following terminologies are used for A-IoT for studying processing time aspects:
T_{R2D_min}: Minimum Time between a R2D transmission and the corresponding D2R transmission following it.
T_{D2R_min}: Minimum Time between a D2R transmission and the corresponding R2D transmission following it.
T_{R2D_R2D_min}: Minimum Time between two different consecutive R2D transmissions to the same A-IoT device.
T_{D2R_D2R_min}: Minimum Time between two different consecutive D2R transmissions from the same A-IoT device.
The study should consider at least following aspects
   Implementation restrictions for the existing BS/UE
   [Processing time is common or different for different A-IoT devices]
   [Processing time for different traffic types/command types (e.g. DT or DO-DTT) and/or different use case (e.g., Inventory or Command)]
      . . .

For ambient IoT devices, a dedicated physical broadcast channel for R2D, e.g. PBCH-like, is not considered for study.

For ambient IoT devices, at least for R2D data transmission, a physical channel (PRDCH) is studied,
System information (if defined) is transmitted on the PRDCH
FFS Whether/how control information is transmitted on the PRDCH

For ambient IoT devices, at least for D2R data transmission, a physical channel (PDRCH) is studied along with the following,
Response transmitted from device to reader during contention-based access procedure is transmitted on the PDRCH
   FFS: Details of response
FFS Whether/how/what D2R control information (if defined) is transmitted on the PDRCH

### Quotation [3] End

In TS 38.211 ([4] 3GPP TS 38.211 V17.6.0 (2023-09)), Frame structure and timing in NR Uu interface are specified:

### Quotation [4] Start

### 4 Frame Structure and Physical Resources

### 4.2 Numerologies

Multiple OFDM numerologies are supported as given by Table 4.2-1 where μ and the cyclic prefix for a downlink or uplink bandwidth part are obtained from the higher-layer parameters subcarrierSpacing and cyclicPrefix, respectively.

TABLE 4.2-1
Supported transmission numerologies.

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

### 4.3.2 Slots

For subcarrier spacing configuration μ, slots are numbered

$${n}_{s}^{μ} ∈ \{ 0 , … , {N}_{slot}^{subframe , μ} - 1 \}$$

in increasing order within a subframe and

$${n}_{s , f}^{μ} ∈ \{ 0 , … , {N}_{slot}^{frame , μ} - 1 \}$$

in increasing order within a frame. There are

$${N}_{symb}^{slot}$$

consecutive OFDM symbols in a slot where

$${N}_{symb}^{slot}$$

depends on the cyclic prefix as given by Tables 4.3.2-1 and 4.3.2-2. The start of slot

$${n}_{s}^{μ}$$

in a subframe is aligned in time with the start of OFDM symbol

$${n}_{s}^{μ} {N}_{symb}^{slot}$$

in the subframe.

OFDM symbols in a slot in a downlink or uplink frame can be classified as ‘downlink’, ‘flexible’, or ‘uplink’. Signaling of slot formats is described in clause 11.1 of [5, TS 38.213].

In a slot in a downlink frame, the UE shall assume that downlink transmissions only occur in ‘downlink’ or ‘flexible’ symbols.

In a slot in an uplink frame, the UE shall only transmit in ‘uplink’ or ‘flexible’ symbols.

. . .

TABLE 4.3.2-1
Number of OFDM symbols per slot, slots per frame,
and slots per subframe for normal cyclic prefix.

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

### 4.4 Physical Resources

. . .

### 4.4.2 Resource Grid

For each numerology and carrier, a resource grid of

$${N}_{grid , x}^{size , μ} {N}_{sc}^{RB}$$

subcarriers and

$${N}_{symb}^{subframe , μ}$$

OFDM symbols is defined, starting at common resource block

$${N}_{grid}^{start , μ}$$

indicated by higher-layer signalling. There is one set of resource grids per transmission direction (uplink, downlink, or sidelink) with the subscript x set to DL, UL, and SL for downlink, uplink, and sidelink, respectively. When there is no risk for confusion, the subscript x may be dropped. There is one resource grid for a given antenna port p, subcarrier spacing configuration μ, and transmission direction (downlink, uplink, or sidelink).

For uplink and downlink, the carrier bandwidth

$${N}_{grid}^{size , μ}$$

for subcarrier spacing configuration μ is given by the higher-layer parameter carrierBandwidth in the SCS-SpecificCarrier IE. The starting position

$${N}_{grid}^{start , μ}$$

for subcarrier spacing configuration μ is given by the higher-layer parameter offsetToCarrier in the SCS-SpecificCarrier IE.

The frequency location of a subcarrier refers to the center frequency of that subcarrier.

### 4.4.3 Resource Elements

Each element in the resource grid for antenna port p and subcarrier spacing configuration μ is called a resource element and is uniquely identified by (k, l)_{p,μ} where k is the index in the frequency domain and/refers to the symbol position in the time domain relative to some reference point. Resource element (k, l)_{p,μ} corresponds to a physical resource and the complex value

$${a}_{k , l}^{( p , μ )} .$$

when there is no risk for confusion, or no particular antenna port or subcarrier spacing is specified, the indices p and u may be dropped, resulting in

$${a}_{k , l}^{( p )}$$

a_{k,l}.

### 4.4.4 Resource Blocks

### 4.4.4.1 General

A resource block is defined as

$${N}_{sc}^{RB} = 12$$

consecutive subcarriers in the frequency domain.
. . .

### 4.4.4.4 Physical Resource Blocks

Physical resource blocks for subcarrier spacing configuration μ are defined within a bandwidth part and numbered from 0 to

$${N}_{BWP , i}^{size , μ} - 1$$

where i the number of the bandwidth part. The relation between the physical resource block

$${n}_{PRB}^{μ}$$

in bandwidth part i and the common resource block n_{CRB}^{μ} is given by

$${n}_{CRB}^{μ} = {n}_{PRB}^{μ} + {N}_{BWP , i}^{start , μ}$$

where

$${N}_{BWP , i}^{start , μ}$$

is the common resource block where bandwidth part i starts relative to common resource block 0. When there is no risk for confusion the index u may be dropped.

### 4.4.5 Bandwidth Part

A bandwidth part is a subset of contiguous common resource blocks defined in clause 4.4.4.3 for a given numerology μᵢ in bandwidth part i on a given carrier. The starting position

$${N}_{BWP , i}^{start , μ}$$

and the number of resource blocks

$${N}_{BWP , i}^{size , μ}$$

in a bandwidth part shall fulfil

$${N}_{grid , x}^{start , μ} \leq {N}_{BWP , i}^{start , μ} < {N}_{grid , x}^{start , μ} + {N}_{grid , x}^{size , μ} and {N}_{grid , x}^{start , μ} < {N}_{BWP , i}^{start , μ} + {N}_{BWP , i}^{size , μ} \leq {N}_{grid , x}^{start , μ} + {N}_{grid , x}^{size , μ} ,$$

respectively. Configuration of a bandwidth part is described in clause 12 of [5, TS 38.213].

A UE can be configured with up to four bandwidth parts in the downlink with a single downlink bandwidth part being active at a given time. The UE is not expected to receive PDSCH, PDCCH, or CSI-RS (except for RRM) outside an active bandwidth part.

A UE can be configured with up to four bandwidth parts in the uplink with a single uplink bandwidth part being active at a given time. If a UE is configured with a supplementary uplink, the UE can in addition be configured with up to four bandwidth parts in the supplementary uplink with a single supplementary uplink bandwidth part being active at a given time. The UE shall not transmit PUSCH or PUCCH outside an active bandwidth part. For an active cell, the UE shall not transmit SRS outside an active bandwidth part.

### Quotation [4] End

In 3GPP RAN1 #116 meeting, there are some contributions (e.g., [5] R1-2400563 and [6] R1-2401446) for discussion on Ambient IoT:

### Quotation [5] Start

### 3. Random Access

Then, a RFID-like asynchronous random access procedure can be considered as a starting point, in which one round of random access procedure is composed by a set occasions and used for a population of devices to establish connection with the gNB or intermediate UE. It is started by a DL command like Query in RFID, and can be divided into 2^{Q} occasions. For each occasion, the starting boundary is marked by another DL command like QueryRep and until the next time reception of this command.

Proposal 3: In Ambient IoT, One Round of Random Access is Composed by a Set of Occasions and Used for a Population of Devices to Establish Connection with the gNB or Intermediate UE
Each round of random access is started by a DL command like Query in RFID which can be divided into 2^{Q} occasions;
For each random access occasion, the starting boundary is marked by a DL command like QueryRep in RFID and until the next time reception of this command.
   . . .

### Proposal 5: In One Occasion of Random Access, the Following Procedures can be Considered as Starting Point:

A random binary stream is generated and transmitted as temporary identification of a device (similar to RN16);
An “ACK” signalling for contention resolution is transmitted by gNB or intermediate UE;
After successful access, Ambient IoT device(s) can transmit the Device ID (e.g., EPC code) to gNB or intermediate UE, and optional subsequent DL/UL data transmission/reception can be performed b/w the device and gNB or intermediate UE.

### 4. Frame Structure

### Frequency Domain Structure

In NB-IoT, one or more PRBs can be used for transmission, this kind of alignment with NR/LTE system can obtain better performance and improve the resource efficiency, especially for in-band deployment scenario. Further, with the implementation of a narrow band for transmission, the device complexity and peak power consumption can be limited accordingly. Another reason is that the peak data rate in Ambient IoT is not very high (maximum not less than 5 kbps, and minimum not less than 0.1 kbps). Thus, based on above analysis, for DL, one or more PRBs can be used for Ambient IoT transmission.

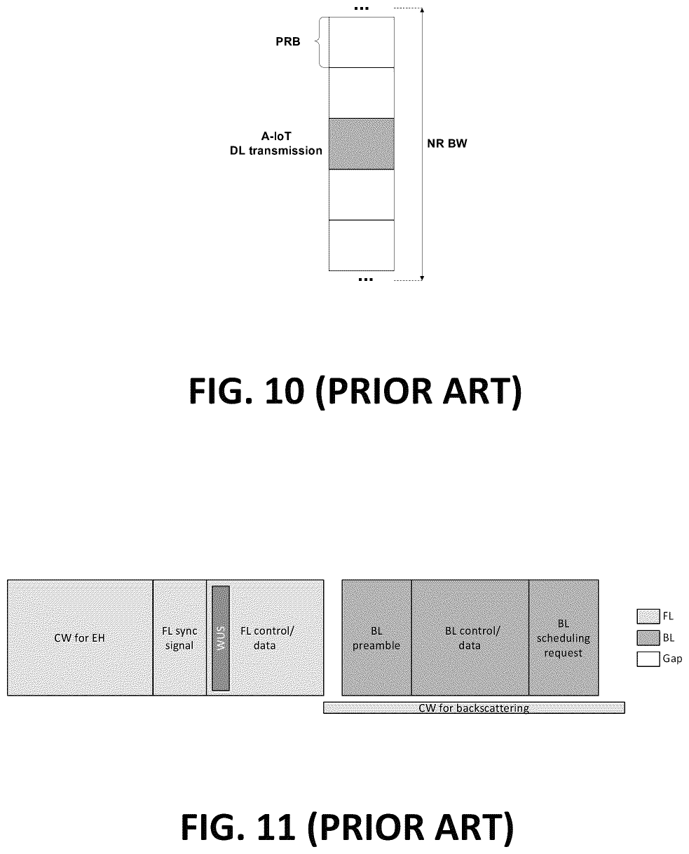

FIG. 10 is a Reproduction of FIG. 1: Frequency Resource for Ambient IoT DL Transmission, from R1-2400563.

### Proposal 6: For DL Frequency Domain Structure, One or More PRBs can be Used for Ambient IoT DL Transmission.

For Ambient IoT UL transmission, since it is a kind of backscattering transmission based on the receiving CW of a device, and only simple and limited number of hardware components can be arranged at least in a type i device, i.e., amplifier, oscillator, and FFT module may not be arranged at least for type i device. So, from our perspective, at least single carrier transmission can be supported for Ambient IoT UL transmission, i.e., a single channel bandwidth is occupied by a device for UL transmission. To align with the NR resource grid, especially for the in-band scenario, the single carrier bandwidth size can be an integer multiple numbers of subcarrier size in NR.

Proposal 7: For UL Frequency Domain Structure, the Resource for Transmission can at Least be a Sing Carrier Bandwidth, the Size of the Bandwidth can be an Integer Multiple Numbers of Subcarrier Size of NR, e.g., 15 kHz, 30 kHz, 150 kHz, 300 KHz, Etc.

### Quotation [5] End

### Quotation [6] Start

### 3. Frame Structure

### 3.1 Time-Domain Aspects

Considering the peak power consumptions, complexities/costs, and form factors of A-IoT devices, none of the existing NR signals/channels are suitable for A-IoT. In high-level, we think following should be considered as a unified frame structure for A-IoT as the starting point.
Forward link (FL) (Reader to A-IoT device):
   A Carrier wave (CW) for energy harvest (EH)
      For charging energy storage of A-IoT devices, or to turn-on A-IoT devices.
   FL synchronization signal
      For A-IoT devices to synchronize its clock, timing, and frequency.
   FL control
      Necessary information for FL data reception/pursing and/or BL backscattering/transmission.
      FL control could indicate target A-IoT device(s) of the FL transmission, such that other irrelevant devices can sleep—this can be viewed as a kind of wake-up signal (WUS)
   FL data
      Data information from Reader to A-IoT device.
   Carrier wave (CW) for backscattering
      For A-IoT device 1/2a to backscatter its backward link (BL)
Backward link (BL) (A-IoT device to reader)
   BL random access signal
      For “message 1” of inventory procedure.
   BL preamble/midamble associated with BL control/data
      For reader to identify/recover A-IoT device's clock, timing, and frequency for BL control/data reception.
   BL control
      Control information, if necessary.
   BL data
      Data information from A-IoT device to Reader.
   BL scheduling request
      For A-IoT device to request scheduling BL to transfer further data information for DO-DTT.
         FIG. 11 is a Reproduction of FIG. 1: Example of a-IoT Time-Domain Frame Structure, from R1-2401446.

### Proposal 1:

Study time domain frame structure such that it can support different types of devices based on a unified design
   FIG. 1 can be a starting point for discussion

### 3.2 Frequency-Domain Aspects

In this section, we discuss the frame structure from the frequency-domain point of view, taking into account that the operation is on a FR1 licensed spectrum in FDD that is a paired spectrum of downlink (DL) and uplink (UL).

### 3.2.1 Topology 1

. . .

### Option 1: FL/CW and BL for Device 1/2a on FDD-DL, BL for Device 2b on FDD-UL

In this option, BS transmits FL and CW for backscattering. Device 1/2a backscatters its BL on FDD-DL around the CW from the BS. Device 2b transmits its BL on FDD-UL. BS is supposed to be capable of transmitting CW and receiving BL from device 1/2a on FDD-DL, meaning that BS is capable of full-duplex operation. There could be potential regulatory concern on this option due to non-BS entities backscattering on FDD-DL, although the negative impact from this would practically be quite small. From A-IoT device point of view, device 1/2a can be operated using only FDD-DL, while device 2b has to support both FDD-DL and FDD-UL.

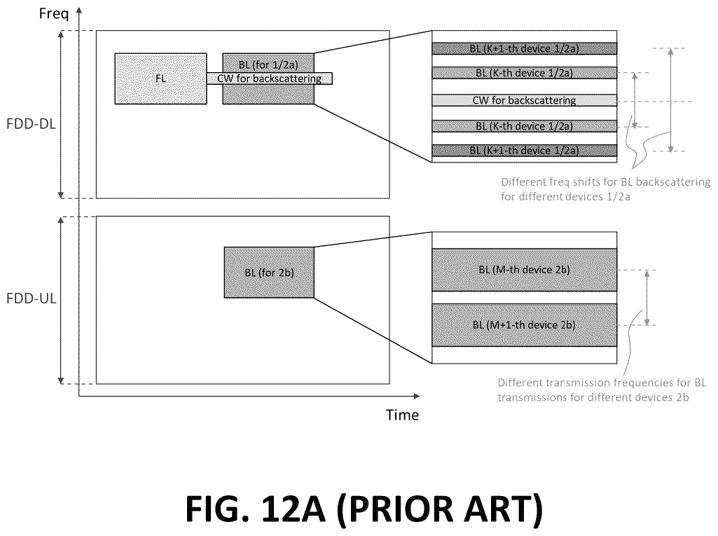

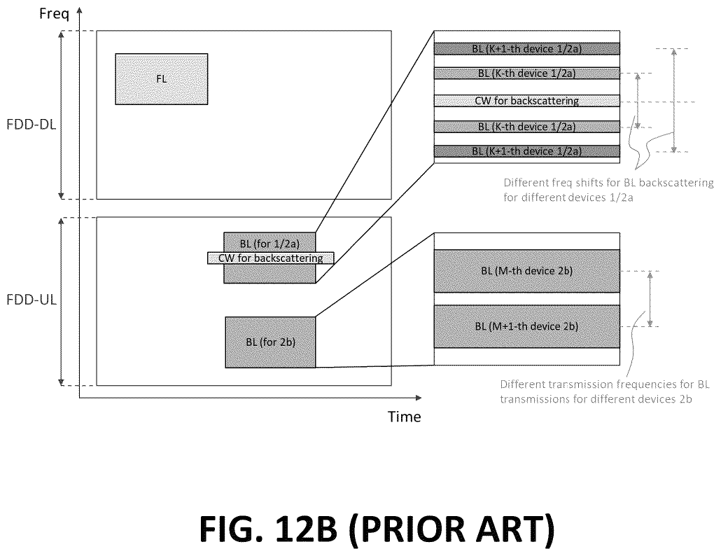

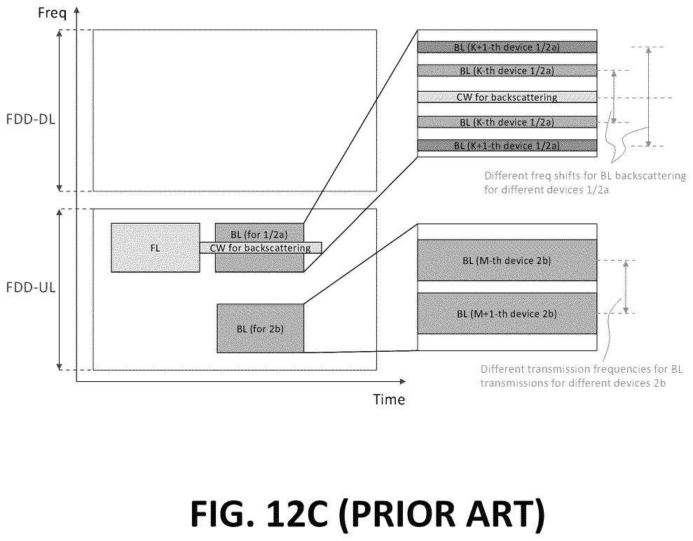

FIG. 12a is a Reproduction of FIG. 3(a): Topology 1 Option 1, from R1-2401446.

### Option 2: FL on FDD-DL, CW/BL on FDD-UL

In this option, BS transmits FL on FDD-DL and CW on FDD-UL. Device 1/2a backscatters BL around CW on FDD-UL, and device 2b transmits BL on FDD-UL. There would be regulatory issue if the CW transmission on FDD-UL is done by BS transmitter. To resolve this, introducing UE-like network entity, that complies with all the UE RF requirement on FDD-UL, for the CW transmission, can be considered. With the new entity, BS full-duplex for CW transmission and BL reception is not required. From A-IoT device point of view, all the devices must support both FDD-DL and FDD-UL.

FIG. 12B is a reproduction of FIG. 3(b): Topology 1 Option 2, from R1-2401446.

### Option 3: FL/CW/BL on FDD-UL

In this option, BS transmits FL and CW on FDD-UL. Due to the same reason mentioned in Option 2, this FL/CW transmission on FDD-UL would have to be done by a UE-like network entity that complies with all the UE RF requirements on FDD-UL. However, this is effectively equal to Topology 3, wherein A-IoT device receives FL data/signalling from an assisting node. Given that Topology 3 has been excluded in the study, this option would not be in the scope.

FIG. 12C is a reproduction of FIG. 3(c): Topology 1 Option 3, from R1-2401446.
. . .

### 6.2 Random Access Framework

### 6.2.1 UHF RFID Case Study

. . .

### 6.2.2 Basic Random Access Procedure for A-IoT Inventory

As presented in Section 6.2.1, UHF RFID inventory procedure can be viewed as a reader-triggered multi-step random access procedure. A tag can be identified by reader through the multiple message exchanges while the initial message ‘RN16’ is just a random number. Similarly, LTE/NR random access procedure can also be viewed as BS-triggered (BS-configured) multi-step (4-step or 2-step) random access procedure, where the UE is identified by BS through contention-resolution steps while the initial message is just a random access preamble. Those two systems adopt similar procedures though the exact messages are different.

Random access procedure for A-IoT inventory should consider similar multi-step procedure. Necessary number of steps and exact messages of the steps should be studied. With smaller number of steps per round (e.g., 2-step), A-IoT device may need to transmit its (full or almost full) device identification at an early step (e.g., via random access channel), enabling lower latency per round in theory, while causing larger delay if there are collisions and re-transmissions. With larger number of steps per round (e.g., 4-step), random access channel can carry temporary/limited information, enabling smaller delay in case of collisions and re-transmissions, while higher latency per round in theory. Detailed studies should take place in either RAN1 or RAN2.

Note that the random access procedure for A-IoT inventory would need to be multi-round as well. Since each A-IoT device is not able to identify collision/failure of random access channel detection at reader, next round should be available for failed A-IoT devices.

### Proposal 9:

Study multi-step and multi-round random access procedure for A-IoT inventory
   UHF RFID inventory procedure with Q protocol and LTE/NR 4-step/2-step random access procedure could be starting points of the discussion

### 6.2.3 Enhancements for Random Access Procedure for A-IoT Inventory

Although the random access procedure may be RAN2's working area as explained in Section 6.2.2, RAN1 should study physical layer aspects to address the issues. Below, we list some aspects that we think should be studied based on the discussion in 6.2.1.

Discussion 1: Whether to Enable Simultaneous Random Access Procedures for Multiple a-IoT Devices

In UHF RFID, one inventory round can inventory one RFID tag. However, this is inefficient for inventory of many devices in a limited time.

In the legacy LTE/NR, gNB can receive/detect multiple PRACH preambles at a given T/F resource (as long as preambles are different). For this case, a PDSCH for Msg-2 can carry multiple RAR messages responding to different PRACH preambles detected on the same T/F resource using the common RA-RNTI. Different RAR messages in a PDSCH responding to different PRACH preambles schedules Msg3 PUSCH transmissions on different T/F resources. In summary, PRACH can be multiplexed on the same T/F resource, and Msg-2 can carry multiple response messages for different UEs.

A-IoT can consider similar operation. For example, FL command(s) for random access procedure can be group-common for multiple A-IoT devices similar to the PDSCH carrying multiple RAR messages mentioned above. BL backscattering/transmission from different A-IoT devices can be multiplexed, at least in frequency-domain. For device 2b that transmits BL with generated carrier frequency, its transmission frequency can be controlled by itself and hence must be feasible. For device 1/2a, assuming BL backscattering is based on square wave modulation [4], different frequencies of square waves can be used by different A-IoT devices, enabling different frequency offsets from the CW for backscattering.

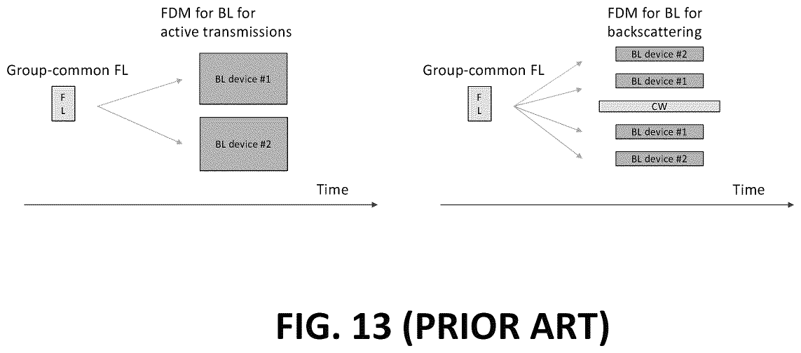

FIG. 13 is a Reproduction of FIG. 13: Group-Common FL Command and FDM of Multiple BL Transmission/Backscattering for Random Access Procedures for Multiple a-IoT Devices, from R1-2401446.

### Quotation [6] End

The description (e.g., regarding scenario, topology, and assumption) for ambient IoT could be found in [7] 3GPP TR 38.848 V18.0.0 (2023 September):

### Quotation Start [7]

### 4.2.1 Connectivity Topologies

### 4.2.1.0 Introduction

The following connectivity topologies for Ambient IoT networks and devices are defined for the purposes of the study. In all these topologies, the Ambient IoT device may be provided with a carrier wave from other node(s) either inside or outside the topology. The links in each topology may be bidirectional or unidirectional.

BS, UE, assisting node, or intermediate node could be multiple BSs or UEs, respectively. The mixture of indoor and outdoor placement of such nodes is regarded as a network implementation choice. Account would need to be taken of potential impact on device or node complexity. In the connectivity topologies, this does not imply the existence of multi-hop assisting or intermediate nodes.

### 4.2.1.1 Topology 1: BS↔Ambient IoT Device

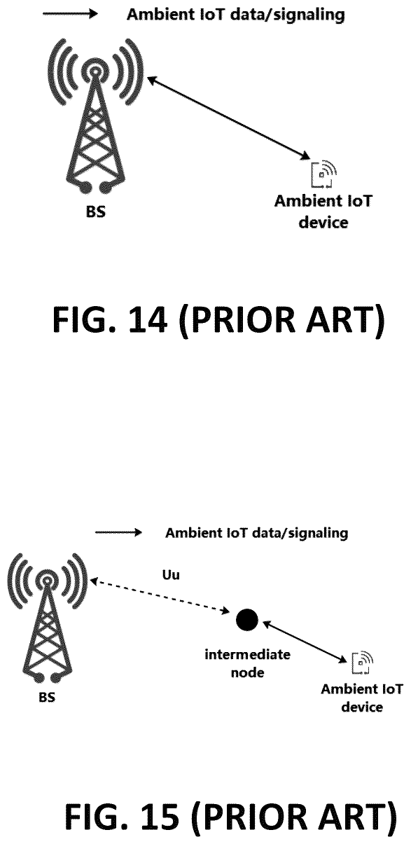

FIG. 14 is a reproduction of FIG. 4.2.1.1-1: Topology 1, from 3GPP TR 38.848 V18.0.0 (2023 September).

In Topology 1, the Ambient IoT device directly and bidirectionally communicates with a basestation. The communication between the basestation and the ambient IoT device includes Ambient IoT data and/or signalling. This topology includes the possibility that the BS transmitting to the Ambient IoT device is a different from the BS receiving from the Ambient IoT device.

### 4.2.1.2 Topology 2: BS↔Intermediate Node↔Ambient IoT Device

FIG. 15 is a Reproduction of FIG. 4.2.1.2-1: Topology 2, from 3GPP TR 38.848 V18.0.0 (2023 September).

In Topology 2, the Ambient IoT device communicates bidirectionally with an intermediate node between the device and basestation. In this topology, the intermediate node can be a relay, IAB node, UE, repeater, etc. which is capable of Ambient IoT. The intermediate node transfers Ambient IoT data and/or signalling between BS and the Ambient IoT device.

### Quotation End

An ambient Internet of Things (IoT) device/User Equipment (UE) would have ultra-low complexity, a very small device size, and a long life cycle. The ambient IoT device/UE would have complexity and power consumption orders of magnitude lower than the existing 3rd Generation Partnership Project (3GPP) Low-Power Wide-Area (LPWA) technologies (e.g., Narrowband (NB)-IoT, enhanced Machine Type Communication (eMTC)). The ambient IoT device/UE may not have energy storage or may have energy storage. The energy of the ambient IoT device/UE may be provided through the harvesting of radio waves, light, motion, heat, or any other power source that could be suitable. The energy and/or power source may be provided as a one-shot (e.g., unexpected or aperiodically), periodically, or continuously. In one embodiment, the power/energy of the ambient IoT device/UE may be provided from a carrier wave from the network and/or an intermediate node. In Topology 1, the ambient IoT device/UE would directly and bidirectionally communicate with a base station. In Topology 2, the ambient IoT device/UE would communicate bidirectionally with an intermediate node (e.g., a UE or a relay node) between the ambient IoT device/UE and the base station. The UL transmission of the ambient IoT device/UE may be generated internally by the device/UE, or be backscattered on the carrier wave provided externally. More details regarding ambient IoT (devices/UEs) could be found in the study item [2] RP-234058 and [7] 3GPP TR 38.848 V18.0.0.

According to the study item of ambient IoT (e.g., [2] RP-234058), the ambient IoT UE has limited energy storage (may possibly even with no energy storage). Comparing a New Radio (NR) UE with power consumption of mW (e.g., maximum UE transmit power 23 dBm corresponds to 199.5 mW), output power of the ambient IoT UE may be typically from 1 μW to a few hundreds of a μW. Currently, the general scope is to address the following types of ambient IoT UEs:
A first type of ambient IoT UE may have 1 μW peak power consumption, with energy storage, with neither Downlink (DL) nor Uplink (UL) amplification. Transmission from the first type of ambient IoT UE may be backscattered on a carrier wave provided externally. The first type of ambient IoT UE may be a type of device 1, e.g., as described in [3] RAN1 Chair's Notes for 3GPP TSG RAN WG1 #106.
A second type of ambient IoT UE may have ≤a few hundred μW peak power consumption, with energy storage, with DL and/or UL amplification. Transmission from the second type of ambient IoT UE may be backscattered on a carrier wave provided externally (e.g., a type of Device 2a) or generated internally by the UE (e.g., a type of Device 2b). The second type of ambient IoT UE may be a type of Device 2a and/or Device 2b, e.g., as described in [3] RAN1 Chair's Notes for 3GPP TSG RAN WG1 #106.

In Radio-frequency Identification (RFID) design (e.g., [1] EPC® Radio-Frequency Identity Generation-2 UHF RFID Standard), inventory operation utilizes slot-based ALOHA, as shown in FIG. 9.
Step 1: Interrogator sends a Query command to a tag population, wherein the Query command indicates a Q value, indication of a Selected/Select Flag (SL) flag selection, a session indication, and a Target indication of an inventoried flag. One or more tags matching the indicated SL flag and inventoried flag will perform inventory operation and randomly generate a slot number among 0 to (2^{Q}−1) in response to the Query command. The interrogator may send one or more Select commands, before the Query command, to set SL flags and inventoried flags of the tag population based on condition on the Memory Bank and the mask bit-string indicated by each Select command. In other words, the Interrogator may select a tag sub-population to perform an inventory operation, instead of a full tag population. Besides, within one inventory round initialized by the Query command, the interrogator can send one or more QueryAdjust commands to adjust the Q value and/or send one or more QueryRep commands for reducing the slot number of the tag sub-population.
Step 2: The one or more tags maintain their slot number and will reduce their slot number by 1 when receiving the QueryRep command from the Interrogator. When the slot number of a tag is equal to zero, the tag will send a randomly generated 16-bit, i.e., RN16, to the interrogator. In other words, the randomly generated slot numbers will normally distribute the tag sub-population into different slot occasions, such that the one or more tags of the tag sub-population will not send their RN16 at the same time with severe collision. Once more than one tag generates the same slot number, it will depend on the Interrogator implementation to distinguish them if feasible.
Step 3: When the Interrogator detects a RN16 signaling from a tag, the interrogator sends an Acknowledge (ACK) command with the detected RN16.
Step 4: The tag sending its RN16 in step 2 will detect or receive the ACK command in step 3. If the ACK command indicates the same RN16, the tag will be considered as acknowledged and will send its tag information to the interrogator, e.g., Electronic Product Code (EPC) or any code for identification. It is because the RN16 is just a temporary identity, the interrogator does not yet acquire real information for identifying the tag. If the ACK command does not indicate the same RN16, the tag will not be considered as acknowledged and will not reply anything.
Step 5: When the interrogator receives the tag information for identifying the tag, it means that the interrogator inventories the tag successfully. If there is no need for further data delivery between the interrogator and the inventoried tag, the interrogator may send a QueryRep command to let other tags reduce their slot number, i.e., go back to step 1 for other tags. If there is need for further data delivery between the interrogator and the inventoried tag, the interrogator will start an access operation and send a Req_RN command to the inventoried tag.
Step 6: When the tag receives the Req_RN command with a valid RN16 utilized in previous steps, the tag will start to perform the access operation and generate a new random 16-bit, denoted as the handle, and send it to the interrogator. More specifically, the RN16 is a temporary identity for the inventory operation, and the handle is an identity for the access operation.
Step 7: After the interrogator acquires the handle from the inventoried tag, the interrogator can send one or more access commands to the tag for communication, e.g., scheduling data transmission from the tag to the interrogator, security management, the tag's file management.
Step 8: When the tag receives the access command with a valid handle, the tag will report/reply accordingly. Note that step 7 and step 8 can be performed multiple times until the interrogator ends the communication (i.e., ends the access operation with the tag) by issuing any of Select, Challenge, Query, QueryX, QueryAdjust, QueryRep, or a NAK command.

For ambient IoT in NR, it is possible to consider RFID as a starting point for designing an access procedure and communication operation. Note that in a terminology aspect, the access procedure for ambient IoT may be more like the inventory operation in RFID, not the access operation in RFID. The communication operation for ambient IoT may be more like the access operation in RFID. The detailed design will be different between RFID and ambient IoT. Moreover, a network/intermediate node in NR may operate with similar functionality(ies) as an interrogator in RFID. The ambient IoT device/UE in NR may operate with similar functionality(ies) as a tag in RFID.

In RFID design, the tag (sub-) population are distributed in time domain, i.e., slot-based ALOHA. It is hard to support large-scale network with seamless coverage for RFID, since larger number of tags will induce longer inventory latency and severe interference.

On the other hand, RFID design seems not to allow more than one inventoried tag to perform an access operation, i.e., communication, at the same time. The interrogator needs to firstly end communication with one Inventoried tag, and then send next the QueryReq command for inventorying and/or accessing other tag(s). It means that one tag's access operation will block other/another tag's inventory and/or access operation. Thus, it is not efficient to inventory and access massive tags, as needed in the future.

Given NR can own abundant frequency resources, access procedures, communication operations for ambient IoT can be considered to design with Frequency Division Multiplexing (FDM).

For Ambient IoT, a slotted-ALOHA based (random) access procedure is supported for a reader to acquire responses from multiple devices. The (random) access procedure is initiated by the reader via a Reader-to-Device (R2D) transmission, and a corresponding response from a device is transmitted on Physical (Ambient IoT) Device (to) Reader Channel (PDRCH). Since Ambient IoT devices are with higher device density, more Device-to-Reader (D2R) resources may be considered to avoid longer access latency. Frequency Division Multiple Access (FDMA) can be considered to provide more D2R resources. However, in response to support of FDMA, power consumption and complexity of ambient IoT devices should try to keep low.

To address the above issues, various concepts, mechanisms, aspects, techniques, methods, and embodiments are provided below.

### Concept A

The concept A is that a network/intermediate node may perform/support multiple access procedures in multiple (pairs of) frequency bandwidths in/at the same time (period/duration). Preferably in certain embodiments, the multiple access procedure in the multiple (pairs of) frequency bandwidths may be performed separately/independently. Preferably in certain embodiments, the network/intermediate node may perform/support a first access procedure in a first (pair of) frequency bandwidth and perform/support a second access procedure in a second (pair of) frequency bandwidth in/at the same time (period/duration). The first access procedure and the second access procedure may be performed separately/independently, e.g., by different devices/UEs.

Preferably in certain embodiments, a first device/UE may (be restricted to) perform (only) one access procedure in one (pair of) frequency bandwidth in/at the same time (period/duration). The first device may prevent from performing more than one access procedure in more than one (pairs of) frequency bandwidth in/at the same time (period/duration). The first device may not allow performing more than one access procedure in more than one (pairs of) frequency bandwidth in/at the same time (period/duration).

Preferably in certain embodiments, the access procedure may be (or comprise) a contention-based access procedure. Preferably in certain embodiments, the access procedure may be (or comprise) a contention-free access procedure. Preferably in certain embodiments, (from the aspect of the network/intermediate node), the access procedure may comprise one or multiple access occasions/Transmission Time Intervals (TTIs). The first device/UE performing/initiating the access procedure may select/determine one access occasion/TTI, among the one or multiple access occasions/TTIs, to transmit a first (D2R) signal/transmission to the network/intermediate node. Preferably in certain embodiments, the first device/UE performing/initiating the access procedure may randomly select/determine the one access occasion/TTI (e.g., based on a random number), among the one or multiple access occasions/TTIs. Preferably in certain embodiments, for a contention-free access procedure, there may be (only) one access occasion/TTI. The first device/UE may transmit the first (D2R) signal/transmission in the one access occasion/TTI.

Preferably in certain embodiments, for paging/querying one or more devices/UEs to perform/initiate an access procedure, the network/intermediate node may transmit (R2D) paging/query information. When the first device/UE receives the (R2D) paging/query information, the first device/UE may perform/initiate a corresponding access procedure, e.g., if (at least) the first device/UE satisfies one or more conditions indicated by the (R2D) paging/query information, if any.

Preferably in certain embodiments, the network/intermediate node may transmit first (R2D) paging/query information in the first (pair of) frequency bandwidth. The first (R2D) paging/query information may page/query a first set of devices/UEs, e.g., to page/query each device/UE of the first set of devices/UEs to perform/initiate an access procedure in the first (pair of) frequency bandwidth. Preferably in certain embodiments, the network/intermediate node may transmit the first (R2D) paging/query information via transmitting one or more first (R2D) paging/query signaling(s) to the first set of devices/UEs. Preferably in certain embodiments, the one or more first (R2D) paging/query signaling(s) may indicate/provide one or more first conditions. The first set of devices/UEs means the devices/UEs satisfying the one or more first conditions.

Preferably in certain embodiments, the network/intermediate node may transmit second (R2D) paging/query information in the second (pair of) frequency bandwidth. The second (R2D) paging/query information may page/query a second set of devices/UEs, e.g., to page/query each device/UE of the second set of devices/UEs to perform/initiate access procedure in the second (pair of) frequency bandwidth. Preferably in certain embodiments, the network/intermediate node may transmit the second (R2D) paging/query information via transmitting one or more second (R2D) paging/query signaling(s) to the second set of devices/UEs.

Preferably in certain embodiments, the one or more second (R2D) paging/query signaling(s) may indicate/provide one or more second conditions. The second set of devices/UEs means the devices/UEs satisfying the one or more second conditions.

In one embodiment, the one or more first conditions and the one or more second conditions may be exclusive. The first set of devices/UEs and the second set of devices/UEs may be exclusive. The first device/UE belonging to the first set of devices/UEs may (assume/expect) not belong to the second set of devices/UEs. The second device/UE belonging to the second set of devices/UEs may (assume/expect) not belong to the first set of devices/UEs. When (or if at least) the first device/UE satisfies the one or more first conditions (and the first device/UE may not perform an ongoing access procedure), the first device/UE may perform/initiate an access procedure in the first (pair of) frequency bandwidth, in response to the first (R2D) paging/query information. If the first device/UE does not satisfy (all of) the one or more first conditions, the first device/UE may not perform/initiate an access procedure in the first (pair of) frequency bandwidth, in response to the first (R2D) paging/query information. When (or if at least) the first device/UE satisfies the one or more second conditions (and the first device/UE may not perform an ongoing access procedure), the first device/UE may perform/initiate an access procedure in the second (pair of) frequency bandwidth, in response to the second (R2D) paging/query information. If at least the first device/UE does not satisfy (all of) the one or more second conditions, the first device/UE may not perform/initiate an access procedure in the second (pair of) frequency bandwidth, in response to the second (R2D) paging/query information.

In one embodiment, the one or more first conditions and the one or more second conditions may not be exclusive. The first device/UE may belong to the first set of devices/UEs and also belong to the second set of devices/UEs. When the first device/UE satisfies the one or more first conditions and the one or more second conditions (and the first device/UE may not perform an ongoing access procedure), the first device/UE may select/determine to perform/initiate an access procedure in either one of the first (pair of) frequency bandwidth and the second (pair of) frequency bandwidth. The first device/UE may select/determine to perform an access procedure in response to either one of the first (R2D) paging/query information and the second (R2D) paging/query information.

Preferably in certain embodiments, the first device/UE may perform the selection/determination randomly. Preferably in certain embodiments, the first device/UE may perform the selection/determination based on any of a formula, an occasion/TTI index, an identity of the first device/UE, etc.

Preferably in certain embodiments, the first device/UE may perform the selection/determination based on whether there is a contention-free access procedure for the first device/UE or indication of a specific (pair of) frequency bandwidth for the first device/UE. If a (R2D) paging/query information in one (pair of) frequency bandwidth indicates a contention-free access procedure for the first device/UE, the first device/UE may determine/select/utilize the one (pair of) frequency bandwidth, where the first device/UE receives the (R2D) paging/query information, to perform/initiate the access procedure. If a (R2D) paging/query information indicates/instructs the first device/UE to utilize a specific (pair of) frequency bandwidth (e.g., the (R2D) paging/query information indicates the identity of the first device/UE and indication of the specific (pair of) frequency bandwidth), the first device/UE may determine/select/utilize the specific (pair of) frequency bandwidth to perform/initiate the access procedure.

Preferably in certain embodiments, the first device/UE may perform the selection/determination based on priority (e.g., select/determine the one with higher priority), e.g., if (R2D) paging/query information indicates/comprises priority information (e.g., priority information of an associated access procedure initiated by the (R2D) paging/query information, priority information of an associated (pair of) frequency bandwidth, or priority information of an associated data/report/service indicated by the (R2D) paging/query information). For example, if at least the first (R2D) paging/query information indicates/comprises a priority (information) higher than a priority (information) indicated by the second (R2D) paging/query information, the first deice/UE may select the first (pair of) frequency bandwidth. If at least the first (R2D) paging/query information indicates/comprises a priority (information) higher than a priority (information) indicated by the second (R2D) paging/query information, the first deice/UE may select/determine to perform an access procedure in response to the first (R2D) paging/query information. Alternatively and/or preferably in certain embodiments, when the first (R2D) paging/query information and the second (R2D) paging/query information indicates/comprises the same priority information, the first device/UE may perform the selection/determination randomly.

Preferably in certain embodiments, the first device/UE may perform the selection/determination based on frequency shift, e.g., for shifting backscattered signal from one frequency (e.g., carrier wave frequency) to another frequency (e.g., the first (pair of) frequency bandwidth, the second (pair of) frequency bandwidth). For instance, if (absolute value of) a first frequency shift corresponding to the first (pair of) frequency bandwidth is smaller than (absolute value of) a second frequency shift corresponding to the second (pair of) frequency bandwidth, the first device/UE may select/determine to perform an access procedure in the first (pair of) frequency bandwidth. Preferably in certain embodiments, when (absolute values of) the first frequency shift and the second frequency shift are the same, the first device/UE may perform the selection/determination randomly.

Preferably in certain embodiments, the first device/UE may perform the selection/determination based on a starting timing of an access procedure. For instance, if an access procedure in the first (pair of) frequency bandwidth can be performed earlier than an access procedure in the second (pair of) frequency bandwidth (and the first device/UE has enough/available power to perform the access procedure in the first (pair of) frequency bandwidth), the first device/UE may select/determine to perform the access procedure in the first (pair of) frequency bandwidth. Alternatively, if an access procedure in the first (pair of) frequency bandwidth can be performed later than an access procedure in the second (pair of) frequency bandwidth (and the first device/UE has enough/available power to perform the access procedure in the second (pair of) frequency bandwidth), the first device/UE may select/determine to perform the access procedure in the first (pair of) frequency bandwidth. For instance, if the first (R2D) paging/query information indicates an earlier starting timing of an access procedure than the second (R2D) paging/query information (and the first device/UE has enough/available power to perform the access procedure in the first (pair of) frequency bandwidth), the first device/UE may select/determine to perform the access procedure in the first (pair of) frequency bandwidth. Alternatively, if the first (R2D) paging/query information indicates a later starting timing of an access procedure than the second (R2D) paging/query information (and the first device/UE has enough/available power to perform the access procedure in the first (pair of) frequency bandwidth), the first device/UE may select/determine to perform the access procedure in the first (pair of) frequency bandwidth. Preferably in certain embodiments, when the starting timing of the access procedure in the first (pair of) frequency bandwidth and the second (pair of) frequency bandwidth are the same, the first device/UE may perform the selection/determination randomly.

Preferably in certain embodiments, the first device/UE may perform the selection/determination based on a value associated with the number of the one or multiple access occasions/TTIs of an access procedure. For instance, if the value associated with the number of the one or multiple access occasions/TTIs of an access procedure in the first (pair of) frequency bandwidth is smaller than the value associated with the number of the one or multiple access occasions/TTIs of an access procedure in the second (pair of) frequency bandwidth, the first device/UE may select/determine to perform the access procedure in the first (pair of) frequency bandwidth. Alternatively, if the value associated with the number of the one or multiple access occasions/TTIs of an access procedure in the first (pair of) frequency bandwidth is larger than the value associated with the number of the one or multiple access occasions/TTIs of an access procedure in the second (pair of) frequency bandwidth, the first device/UE may select/determine to perform the access procedure in the first (pair of) frequency bandwidth. Preferably in certain embodiments, when the value associated with the number of the one or multiple access occasions/TTIs of an access procedure in the first (pair of) frequency bandwidth and the value associated with the number of the one or multiple access occasions/TTIs of an access procedure in the second (pair of) frequency bandwidth are the same, the first device/UE may perform the selection/determination randomly. Preferably in certain embodiments, the value may be indicated/provided by the network/intermediate node. Preferably in certain embodiments, the value associated with the number of the one or multiple access occasions/TTIs of the access procedure in the first (pair of) frequency bandwidth may be indicated/provided by the first (R2D) paging/query information. The value associated with the number of the one or multiple access occasions/TTIs of the access procedure in the second (pair of) frequency bandwidth may be indicated/provided by the second (R2D) paging/query information.

Preferably in certain embodiments, the first device/UE may perform the selection/determination based on a type of reader (network/intermediate node). Preferably in certain embodiments, there may be association between the type of reader and the (pair of) frequency bandwidth. Preferably in certain embodiments, the (R2D) paging/query information may indicate the type of reader. For example, if the first device/UE receives a (R2D) paging/query information from a first type of reader (e.g., a network), the first device/UE may select/determine to perform an access procedure in the first (pair of) frequency bandwidth. If the first device/UE receives a (R2D) paging/query information from a second type of reader (e.g., a UE), the first device/UE may select/determine to perform an access procedure in the second (pair of) frequency bandwidth. More specifically, if the first device/UE receives the first (R2D) paging/query information from the first type of reader (e.g., a network) and receives the second (R2D) paging/query information from the second type of reader (e.g., a UE), the first device/UE may (prioritize to) select/determine to perform the access procedure in the first (pair of) frequency bandwidth. Alternatively, if the first device/UE receives the first (R2D) paging/query information from the first type of reader (e.g., a network) and receives the second (R2D) paging/query information from the second type of reader (e.g., a UE), the first device/UE may (prioritize to) select/determine to perform the access procedure in the second (pair of) frequency bandwidth. For another instance, if the first device/UE has pending data for reporting/transmitting to the first type of reader, the first device/UE may select/determine to perform the access procedure in the first (pair of) frequency bandwidth. If the first device/UE has pending data for reporting/transmitting to the second type of reader, the first device/UE may select/determine to perform the access procedure in the second (pair of) frequency bandwidth. More specifically, if the first device/UE has pending data for reporting/transmitting to the first type of reader (e.g., a network) and has pending data for reporting/transmitting to the second type of reader (e.g., a UE), the first device/UE may (prioritize to) select/determine to perform the access procedure in the first (pair of) frequency bandwidth. Alternatively, if the first device/UE has pending data for reporting/transmitting to the first type of reader (e.g., a network) and has pending data for reporting/transmitting to the second type of reader (e.g., a UE), the first device/UE may (prioritize to) select/determine to perform the access procedure in the second (pair of) frequency bandwidth. The first type and/or the second type may be (or comprise) a network, a base station, a Next Generation Node B (gNB), an intermediate node, and/or a UE. The first type and the second type may be different.

Preferably in certain embodiments, the first device/UE may perform the selection/determination based on an interface between the first device/UE and the reader (network/intermediate node). Preferably in certain embodiments, there may be an association between the interface and (pair of) frequency bandwidth. Preferably in certain embodiments, the (R2D) paging/query information may indicate the interface. For example, if the first device/UE receives a (R2D) paging/query information via a first interface (e.g., Uu interface), the first device/UE may select/determine to perform the access procedure in the first (pair of) frequency bandwidth. If the first device/UE receives a (R2D) paging/query information via a second interface (e.g., PC5 interface), the first device/UE may select/determine to perform the access procedure in the second (pair of) frequency bandwidth. More specifically, if the first device/UE receives the first (R2D) paging/query information via the first interface (e.g., Uu interface) and receives the second (R2D) paging/query information via the second interface (e.g., PC5 interface), the first device/UE may (prioritize to) select/determine to perform the access procedure in the first (pair of) frequency bandwidth. Alternatively, if the first device/UE receives the first (R2D) paging/query information via the first interface (e.g., Uu interface) and receives the second (R2D) paging/query information via the second interface (e.g., PC5 interface), the first device/UE may (prioritize to) select/determine to perform the access procedure in the second (pair of) frequency bandwidth. For another example, if the first device/UE receives a (R2D) paging/query information via a first channel or a first resource belonging to the first interface (e.g., Uu interface), the first device/UE may select/determine to perform the access procedure in the first (pair of) frequency bandwidth. If the first device/UE receives a (R2D) paging/query information via a second channel or a second resource belonging to the second interface (e.g., PC5 interface), the first device/UE may select/determine to perform the access procedure in the second (pair of) frequency bandwidth. More specifically, if the first device/UE receives the first (R2D) paging/query information via the first channel or the first resource belonging to the first interface (e.g., Uu interface) and receives the second (R2D) paging/query information via the second channel or the second resource belonging to the second interface (e.g., PC5 interface), the first device/UE may (prioritize to) select/determine to perform the access procedure in the first (pair of) frequency bandwidth. Alternatively, if the first device/UE receives the first (R2D) paging/query information via the first channel or the first resource belonging to the first interface (e.g., Uu interface) and receives the second (R2D) paging/query information via the second channel or the second resource belonging to the second interface (e.g., PC5 interface), the first device/UE may (prioritize to) select/determine to perform the access procedure in the second (pair of) frequency bandwidth. The first interface and/or the second interface may be (or comprise) a Uu interface, a PC5 interface, an interface between a UE and a Network (NW), and/or an interface between UE and UE. The first interface and the second interface may be different. Preferably in certain embodiments, the first device/UE may be able to distinguish the first interface and the second interface. The first device/UE may be able to distinguish the first channel and the second channel.

Preferably in certain embodiments, the first device/UE may perform the selection/determination based on one or more characteristics of target device(s)/UE(s) of a received (R2D) paging/query information. For example, if the first set of devices/UEs is higher than or prioritized over the second set of devices/UEs based on the one or more characteristics of the first set and the second set of devices/UEs, the first device/UE may select/determine to perform the access procedure in the first (pair of) frequency bandwidth. If the second set of devices/UEs is higher than or prioritized over the first set of devices/UEs based on the one or more characteristics of the first set and the second set of devices/UEs, the first device/UE may select/determine to perform the access procedure in the second (pair of) frequency bandwidth. The one or more characteristics may be (or include) any of type of target device/UE, priority of UE type, priority of UE group, priority of service/data/report type, latency requirement of pending service/data/report type, and amount of sets of UEs.

In one embodiment, the one or more first conditions and the one or more second conditions may not be exclusive. The first device/UE may belong to the first set of devices/UEs and also belong to the second set of devices/UEs. When the first device/UE satisfies the one or more first conditions and the one or more second conditions (and the first device/UE may not perform an ongoing access procedure), the first device/UE may perform/initiate a first access procedure in the first (pair of) frequency bandwidth and perform/initiate a second access procedure in the second (pair of) frequency bandwidth. The first device/UE may perform/initiate the first access procedure in response to the first (R2D) paging/query information and perform/initiate the second access procedure in response to the second (R2D) paging/query information. Preferably in certain embodiments, the first device/UE performing/initiating the first access procedure may select/determine a first access occasion/TTI to transmit a first (D2R) signal/transmission in the first (pair of) frequency bandwidth. The first (D2R) signal/transmission may or may not comprise an identifier associated with the first device/UE. The first device/UE performing/initiating the second access procedure may select/determine a second access occasion/TTI to transmit a second (D2R) signal/transmission in the second (pair of) frequency bandwidth. The second (D2R) signal/transmission may or may not comprise an identifier associated with the first device/UE.

Preferably in certain embodiments, if the first access occasion/TTI is/comes earlier than the second access occasion/TTI, the first device/UE may transmit the first (D2R) signal/transmission in the first (pair of) frequency bandwidth. The first device/UE may continue to perform the first access procedure in the first (pair of) frequency bandwidth, e.g., in response to transmission of the first (D2R) signal/transmission or in response to reception of a first valid (R2D) response associated with the first (D2R) signal/transmission. Preferably in certain embodiments, the first device/UE may stop/abort/discard/cancel the second access procedure in the second (pair of) frequency bandwidth, e.g., in response to transmission of the first (D2R) signal/transmission or in response to reception of the first valid (R2D) response associated with the first (D2R) signal/transmission.

Preferably in certain embodiments, if the second access occasion/TTI is/comes earlier than the first access occasion/TTI, the first device/UE may transmit the second (D2R) signal/transmission in the second (pair of) frequency bandwidth. The first device/UE may continue to perform the second access procedure in the second (pair of) frequency bandwidth, e.g., in response to transmission of the second (D2R) signal/transmission or in response to reception of a second valid (R2D) response associated with the second (D2R) signal/transmission. Preferably in certain embodiments, the first device/UE may stop/abort/discard/cancel the first access procedure in the first (pair of) frequency bandwidth, e.g., in response to transmission of the second (D2R) signal/transmission or in response to reception of the second valid (R2D) response associated with the second (D2R) signal/transmission.

Preferably in certain embodiments, the first device/UE may perform the selection/determination randomly. Preferably in certain embodiments, the first device/UE may perform the selection/determination based on any of a formula, an occasion/TTI index, an identity of the first device/UE, etc.

In one embodiment, the one or more first conditions and the one or more second conditions may not be exclusive. The first device/UE may belong to the first set of devices/UEs and also belong to the second set of devices/UEs. When the first device/UE satisfies the one or more first conditions and the one or more second conditions (and the first device/UE may not perform an ongoing access procedure), the first device/UE may perform/initiate a first access procedure in the first (pair of) frequency bandwidth and perform/initiate a second access procedure in the second (pair of) frequency bandwidth. The first device/UE may perform/initiate the first access procedure in response to the first (R2D) paging/query information and perform/initiate the second access procedure in response to the second (R2D) paging/query information. Preferably in certain embodiments, the first access procedure and the second access procedure may be performed separately or independently.

Preferably in certain embodiments, the first device/UE performing/initiating the first access procedure may select/determine a first access occasion/TTI to transmit a first (D2R) signal/transmission in the first (pair of) frequency bandwidth. The first device/UE performing/initiating the second access procedure may select/determine a second access occasion/TTI to transmit a second (D2R) signal/transmission in the second (pair of) frequency bandwidth.

Preferably in certain embodiments, the first device/UE may transmit the first (D2R) signal/transmission in the first access occasion/TTI in the first (pair of) frequency bandwidth. The first device/UE may continue to perform the first access procedure in the first (pair of) frequency bandwidth, e.g., in response to transmission of the first (D2R) signal/transmission or in response to reception of a first valid (R2D) response associated with the first (D2R) signal/transmission. Preferably in certain embodiments, the first device/UE may not stop/abort/discard/cancel the second access procedure in the second (pair of) frequency bandwidth, e.g., in response to transmission of the first (D2R) signal/transmission or in response to reception of the first valid (R2D) response associated with the first (D2R) signal/transmission. Preferably in certain embodiments, the first device/UE may or may not stop/abort/discard/cancel the second access procedure in the second (pair of) frequency bandwidth, e.g., in response to completion of the first access procedure.

Preferably in certain embodiments, the first device/UE may transmit the second (D2R) signal/transmission in the second access occasion/TTI in the second (pair of) frequency bandwidth. The first device/UE may continue to perform the first access procedure in the first (pair of) frequency bandwidth, e.g., in response to transmission of the first (D2R) signal/transmission or in response to reception of a first valid (R2D) response associated with the first (D2R) signal/transmission. Preferably in certain embodiments, the first device/UE may not stop/abort/discard/cancel the first access procedure in the first (pair of) frequency bandwidth, e.g., in response to transmission of the second (D2R) signal/transmission or in response to reception of the second valid (R2D) response associated with the second (D2R) signal/transmission. Preferably in certain embodiments, the first device/UE may or may not stop/abort/discard/cancel the first access procedure in the first (pair of) frequency bandwidth, e.g., in response to completion of the second access procedure.

Preferably in certain embodiments, if the first access occasion/TTI (partially or fully) collides with the second access occasion/TTI, the first device/UE may transmit the first (D2R) signal/transmission in the first (pair of) frequency bandwidth and transmit the second (D2R) signal/transmission in the second (pair of) frequency bandwidth separately (if at least the first device/UE is capable to transmit both, e.g., device/UE capability and/or enough/available power).

Alternatively and/or preferably in certain embodiments, if the first access occasion/TTI (partially or fully) collides with the second access occasion/TTI, the first device/UE may transmit either one of the first (D2R) signal/transmission in the first (pair of) frequency bandwidth and the second (D2R) signal/transmission in the second (pair of) frequency bandwidth (if at least the first device/UE is not capable to transmit both, e.g., due to device/UE capability and/or enough/available power). Preferably in certain embodiments, if starting of the first access occasion/TTI is/comes earlier than starting of the second access occasion/TTI, the first device/UE may transmit the first (D2R) signal/transmission in the first access occasion/TTI in the first (pair of) frequency bandwidth, and not perform the second (D2R) signal/transmission in the second access occasion/TTI in the second (pair of) frequency bandwidth. If starting of the second access occasion/TTI is/comes earlier than starting of the first access occasion/TTI, the first device/UE may transmit the second (D2R) signal/transmission in the second access occasion/TTI in the second (pair of) frequency bandwidth, and not perform the first (D2R) signal/transmission in the first access occasion/TTI in the first (pair of) frequency bandwidth. Preferably in certain embodiments, if the first (R2D) paging/query information indicates/comprises higher priority than the second (R2D) paging/query information, the first device/UE may transmit the first (D2R) signal/transmission in the first access occasion/TTI in the first (pair of) frequency bandwidth, and not perform the second (D2R) signal/transmission in the second access occasion/TTI in the second (pair of) frequency bandwidth. Preferably in certain embodiments, if the second (R2D) paging/query information indicates/comprises higher priority than the first (R2D) paging/query information, the first device/UE may transmit the second (D2R) signal/transmission in the second access occasion/TTI in the second (pair of) frequency bandwidth, and not perform the first (D2R) signal/transmission in the first access occasion/TTI in the first (pair of) frequency bandwidth.

Preferably in certain embodiments, the (pair of) frequency bandwidth may comprise one frequency bandwidth for R2D (from the network/intermediate node to device(s)/UE(s)) transmission/reception and D2R (from device(s)/UE(s) to the network/intermediate node) transmission/reception. In other words, for the (pair of) frequency bandwidth, its R2D frequency bandwidth is the same as its D2R frequency bandwidth, e.g., in frequency domain. The D2R transmission/reception/operation and R2D transmission/reception/operation may be Time Division Multiplexed (TDMed).

Alternatively and/or preferably in certain embodiments, the (pair of) frequency bandwidth may comprise one R2D (from the network/intermediate node to device(s)/UE(s)) frequency bandwidth for R2D transmission/reception and one D2R (from device(s)/UE(s) to the network/intermediate node) frequency bandwidth for D2R transmission/reception. The one R2D frequency bandwidth and the one D2R frequency bandwidth may be linked/paired as the (pair of) frequency bandwidth. The D2R transmission/reception/operation and R2D transmission/reception/operation may be Frequency Domain Multiplexed (FDMed).

Preferably in certain embodiments, the network/intermediate node may provide pairing/linking information of one (pair of) frequency bandwidth, e.g., a frequency shift between the one R2D frequency bandwidth and the one D2R frequency bandwidth or between center frequency of the one R2D frequency bandwidth and center frequency of the one D2R frequency bandwidth, and/or any of frequency location, bandwidth, starting point of the D2R frequency bandwidth. Preferably in certain embodiments, the pairing/linking information may be provided/transmitted/comprised in the paging/query information. Alternatively and/or preferably in certain embodiments, the pairing/linking information may be provided/transmitted/comprised in a configuration provided from the network/intermediate node. Alternatively and/or preferably in certain embodiments, the pairing/linking information may be specified or (pre-) configured or fixed.

Preferably in certain embodiments, the network/intermediate node may transmit the first (R2D) paging/query information in a first R2D frequency bandwidth. Preferably in certain embodiments, the first (R2D) paging/query information in the first R2D frequency bandwidth may indicate/comprise information of a first D2R frequency bandwidth. Preferably in certain embodiments, the first device/UE may transmit the first (D2R) signal/transmission in the first D2R frequency bandwidth. Preferably in certain embodiments, the first device/UE may receive the first valid (R2D) response in the first R2D frequency bandwidth.

Preferably in certain embodiments, the network/intermediate node may transmit the second (R2D) paging/query information in a second R2D frequency bandwidth. Preferably in certain embodiments, the second (R2D) paging/query information in the second R2D frequency bandwidth may indicate/comprise information of a second D2R frequency bandwidth. The first device/UE may transmit the second (D2R) signal/transmission in the second D2R frequency bandwidth. The first device/UE may receive the second valid (R2D) response in the second R2D frequency bandwidth.

Preferably in certain embodiments, the first device/UE may monitor/detect/receive (R2D) paging/query information in one or more (pairs of) frequency bandwidths among the multiple (pairs of) frequency bandwidths. More specifically, the first device/UE may monitor/detect/receive (R2D) paging/query information in one or more R2D frequency bandwidths among the multiple R2D frequency bandwidths. Preferably in certain embodiments, the number of the one or more (pairs of) frequency bandwidths or the one or more R2D frequency bandwidths on which the first device/UE may monitor/detect/receive (R2D) paging/query information may depend on capability of the first device/UE and/or available/remaining power of the first device/UE. Preferably in certain embodiments, (when the first device/UE powers on or becomes active,) the first device/UE may receive/acquire information of available (pairs of) frequency bandwidths or available R2D frequency bandwidths, e.g., the multiple (pairs of) frequency bandwidths or the multiple R2D frequency bandwidths, provided by the network/intermediate node or by specification or by (pre-) configuration. Preferably in certain embodiments, the first device/UE may determine/derive/select the one or more R2D frequency bandwidths, among the multiple R2D frequency bandwidths, for monitoring/detecting/receiving (R2D) paging/query information. Preferably in certain embodiments, the first device/UE may monitor/detect/receive (R2D) paging/query information in the multiple R2D frequency bandwidths, e.g., if feasible.

Preferably in certain embodiments, the first device/UE may receive the first (R2D) paging/query information in the first R2D frequency bandwidth in a first reception timing/occasion/TTI. The first device/UE may receive the second (R2D) paging/query information in the second R2D frequency bandwidth in a second reception timing/occasion/TTI.

Preferably in certain embodiments, the first device/UE may monitor/detect/receive (R2D) paging/query information in the first R2D frequency bandwidth and the second R2D frequency bandwidth in/at the same time (period/duration). The first reception timing/occasion/TTI may be the same as or different from the second reception timing/occasion/TTI.

Alternatively and/or preferably in certain embodiments, the first device/UE may monitor/detect/receive (R2D) paging/query information in one R2D frequency bandwidth at a time. The first device/UE may not (be able to) monitor/detect/receive (R2D) paging/query information in more than one R2D frequency bandwidth at the same time. The first device/UE may monitor/detect/receive (R2D) paging/query information in the first R2D frequency bandwidth and the second R2D frequency bandwidth in different time. Preferably in certain embodiments, the first device/UE may switch the R2D frequency bandwidth, for monitoring/detecting/receiving (R2D) paging/query information, based on hopping operation/formula. Preferably in certain embodiments, the first device/UE may switch the R2D frequency bandwidth, for monitoring/detecting/receiving (R2D) paging/query information, based on an order, e.g., order in frequency or index of each R2D frequency bandwidth. Preferably in certain embodiments, the first reception timing/occasion/TTI may be different from the second reception timing/occasion/TTI.

Preferably in certain embodiments, when the first device/UE (successfully) detects/receives (R2D) paging/query information in one R2D frequency bandwidth (and the first device satisfies one or more conditions indicated by the detected/received (R2D) paging/query information), the first device/UE may or may not monitor/detect/receive (R2D) paging/query information in other R2D frequency bandwidth(s). Preferably in certain embodiments, when the first device/UE performs/initiates an access procedure associated with the detected/received (R2D) paging/query information, the first device/UE may or may not monitor/detect/receive (R2D) paging/query information in other/another R2D frequency bandwidth(s). Preferably in certain embodiments, when the first device/UE (successful or failed) completes the access procedure associated with the detected/received (R2D) paging/query information, the first device/UE may start to monitor/detect/receive (R2D) paging/query information in other/another R2D frequency bandwidth(s).

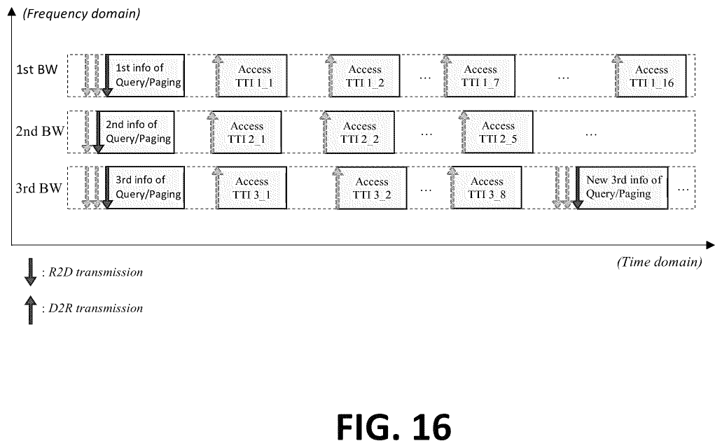

Preferably in certain embodiments, FIG. 16 shows an exemplary instance. The network/intermediate node may in parallel/separately/independently perform/support a 1st access procedure in a 1st (pair of) frequency bandwidth (denoted as 1st Bandwidth (BW) in FIG. 16), a 2nd access procedures in a 2nd (pair of) frequency bandwidth (denoted as 2nd BW in FIG. 16), and a 3rd access procedure in a 3rd (pair of) frequency bandwidth (denoted as 3rd BW in FIG. 16). Note that FIG. 16 shows an instance that the R2D frequency bandwidth is the same as the D2R frequency bandwidth. It is possible that the R2D frequency bandwidth is different from the D2R frequency bandwidth. It is also possible that each R2D frequency bandwidth is associated with a D2R frequency bandwidth in different frequency resources. Note that there may or may not be a guard band between two adjacent (pair of) frequency bandwidths or two R2D frequency bandwidths or two D2R frequency bandwidths.

As shown in the instance of FIG. 16, there may be 16 access occasions/TTIs, i.e., access TTI 1_1˜1_16, for the 1st access procedure. There may be at least 5 access occasions/TTIs, i.e., access TTI 2_1˜2_5, for the 2nd access procedure. There may be 8 access occasions/TTIs, i.e., access TTI 3_1˜3_8, for the 3rd access procedure. FIG. 16 shows the instance that each access procedure may comprise different access occasions/TTIs. It is also possible that two access procedures in two different (pair of) frequency bandwidths may comprise the same number of access occasions/TTIs. Preferably in certain embodiments, the network/intermediate node may transmit an R2D signaling for indicating change/switch of the access occasion/TTI before each access occasion/TTI (except for the first access occasion/TTI) separately/independently for each (pair of) frequency bandwidth. In response to reception of the R2D signaling, the first device/UE can derive/determine the access occasion/TTI and/or acquire (DL or R2D) timing synchronization. The first device/UE may perform a corresponding D2R transmission based on the timing synchronization or based on the reception time of the R2D signaling/transmission. The first device/UE may perform a D2R transmission based on the timing synchronization or based on the reception time of a closest/nearest R2D signaling/transmission before the D2R transmission.

Preferably in certain embodiments, for one access procedure, a time gap between adjacent access occasions/TTIs may be fixed or varied (in physical timing or in (micro-) second aspect). FIG. 16 shows the instance that a time gap between adjacent access occasion/TTI is varied. Thus, it is possible that access TTI 1_7 is earlier than access TTI 2_5 in time domain. The first device/UE may receive the 1st information of Query/paging in the 1st BW and receive the 2nd information of Query/paging in the 2nd BW. For the 1st access procedure in the 1st BW, the first device/UE may determine/select the Access TTI 1_7 for transmitting the first (D2R) signal/transmission. For the 2nd access procedure in the 2nd BW, the first device/UE may determine/select the Access TTI 2_5 for transmitting the second (D2R) signal/transmission.

### Concept B

The concept B is that a network/intermediate node may perform/support an access procedure in multiple (pairs of) frequency bandwidths (in/at the same time (period/duration)). Preferably in certain embodiments, the network/intermediate node may perform/support the access procedure in at least a first (pair of) frequency bandwidth and a second (pair of) frequency bandwidth (in/at the same time (period/duration)). The first (pair of) frequency bandwidth and the second (pair of) frequency bandwidth may be utilized by different devices/UEs for performing their access procedure (e.g., from the aspect of the device/UE).

Preferably in certain embodiments, the access procedure may be a contention-based access procedure. Preferably in certain embodiments, the access procedure may be a contention-free access procedure. Preferably in certain embodiments, the access procedure may comprise one or multiple access occasions/TTIs in the multiple (pair of) frequency bandwidths. Preferably in certain embodiments, the access procedure may comprise a first set of access occasions/TTIs in the first (pairs of) frequency bandwidth and comprise a second set of access occasions/TTIs in the second (pair of) frequency bandwidth. The number of the first set of access occasions/TTIs may be the same as or different from the number of the second set of access occasions/TTIs.

Preferably in certain embodiments, for paging/querying one or more devices/UEs to perform/initiate an access procedure, the network/intermediate node may transmit (R2D) paging/query information. Preferably in certain embodiments, the network/intermediate node may transmit the (R2D) paging/query information in (only) one (pair of) frequency bandwidth among the multiple (pairs of) frequency bandwidths. Preferably in certain embodiments, the (R2D) paging/query information may indicate the multiple (pairs of) frequency bandwidths for the access procedure. The indication may or may not indicate the one frequency bandwidth utilized for transmitting the (R2D) paging/query information.

Preferably in certain embodiments, the network/intermediate node may transmit a first (R2D) paging/query information in the first (pair of) frequency bandwidth. Preferably in certain embodiments, the first (R2D) paging/query information may indicate at least the second (pair of) frequency bandwidth for the access procedure. Preferably in certain embodiments, the access procedure(s) are associated with the multiple (pairs of) frequency bandwidths indicated by the first (R2D) paging/query information. The multiple (pairs of) frequency bandwidths may comprise at least the first (pair of) frequency bandwidth and the second (pair of) frequency bandwidth. The first (R2D) paging/query information may page/query a first set of devices/UEs, e.g., to page/query each device/UE of the first set of devices/UEs to perform/initiate access procedure in the first (pair of) frequency bandwidth and/or the second (pair of) frequency bandwidth for the access procedure. Preferably in certain embodiments, the network/intermediate node may transmit the first (R2D) paging/query information via transmitting one or more first (R2D) paging/query signaling(s), to the first set of devices/UEs, in the first (pair of) frequency bandwidth. Preferably in certain embodiments, the one or more first (R2D) paging/query signaling(s) may indicate/provide one or more first conditions. The first set of devices/UEs means the devices/UEs satisfying the one or more first conditions.

Preferably in certain embodiments, when a first device/UE receives the first (R2D) paging/query information, the first device/UE may perform/initiate a corresponding access procedure, e.g., if at least the first device/UE satisfies the one or more first conditions indicated by the first (R2D) paging/query information, if any. Preferably in certain embodiments, the first device/UE may determine/select a (pair of) frequency bandwidth, among the multiple (pairs of) frequency bandwidths, to perform/initiate the corresponding access procedure.

Preferably in certain embodiments, when a second device/UE receives the first (R2D) paging/query information, the second device/UE may perform/initiate a corresponding access procedure, e.g., if at least the second device/UE satisfies the one or more first conditions indicated by the first (R2D) paging/query information, if any. Preferably in certain embodiments, the second device/UE may determine/select another (pair of) frequency bandwidth, among the multiple (pairs of) frequency bandwidths, to perform/initiate the corresponding access procedure. Preferably in certain embodiments, the (pair of) frequency bandwidth determined/selected by the first device/UE may be the same as or different from the another (pair of) frequency bandwidth determined/selected by the second device/UE.

Preferably in certain embodiments, the first/second device/UE may perform the selection/determination on a (pair of) frequency bandwidth randomly. Preferably in certain embodiments, the first/second device/UE may perform the selection/determination on (pair of) frequency bandwidth based on any of a formula, an occasion/TTI index, an identity of the first/second device/UE, etc. Preferably in certain embodiments, the network/intermediate node may transmit a reselect/adjust signaling/indication to the first device/UE and/or the second device/UE. Preferably in certain embodiments, when the first device/UE determining/selecting the first (pair of) frequency bandwidth receives the reselect/adjust signaling/indication (and the first device/UE does not complete its access procedure), the first device/UE may re-select/re-determine a (pair of) frequency bandwidth (may or may not be the first (pair of) frequency bandwidth), among the multiple (pairs of) frequency bandwidths, to perform/initiate the corresponding access procedure. Preferably in certain embodiments, when the second device/UE determining/selecting the second (pair of) frequency bandwidth receives the reselect/adjust signaling/indication (and the second device/UE does not complete its access procedure), the second device/UE may re-select/re-determine a (pair of) frequency bandwidth (may or may not be the second (pair of) frequency bandwidth), among the multiple (pairs of) frequency bandwidths, to perform/initiate the corresponding access procedure.

Preferably in certain embodiments, the first/second device/UE may perform the selection/determination on a (pair of) frequency bandwidth based on whether there is a contention-free access procedure for the first/second device/UE or indication of a specific (pair of) frequency bandwidth for the first/second device/UE. For instance, if the first (R2D) paging/query information indicates a contention-free access procedure for the first/second device/UE, the first/second device/UE may determine/select/utilize the first (pair of) frequency bandwidth, where the first/second device/UE receives the first (R2D) paging/query information, to perform/initiate the access procedure. If the first (R2D) paging/query information indicates/instructs the first/second device/UE to utilize a specific (pair of) frequency bandwidth (e.g., the first (R2D) paging/query information indicates identity of the first/second device/UE and information of the specific (pair of) frequency bandwidth), the first/second device/UE may determine/select/utilize the specific (pair of) frequency bandwidth to perform/initiate the access procedure.

Preferably in certain embodiments, the first/second device/UE may perform the selection/determination on a (pair of) frequency bandwidth based on frequency shift, e.g., for shifting backscattered signal from one frequency (e.g., carrier wave frequency or the first (pair of) frequency bandwidth where the first/second device/UE receives the first (R2D) paging/query information) to another frequency (e.g., the first (pair of) frequency bandwidth, the second (pair of) frequency bandwidth, one of the multiple (pair of) frequency bandwidths). For instance, if (absolute value of) a first frequency shift corresponding to the first (pair of) frequency bandwidth is smaller than (absolute value of) a second frequency shift corresponding to the second (pair of) frequency bandwidth, the first/second device/UE may select/determine to perform the access procedure in the first (pair of) frequency bandwidth. Preferably in certain embodiments, when (absolute values of) the first frequency shift and the second frequency shift are the same, the first/second device/UE may perform the selection/determination randomly.

Preferably in certain embodiments, the first/second device/UE may perform the selection/determination on a (pair of) frequency bandwidth based on a value associated with the number of the set of access occasions/TTIs in each of the multiple (pair of) frequency bandwidths. For instance, if the value associated with the number of the first set of access occasions/TTIs of the access procedure in the first (pair of) frequency bandwidth is smaller than the value associated with the number of the second set of access occasions/TTIs of the access procedure in the second (pair of) frequency bandwidth, the first/second device/UE may select/determine to perform the access procedure in the first (pair of) frequency bandwidth. Alternatively, if the value associated with the number of the first set of access occasions/TTIs of the access procedure in the first (pair of) frequency bandwidth is larger than the value associated with the number of the second set of access occasions/TTIs of the access procedure in the second (pair of) frequency bandwidth, the first/second device/UE may select/determine to perform the access procedure in the first (pair of) frequency bandwidth. Preferably in certain embodiments, when the value associated with the number of the first set of access occasions/TTIs of the access procedure in the first (pair of) frequency bandwidth and the value associated with the number of the second set of access occasions/TTIs of the access procedure in the second (pair of) frequency bandwidth are the same, the first/second device/UE may perform the selection/determination on (pair of) frequency bandwidth randomly.

Preferably in certain embodiments, the first/second device/UE may perform the selection/determination on (pair of) frequency bandwidth based on a type of reader (network/intermediate node). Preferably in certain embodiments, there may be association between the type of reader and (pair of) frequency bandwidth. Preferably in certain embodiments, the (R2D) paging/query information may indicate the type of reader. For example, if the first/second device/UE receives a (R2D) paging/query information from a first type of reader (e.g., a network), the first/second device/UE may select/determine to perform the access procedure in the first (pair of) frequency bandwidth. If the first/second device/UE receives a (R2D) paging/query information from a second type of reader (e.g., a UE), the first/second device/UE may select/determine to perform the access procedure in the second (pair of) frequency bandwidth. The first type and/or the second type may be (or comprise) a network, a base station, a gNB, an intermediate node, and/or a UE. The first type and the second type may be different.

Preferably in certain embodiments, the first/second device/UE may perform the selection/determination based on an interface between the first/second device/UE and the reader (network/intermediate node). Preferably in certain embodiments, there may be association between the interface and (pair of) frequency bandwidth. Preferably in certain embodiments, the (R2D) paging/query information may indicate the interface. For example, if the first/second device/UE receives a (R2D) paging/query information via a first interface (e.g., Uu interface), the first/second device/UE may select/determine to perform the access procedure in the first (pair of) frequency bandwidth. If the first/second device/UE receives a (R2D) paging/query information via a second interface (e.g., PC5 interface), the first/second device/UE may select/determine to perform the access procedure in the second (pair of) frequency bandwidth. For another example, if the first device/UE receives a (R2D) paging/query information via a first channel or a first resource belonging to the first interface (e.g., Uu interface), the first device/UE may select/determine to perform the access procedure in the first (pair of) frequency bandwidth. If the first device/UE receives a (R2D) paging/query information via a second channel or a second resource belonging to the second interface (e.g., PC5 interface), the first device/UE may select/determine to perform the access procedure in the second (pair of) frequency bandwidth. The first interface and/or the second interface may be (or comprise) a Uu interface, a PC5 interface, an interface between a UE and a NW, and/or an interface between a UE and a UE. The first interface and the second interface may be different. Preferably in certain embodiments, the first device/UE may be able to distinguish the first interface and the second interface. The first device/UE may be able to distinguish the first channel and the second channel.

Preferably in certain embodiments, the first/second device/UE may perform the selection/determination based on one or more characteristics of target device(s)/UE(s) of a received (R2D) paging/query information. For example, if different (pair of) frequency bandwidths are associated with different one or more characteristics of the target device(s)/UE(s), the first/second device/UE may select/determine to perform the access procedure in a (pair of) frequency bandwidth associated with matched one or more characteristics. If the first device/UE receives a (R2D) paging/query information targeting first one or more characteristics of the target device(s)/UE(s) and the first device/UE satisfies the first one or more characteristics, the first device/UE may select/determine to perform the access procedure in a (pair of) frequency bandwidth associated with the first one or more characteristics, e.g., in the first (pair of) frequency bandwidth. If the second device/UE receives a (R2D) paging/query information (also) targeting a second one or more characteristics of the target device(s)/UE(s) and the second device/UE satisfies the second one or more characteristics, the second device/UE may select/determine to perform the access procedure in a (pair of) frequency bandwidth associated with the second one or more characteristics, e.g., in the second (pair of) frequency bandwidth. The one or more characteristics may be (or include) any of type of target device/UE, priority of a UE type, priority of a UE group, priority of a service/data/report type, latency requirement of a pending service/data/report type, and amount of the set of UEs.

For instance, the first device/UE may determine/select the first (pair of) frequency bandwidth to perform/initiate the access procedure. The first device/UE may select/determine one access occasion/TTI, among the first set of access occasions/TTIs, to transmit a first (D2R) signal/transmission to the network/intermediate node. Preferably in certain embodiments, after the first device/UE transmits the first (D2R) signal/transmission in the first (pair of) frequency bandwidth, the first device/UE may monitor/detect/receive a first valid (R2D) response associated with the first (D2R) signal/transmission in the first (pair of) frequency bandwidth. Preferably in certain embodiments, the first device/UE may randomly select/determine the one access occasion/TTI, among the first set of access occasions/TTIs. Preferably in certain embodiments, for contention-free access procedure, there may be (only) one access occasions/TTI in the first set of access occasions/TTIs. Preferably in certain embodiments, (for a contention-free access procedure,) the first (R2D) paging/query information may indicate the first device/UE to determine/select/utilize the first (pair of) frequency bandwidth to perform/initiate the access procedure (e.g., the first (R2D) paging/query information indicates identity of the first device/UE and indication of the first (pair of) frequency bandwidth). Preferably in certain embodiments, for a contention-free access procedure, the first device/UE may determine/select/utilize the first (pair of) frequency bandwidth, where the first device/UE receives the first (R2D) paging/query information, to perform/initiate the access procedure. The first device/UE may transmit the first (D2R) signal/transmission in the one access occasions/TTI in the first (pair of) frequency bandwidth.

For instance, the second device/UE may determine/select the second (pair of) frequency bandwidth to perform/initiate the access procedure. The second device/UE may select/determine one access occasion/TTI, among the second set of access occasions/TTIs, to transmit a second (D2R) signal/transmission to the network/intermediate node. Preferably in certain embodiments, after the second device/UE transmits the second (D2R) signal/transmission in the second (pair of) frequency bandwidth, the second device/UE may monitor/detect/receive a second valid (R2D) response associated with the second (D2R) signal/transmission in the second (pair of) frequency bandwidth. Alternatively and/or preferably in certain embodiments, after the second device/UE transmits the second (D2R) signal/transmission in the second (pair of) frequency bandwidth, the second device/UE may monitor/detect/receive a second valid (R2D) response associated with the second (D2R) signal/transmission in the first (pair of) frequency bandwidth (i.e., monitor/detect/receive the second valid (R2D) response in the (pair of) frequency bandwidth wherein the second device/UE receives the first (R2D) paging/query information). Preferably in certain embodiments, the second device/UE may randomly select/determine the one access occasion/TTI, among the second set of access occasions/TTIs. Preferably in certain embodiments, (for a contention-free access procedure,) the first (R2D) paging/query information may indicate the second device/UE to determine/select/utilize the second (pair of) frequency bandwidth to perform/initiate the access procedure (e.g., the first (R2D) paging/query information indicates identity of the second device/UE and indication of the second (pair of) frequency bandwidth). The second device/UE may transmit the second (D2R) signal/transmission in the one access occasions/TTI in the second (pair of) frequency bandwidth.

Preferably in certain embodiments, the first/second device/UE may (restrict to) perform one access procedure in (only) one (pair of) frequency bandwidth (at least for D2R transmission(s) associated with the one access procedure). The first/second device/UE may prevent from performing the one access procedure in more than one (pairs of) frequency bandwidth in/at the same time (period/duration) (at least for D2R transmission(s) associated with the one access procedure). The first/second device/UE may not allow to perform more than one access procedure in more than one (pairs of) frequency bandwidth in/at the same time (period/duration).

Preferably in certain embodiments, the (pair of) frequency bandwidth may comprise one frequency bandwidth for R2D (from the network/intermediate node to device(s)/UE(s)) transmission/reception and D2R (from device(s)/UE(s) to the network/intermediate node) transmission/reception. In other words, for the (pair of) frequency bandwidth, its R2D frequency bandwidth is the same as its D2R frequency bandwidth, e.g., in frequency domain. The D2R transmission/reception/operation and R2D transmission/reception/operation may be TDMed.

Alternatively and/or preferably in certain embodiments, the (pair of) frequency bandwidth may comprise one R2D (from the network/intermediate node to device(s)/UE(s)) frequency bandwidth for R2D transmission/reception and one D2R (from device(s)/UE(s) to the network/intermediate node) frequency bandwidth for D2R transmission/reception. The one R2D frequency bandwidth and the one D2R frequency bandwidth may be linked/paired as the (pair of) frequency bandwidth. The D2R transmission/reception/operation and R2D transmission/reception/operation may be FDMed.

Preferably in certain embodiments, the network/intermediate node may provide pairing/linking information of one (pair of) frequency bandwidth, e.g., a frequency shift between the one R2D frequency bandwidth and the one D2R frequency bandwidth or between center frequency of the one R2D frequency bandwidth and center frequency of the one D2R frequency bandwidth, and/or any of frequency location, bandwidth, starting point of the D2R frequency bandwidth. Preferably in certain embodiments, the network/intermediate node may provide pairing/linking information of multiple (pair of) frequency bandwidths, e.g., multiple frequency shifts including a first frequency shift between the one R2D frequency bandwidth and a first D2R frequency bandwidth or between center frequency of the one R2D frequency bandwidth and center frequency of the first D2R frequency bandwidth and a second frequency shift between the one R2D frequency bandwidth and a second D2R frequency bandwidth or between center frequency of the one R2D frequency bandwidth and center frequency of the second D2R frequency bandwidth, and/or any of frequency location, bandwidth, starting point of each of the D2R frequency bandwidths. Preferably in certain embodiments, the pairing/linking information may be provided/transmitted/comprised in the paging/query information. Alternatively and/or preferably in certain embodiments, the pairing/linking information may be provided/transmitted/comprised in a configuration provided from the network/intermediate node. Alternatively and/or preferably in certain embodiments, the pairing/linking information may be specified or (pre-) configured or fixed.

Preferably in certain embodiments, the network/intermediate node may transmit the first (R2D) paging/query information in a first R2D frequency bandwidth. Preferably in certain embodiments, the first (R2D) paging/query information in the first R2D frequency bandwidth may indicate/comprise information of a first D2R frequency bandwidth. Preferably in certain embodiments, the first device/UE in the instance above may transmit the first (D2R) signal/transmission in the first D2R frequency bandwidth. Preferably in certain embodiments, the first device/UE in instance above may receive the first valid (R2D) response in the first R2D frequency bandwidth. Preferably in certain embodiments, the second device/UE in the instance above may transmit the second (D2R) signal/transmission in the second D2R frequency bandwidth. Preferably in certain embodiments, the second device/UE in the instance above may receive the second valid (R2D) response in the second R2D frequency bandwidth or the first R2D frequency bandwidth.

Preferably in certain embodiments, the first (R2D) paging/query information in the first R2D frequency bandwidth may indicate/comprise information of a second D2R frequency bandwidth. The second device/UE in the instance above may transmit the second (D2R) signal/transmission in the second D2R frequency bandwidth. The second device/UE in the instance above may receive the second valid (R2D) response in the second R2D frequency bandwidth or in the first R2D frequency bandwidth.

Preferably in certain embodiments, for one access procedure, the network/intermediate node may transmit the first (R2D) paging/query information in (only) one R2D frequency bandwidth, e.g., the first R2D frequency bandwidth.

Preferably in certain embodiments, for one access procedure, the network/intermediate node may transmit the valid (R2D) response in the (only) one R2D frequency bandwidth, e.g., the one R2D frequency bandwidth where the network/intermediate node transmits the first (R2D) paging/query information.

Preferably in certain embodiments, for one access procedure, the network/intermediate node may transmit the valid (R2D) response in a second R2D frequency bandwidth, which is determined based on the first R2D frequency bandwidth. Preferably in certain embodiments, the center frequency of the second R2D frequency bandwidth is the same as the center frequency of the first R2D frequency bandwidth. Preferably in certain embodiments, the second R2D frequency bandwidth comprises the first R2D frequency bandwidth. Preferably in certain embodiments, the second R2D frequency bandwidth is comprised in the first R2D frequency bandwidth. Preferably in certain embodiments, the second R2D frequency bandwidth is the same or identical to the first R2D frequency bandwidth.

Preferably and/or alternatively in certain embodiments, (for one access procedure), the network/intermediate node may transmit a valid (R2D) response in an R2D frequency bandwidth paired/linked to a D2R frequency bandwidth where the network/intermediate node receives a corresponding (D2R) signal/transmission.

Preferably in certain embodiments, the first/second device/UE may monitor/detect/receive (R2D) paging/query information in (only) one (pair of) frequency bandwidth (among the multiple (pairs of) frequency bandwidths). More specifically, the first/second device/UE may monitor/detect/receive (R2D) paging/query information in (only) one R2D frequency bandwidth (among the multiple R2D frequency bandwidths). Preferably in certain embodiments, the one (pairs of) frequency bandwidth or the one R2D frequency bandwidth on which the first/second device/UE may monitor/detect/receive (R2D) paging/query information may depend on a frequency resource, wherein the first/second device/UE receives/detects a carrier wave (signal). Preferably in certain embodiments, (when the first/second device/UE powers on or becomes active,) the first/second device/UE may receive/acquire information of the first (pairs of) frequency bandwidths or the first R2D frequency bandwidths provided by the network/intermediate node or by specification or by (pre-) configuration. Preferably in certain embodiments, (when the first/second device/UE powers on or becomes active,) the first/second device/UE may receive/acquire information of available (pairs of) frequency bandwidths or available R2D frequency bandwidths, e.g., the multiple (pairs of) frequency bandwidths or the multiple R2D frequency bandwidths, provided by the network/intermediate node or by specification or by (pre-) configuration. Preferably in certain embodiments, the first/second device/UE may determine/derive/select the one R2D frequency bandwidths, among the multiple R2D frequency bandwidths, for monitoring/detecting/receiving (R2D) paging/query information, e.g., based on a configuration or indication provided by the network/intermediate node or by specification or by (pre-) configuration. Preferably in certain embodiments, the first/second device/UE may monitor/detect/receive (R2D) paging/query information in the one R2D frequency bandwidths, e.g., if feasible.

Preferably in certain embodiments, the first device/UE may receive the first (R2D) paging/query information in the first R2D frequency bandwidth in a first reception timing/occasion/TTI. The second device/UE may receive the first (R2D) paging/query information in the first R2D frequency bandwidth in the first reception timing/occasion/TTI.

Preferably in certain embodiments, for one access procedure, the first/second device/UE may monitor/detect/receive the first/second valid (R2D) response in the first R2D frequency bandwidth, e.g., the one R2D frequency bandwidth where the first/second device/UE receives the first (R2D) paging/query information.

Preferably in certain embodiments, for one access procedure, the first/second device/UE may monitor/detect/receive the first/second valid (R2D) response in a second R2D frequency bandwidth, which is determined based on the first R2D frequency bandwidth. Preferably in certain embodiments, the center frequency of the second R2D frequency bandwidth is the same as the center frequency of the first R2D frequency bandwidth. Preferably in certain embodiments, the second R2D frequency bandwidth comprises the first R2D frequency bandwidth. Preferably in certain embodiments, the second R2D frequency bandwidth is comprised in the first R2D frequency bandwidth. Preferably in certain embodiments, the second R2D frequency bandwidth is the same or identical to the first R2D frequency bandwidth.

Preferably and/or alternatively in certain embodiments, (for one access procedure), the first device/UE may monitor/detect/receive the first valid (R2D) response in an R2D frequency bandwidth paired/linked to a D2R frequency bandwidth where the first device/UE transmits the first (D2R) signal/transmission. The second device/UE may monitor/detect/receive the second valid (R2D) response in an R2D frequency bandwidth paired/linked to a D2R frequency bandwidth where the second device/UE transmits the second (D2R) signal/transmission.

Preferably in certain embodiments, the first/second device/UE may monitor/detect/receive (R2D) paging/query information in one R2D frequency bandwidth at a time. The first/second device/UE may not (able to) monitor/detect/receive (R2D) paging/query information in more than one R2D frequency bandwidth at the same time.

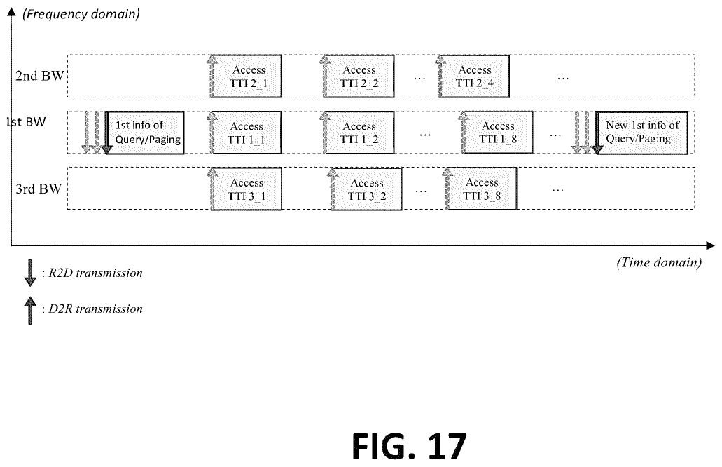

Preferably in certain embodiments, FIG. 17 shows an exemplary instance. The network/intermediate node may perform/support 1st access procedure in a 1st (pair of) frequency bandwidth (denoted as a 1st BW in FIG. 17), a 2nd (pair of) frequency bandwidth (denoted as a 2nd BW in FIG. 17), and a 3rd (pair of) frequency bandwidth (denoted as a 3rd BW in FIG. 17). Note that FIG. 17 shows an instance that R2D frequency bandwidth is the same as one D2R frequency bandwidth. It is possible that the R2D frequency bandwidth is different from one D2R frequency bandwidth. It is also possible that each R2D frequency bandwidth is associated with a D2R frequency bandwidth in different frequency resources. Note that there may or may not be a guard band between two adjacent (pair of) frequency bandwidths or two R2D frequency bandwidths or two D2R frequency bandwidths.

As shown in the instance of FIG. 17, there may be 8 access occasions/TTIs, i.e., access TTI 1_1˜1_8, for the 1st (pair of) frequency bandwidth. There may be 4 access occasions/TTIs, i.e., access TTI 2_1˜2_4, for the 2nd (pair of) frequency bandwidth. There may be 8 access occasions/TTIs, i.e., access TTI 3_1˜3_8, for the 3rd (pair of) frequency bandwidth. FIG. 17 shows the instance that each (pair of) frequency bandwidth for the access procedure may comprise different access occasions/TTIs. It is also possible that two or more or all of multiple (pair of) frequency bandwidths for the access procedure may comprise the same number of access occasions/TTIs. Preferably in certain embodiments, the network/intermediate node may transmit an R2D signaling for indicating change/switch of access occasion/TTI before each access occasion/TTI (except for the first access occasion/TTI) separately/independently for each (pair of) frequency bandwidth. In response to reception of the R2D signaling, the first device/UE can derive/determine an access occasion/TTI and/or acquire (DL or R2D) timing synchronization. The first device/UE may perform corresponding D2R transmission based on the timing synchronization or based on the reception time of the R2D signaling/transmission. The first device/UE may perform a D2R transmission based on the timing synchronization or based on the reception time of a closest/nearest R2D signaling/transmission before the D2R transmission.

Preferably in certain embodiments, for the access procedure, time gap between an adjacent access occasion/TTI may be fixed or varied (in physical timing or in (micro-) second aspect). FIG. 17 shows the instance that a time gap between adjacent access occasions/TTIs is varied. Thus, it is possible that access TTI 3_8 is earlier than access TTI 1_8 in time domain. The first device/UE and the second device/UE may receive the 1st information of Query/paging in the 1st BW. For the access procedure, the first device/UE may determine/select the 1st BW and the Access TTI 1_7 for transmitting the first (D2R) signal/transmission. For the access procedure, the second device/UE may determine/select the 2nd BW and the Access TTI 2_2 for transmitting the second (D2R) signal/transmission.

### Concept C

The concept C is that a network/intermediate node may perform/support one or more access procedures in a first one or more (pairs of) frequency bandwidths (in/at the same time (period/duration)). The network/intermediate node may perform/support a (data or control) communication operation in a second one or more (pairs of) frequency bandwidths (in/at the same time (period/duration)). Preferably in certain embodiments, the network/intermediate node may perform the one or more access procedures in the first one or more (pairs of) frequency bandwidths and perform the (data or control) communication operation in the second one or more (pairs of) frequency bandwidths in/at the same time (period/duration).

Preferably in certain embodiments, the network/intermediate node may not perform (or may prevent/exclude from performing) the one or more access procedures in the second one or more (pairs of) frequency bandwidths.

Preferably in certain embodiments, the network/intermediate node may not perform (or may prevent/exclude from performing) the (data or control) communication operation in the first one or more (pairs of) frequency bandwidths. Alternatively and/or preferably in certain embodiments, the network/intermediate node may (be able to) perform the (data or control) communication operation in the first one or more (pairs of) frequency bandwidths.

Preferably in certain embodiments, the first one or more (pairs of) frequency bandwidths may be non-overlapped, in frequency domain, with the second one or more (pairs of) frequency bandwidths (at a time).

Preferably in certain embodiments, the second one or more (pairs of) frequency bandwidths may be other than the first one or more (pairs of) frequency bandwidths, e.g., from the aspect of a carrier wave (signal). Preferably in certain embodiments, the second one or more (pairs of) frequency bandwidths may be associated with a larger frequency shift than the first one or more (pairs of) frequency bandwidths, e.g., from the aspect of a carrier wave (signal) or from the first (pair of) frequency bandwidth wherein the (R2D) paging/query information is transmitted/received.

Preferably in certain embodiments, frequency resource size (e.g., in level of Hz, MHz, subcarrier, Resource Block (RB), Physical Resource Block (PRB), or sub-channel) of each of the first one or more (pairs of) frequency bandwidths may be the same as the frequency resource size (e.g., in level of Hz, MHz, subcarrier, RB, PRB, or sub-channel) of each of the second one or more (pairs of) frequency bandwidths. Alternatively and/or preferably in certain embodiments, the frequency resource size (e.g., in level of Hz, MHz, subcarrier, RB, PRB, or sub-channel) of each of the first one or more (pairs of) frequency bandwidths may be different from the frequency resource size (e.g., in level of Hz, MHz, subcarrier, RB, PRB, or sub-channel) of each of the second one or more (pairs of) frequency bandwidths. Preferably in certain embodiments, the frequency resource size of each of the first one or more (pairs of) frequency bandwidths and the frequency resource size of each of the second one or more (pairs of) frequency bandwidths may be (pre-) configured or specified separately/independently.

Preferably in certain embodiments, a first device/UE may perform an access procedure in at least a first (pair of) frequency bandwidth and/or a second (pair of) frequency bandwidth among the first one or more (pairs of) frequency bandwidths. Preferably in certain embodiments, in/for the access procedure, the first device/UE may perform any one or a combination of (at least) receiving a (R2D) paging/query information, transmitting a (D2R) signal/transmission, receiving a valid (R2D) response associated with the first (D2R) signal/transmission, and/or transmitting a device/UE information after receiving the valid (R2D) response. The device/UE information may comprise an identifier associated with the first device/UE. The device/UE information may not comprise the identifier associated with the first device/UE. More specifically, the first device/UE may receive the (R2D) paging/query information for the access procedure within the first one or more (pairs of) frequency bandwidths, e.g., in the first (pair of) frequency bandwidth and/or the second (pair of) frequency bandwidth. The first device/UE may transmit the (D2R) signal/transmission for the access procedure within the first one or more (pairs of) frequency bandwidths, e.g., in the first (pair of) frequency bandwidth and/or the second (pair of) frequency bandwidth. The first device/UE may receive the valid (R2D) response, associated with the first (D2R) signal/transmission, within the first one or more (pairs of) frequency bandwidths, e.g., in the first (pair of) frequency bandwidth and/or the second (pair of) frequency bandwidth. The first device/UE may transmit the device/UE information, after receiving a valid (R2D) response, within the first one or more (pairs of) frequency bandwidths, e.g., in the first (pair of) frequency bandwidth and/or the second (pair of) frequency bandwidth. Preferably in certain embodiments, the access procedure may be performed based on Concept A and/or Concept B.

Preferably in certain embodiments, a first device/UE may perform a (data or control) communication operation in at least a third (pair of) frequency bandwidth among the second one or more (pairs of) frequency bandwidths. Preferably in certain embodiments, in/for the (data or control) communication operation, the first device/UE may perform any one or a combination of receiving a (R2D) scheduling/control/data transmission(s), transmitting a (D2R) control/data/report transmission(s). More specifically, the first device/UE may receive the (R2D) scheduling/control/data transmission(s) within the second one or more (pairs of) frequency bandwidths, e.g., in the third (pair of) frequency bandwidth. The first device/UE may transmit the (D2R) control/data/report transmission(s) within the second one or more (pairs of) frequency bandwidths, e.g., in the third (pair of) frequency bandwidth.

Preferably in certain embodiments, the first device/UE may receive a specific indication/signaling for performing/initiating the (data or control) communication operation. Preferably in certain embodiments, the first device/UE may receive a specific indication/signaling for switching a (pair of) frequency bandwidth to perform the (data or control) communication operation. Preferably in certain embodiments, the specific indication/signaling may indicate at least one (pair of) frequency bandwidth among the second one or more (pairs of) frequency bandwidths, e.g., the specific indication/signaling may indicate the third (pair of) frequency bandwidth. The specific indication/signaling may indicate an identifier associated with the first device/UE (e.g., (complete or partial) ID of the first device/UE).

Preferably in certain embodiments, in response to or when the first device/UE receives the specific indication/signaling, the first device/UE may (determine/start to) perform/initiate the (data or control) communication operation in the indicated one (pair of) frequency bandwidth, e.g., the third (pair of) frequency bandwidth. Preferably in certain embodiments, in response to or when the first device/UE receives the specific indication/signaling and/or when/after the first device/UE switches to the third (pair of) frequency bandwidth, the first device/UE may stop/abort/discard/cancel monitoring/detecting/receiving within the first one or more (pairs of) frequency bandwidths. Preferably in certain embodiments, in response to or when the first device/UE receives the specific indication/signaling and/or when/after the first device/UE switches to the third (pair of) frequency bandwidth, the first device/UE may stop/abort/discard/cancel monitoring/detecting/receiving in the (pair of) frequency bandwidth(s) for performing the access procedure, e.g., the first (pair of) frequency bandwidth and the second (pair of) frequency bandwidth. Preferably in certain embodiments, in response to or when the first device/UE receives the specific indication/signaling and/or when/after the first device/UE switches to the third (pair of) frequency bandwidth, the first device/UE may (start/continue to) monitor/detect/receive R2D transmission(s), e.g., the (R2D) scheduling/control/data transmission(s), in the third (pair of) frequency bandwidth(s). Preferably in certain embodiments, in response to or when the first device/UE receives the specific indication/signaling and/or when/after the first device/UE switches to the third (pair of) frequency bandwidth, the first device/UE may (start/continue to) perform D2R transmission(s), e.g., the (D2R) control/data/report transmission(s), in the third (pair of) frequency bandwidth(s). Preferably in certain embodiments, in response to or when the first device/UE receives the specific indication/signaling and/or when/after the first device/UE switches to the third (pair of) frequency bandwidth, the first device/UE may continue/keep operation, e.g., the (data or control) communication operation, in the third (pair of) frequency bandwidth(s).

Preferably in certain embodiments, in response to or when the first device/UE receives the specific indication/signaling, the first device/UE may consider the access procedure as (successfully) completed. Preferably in certain embodiments, in response to or when the first device/UE receives the specific indication/signaling, the first device/UE may complete the access procedure. Preferably in certain embodiments, in response to or when the first device/UE receives the specific indication/signaling, the first device/UE may stop the access procedure. Preferably in certain embodiments, the specific indication/signaling may be comprised/included in a (R2D) transmission for indicating/informing (successfully) completion of the access procedure.

Preferably in certain embodiments, the network/intermediate node may transmit the specific indication/signaling to the first device/UE after receiving the (D2R) signal/transmission for the access procedure from the first device/UE. The first device/UE may monitor/detect/receive the specific indication/signaling after transmitting the (D2R) signal/transmission for the access procedure to the network/intermediate node. Preferably in certain embodiments, the access procedure may be a contention-free access procedure (or contention-based access procedure).

Preferably in certain embodiments, the network/intermediate node may transmit the specific indication/signaling to the first device/UE after receiving the device/UE information from the first device/UE. The first device/UE may monitor/detect/receive the specific indication/signaling after transmitting the device/UE information to the network/intermediate node. Preferably in certain embodiments, the access procedure may be a contention-based access procedure or a contention-free access procedure.

Preferably in certain embodiments, the network/intermediate node may transmit the specific indication/signaling to the first device/UE in a (R2D) scheduling/control/data transmission, e.g., after completion of the access procedure. The first device/UE may monitor/detect/receive the (R2D) scheduling/control/data transmission(s) after completion of the access procedure. The first device/UE may perform a (D2R) control/data/report transmission in response to reception of the (R2D) scheduling/control/data transmission.

Preferably in certain embodiments, the first device/UE may (restrict to) perform an R2D reception and/or a D2R transmission in one (pair of) frequency bandwidth at/in a time (period/duration).

Preferably in certain embodiments, the (pair of) frequency bandwidth may comprise one frequency bandwidth for R2D (from the network/intermediate node to the device(s)/UE(s)) transmission/reception and D2R (from the device(s)/UE(s) to the network/intermediate node) transmission/reception. In other words, for the (pair of) frequency bandwidth, its R2D frequency bandwidth is the same as its D2R frequency bandwidth, e.g., in frequency domain. The D2R transmission/reception/operation and R2D transmission/reception/operation may be TDMed.

Alternatively and/or preferably in certain embodiments, the (pair of) frequency bandwidth may comprise one R2D (from the network/intermediate node to the device(s)/UE(s)) frequency bandwidth for R2D transmission/reception and one D2R (from the device(s)/UE(s) to the network/intermediate node) frequency bandwidth for D2R transmission/reception. The one R2D frequency bandwidth and the one D2R frequency bandwidth may be linked/paired as the (pair of) frequency bandwidth. The D2R transmission/reception/operation and R2D transmission/reception/operation may be FDMed.

Preferably in certain embodiments, the network/intermediate node may provide pairing/linking information of one (pair of) frequency bandwidth, e.g., a frequency shift between the one R2D frequency bandwidth and the one D2R frequency bandwidth or between the center frequency of the one R2D frequency bandwidth and the center frequency of the one D2R frequency bandwidth, and/or any of frequency location, bandwidth, starting point of the D2R frequency bandwidth. Preferably in certain embodiments, the pairing/linking information may be provided/transmitted/comprised in the paging/query information. Preferably in certain embodiments, the pairing/linking information may be provided/transmitted/comprised in the specific indication/signaling. Alternatively and/or preferably in certain embodiments, the pairing/linking information may be provided/transmitted/comprised in a configuration provided from the network/intermediate node. Alternatively and/or preferably in certain embodiments, the pairing/linking information may be specified or (pre-) configured or fixed.

Preferably in certain embodiments, the network/intermediate node may transmit the (R2D) paging/query information in a first R2D frequency bandwidth. Preferably in certain embodiments, the (R2D) paging/query information in the first R2D frequency bandwidth may indicate/comprise information of a first D2R frequency bandwidth. Preferably in certain embodiments, the first device/UE may transmit the (D2R) signal/transmission in the first D2R frequency bandwidth. Preferably in certain embodiments, the first device/UE may receive the valid (R2D) response in the first R2D frequency bandwidth. Preferably in certain embodiments, the first device/UE may transmit the device/UE information in the first D2R frequency bandwidth.

Preferably in certain embodiments, the (R2D) paging/query information in the first R2D frequency bandwidth may indicate/comprise information of a second D2R frequency bandwidth. Preferably and/or alternatively in certain embodiments, the first device/UE may transmit the (D2R) signal/transmission in the second D2R frequency bandwidth. The first device/UE may receive the valid (R2D) response in the second R2D frequency bandwidth or in the first R2D frequency bandwidth. Preferably in certain embodiments, the first device/UE may transmit the device/UE information in the second D2R frequency bandwidth or the first D2R frequency bandwidth.

Preferably in certain embodiments, the network/intermediate node may transmit the (R2D) paging/query information in (only) one R2D frequency bandwidth, e.g., the first R2D frequency bandwidth.

Preferably in certain embodiments, for one access procedure, the network/intermediate node may transmit the valid (R2D) response in the (only) one R2D frequency bandwidth, e.g., the one R2D frequency bandwidth where the network/intermediate node transmits the first (R2D) paging/query information.

Preferably and/or alternatively in certain embodiments, (for one access procedure), the network/intermediate node may transmit the valid (R2D) response in an R2D frequency bandwidth paired/linked to a D2R frequency bandwidth where the network/intermediate node receives corresponding (D2R) signal/transmission.

Preferably in certain embodiments, the network/intermediate node may transmit the specific indication/signaling in the (only) one R2D frequency bandwidth, e.g., the one R2D frequency bandwidth where the network/intermediate node transmits the (R2D) paging/query information.

Preferably and/or alternatively in certain embodiments, (for one access procedure), the network/intermediate node may transmit the specific indication/signaling in an R2D frequency bandwidth paired/linked to a D2R frequency bandwidth where the network/intermediate node receives corresponding (D2R) signal/transmission or receives the device/UE information.

Preferably in certain embodiments, the first device/UE may monitor/detect/receive the (R2D) paging/query information in (only) one (pair of) frequency bandwidth (among the first one or more (pairs of) frequency bandwidths). More specifically, the first device/UE may monitor/detect/receive the (R2D) paging/query information in (only) one R2D frequency bandwidth (among the first one or more R2D frequency bandwidths). Preferably in certain embodiments, the one (pair of) frequency bandwidth or the one R2D frequency bandwidth on which the first device/UE may monitor/detect/receive the (R2D) paging/query information may depend on a frequency resource, wherein the first device/UE receives/detects a carrier wave (signal). Preferably in certain embodiments, (when the first device/UE powers on or becomes active,) the first device/UE may receive/acquire information of the one (pair of) frequency bandwidth or the one R2D frequency bandwidth provided by the network/intermediate node or by specification or by (pre-) configuration.

Preferably in certain embodiments, (when the first device/UE powers on or becomes active,) the first device/UE may receive/acquire information of available (pairs of) frequency bandwidths or available R2D frequency bandwidths, e.g., the first one or more (pairs of) frequency bandwidths or the first one or more R2D frequency bandwidths, provided by the network/intermediate node or by specification or by (pre-) configuration. Preferably in certain embodiments, the first device/UE may determine/derive/select the one R2D frequency bandwidth, among the first one or more R2D frequency bandwidths, for monitoring/detecting/receiving the (R2D) paging/query information, e.g., based on configuration or indication provided by the network/intermediate node or by specification or by (pre-) configuration. Preferably in certain embodiments, the first/device/UE may monitor/detect/receive the (R2D) paging/query information in the one R2D frequency bandwidth, e.g., if feasible.

Preferably in certain embodiments, the first device/UE may receive the (R2D) paging/query information in the first R2D frequency bandwidth in a first reception timing/occasion/TTI.

Preferably in certain embodiments, for the access procedure, the first device/UE may monitor/detect/receive the valid (R2D) response in the first R2D frequency bandwidth, e.g., the one R2D frequency bandwidth where the first device/UE receives the first (R2D) paging/query information.

Preferably and/or alternatively in certain embodiments, (for the access procedure), the first device/UE may monitor/detect/receive the valid (R2D) response in an R2D frequency bandwidth paired/linked to a D2R frequency bandwidth where the first device/UE transmits the (D2R) signal/transmission.

Preferably in certain embodiments, for the access procedure, the first device/UE may monitor/detect/receive the specific indication/signaling in the first R2D frequency bandwidth, e.g., the one R2D frequency bandwidth where the first device/UE receives the (R2D) paging/query information.

Preferably and/or alternatively in certain embodiments, (for the access procedure), the first device/UE may monitor/detect/receive the specific indication/signaling in an R2D frequency bandwidth paired/linked to a D2R frequency bandwidth where the first device/UE transmits the (D2R) signal/transmission or the device/UE information.

Preferably in certain embodiments, the first device/UE may monitor/detect/receive the (R2D) paging/query information in one R2D frequency bandwidth at a time. The first/second device/UE may not (be able to) monitor/detect/receive (R2D) paging/query information in more than one R2D frequency bandwidth at the same time.

Preferably in certain embodiments, the first device/UE may monitor/detect/receive the specific indication/signaling in one R2D frequency bandwidth at a time. The first/second device/UE may not (be able to) monitor/detect/receive the specific indication/signaling in more than one R2D frequency bandwidth at the same time.

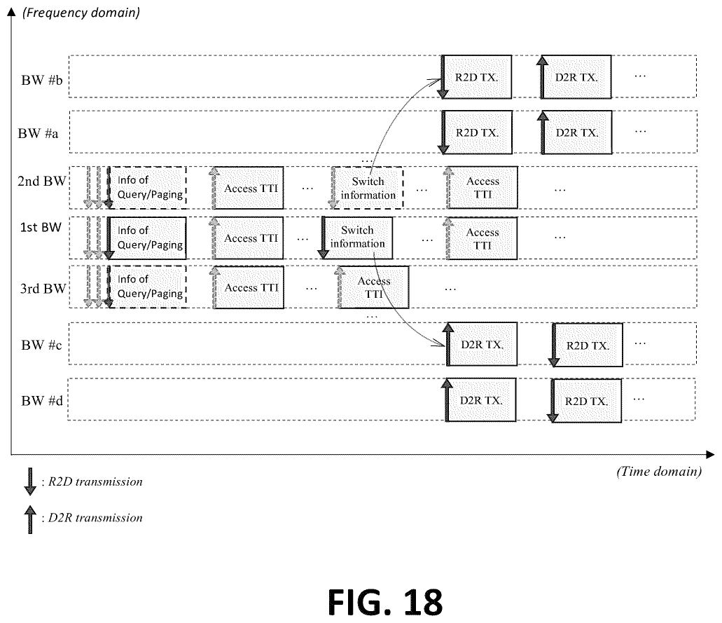

Preferably in certain embodiments, FIG. 18 shows an exemplary instance. The network/intermediate node may perform/support one or multiple access procedures in a 1st access procedure in a 1st (pair of) frequency bandwidth (denoted as a 1st BW in FIG. 18), a 2nd (pair of) frequency bandwidth (denoted as a 2nd BW in FIG. 18), and a 3rd (pair of) frequency bandwidth (denoted as a 3rd BW in FIG. 18). Note that FIG. 18 shows an instance that the R2D frequency bandwidth is the same as the D2R frequency bandwidth. It is possible that the R2D frequency bandwidth is different from the D2R frequency bandwidth. It is also possible that each R2D frequency bandwidth is associated with a D2R frequency bandwidth in different frequency resources. Note that there may or may not be a guard band between two adjacent (pair of) frequency bandwidths or two R2D frequency bandwidths or two D2R frequency bandwidths. Note that FIG. 18 shows an instance of three (pair of) frequency bandwidths for supporting the access procedure(s). It is also possible that the network/intermediate node may perform/support (only) one (pair of) frequency bandwidth for the access procedure.

As shown in the instance of FIG. 18, a first device/UE may transmit its (D2R) signal/transmission in an access TTI in a 1st BW, and may receive a switch information (e.g., the specific indication/signaling) for a (pair of) frequency bandwidth, denoted as BW #c. The switch information may indicate an identifier associated with the first device/UE (e.g., (complete or partial) ID of the first device/UE). The switch information may indicate the (pair of) frequency bandwidth (e.g., BW #c) or a frequency shift associated with the (pair of) frequency bandwidth (e.g., form the 1st BW). The first device/UE may consider the access procedure on the 1st BW successful. The first device/UE may perform a (data or control) communication operation in the BW #c, e.g., receiving one or more (R2D) scheduling/control/data transmission(s) or transmitting one or more (D2R) control/data/report transmission(s). The first device/UE may perform a first (D2R) control/data/report transmission in response to reception of the switch information.

As shown in the instance of FIG. 18, a second device/UE may transmit its (D2R) signal/transmission in an access TTI in a 2nd BW, and may receive a switch information (e.g., the specific indication/signaling) for a (pair of) frequency bandwidth, denoted as BW #b. The switch information may indicate an identifier associated with the second device/UE (e.g., (complete or partial) ID of the second device/UE). The switch information may indicate the (pair of) frequency bandwidth (e.g., BW #b) or a frequency shift associated with the (pair of) frequency bandwidth (e.g., form 2nd BW). The second device/UE may consider the access procedure on the 2nd BW successful. The second device/UE may perform (data or control) communication operation in the BW #b, e.g., receiving one or more (R2D) scheduling/control/data transmission(s) or transmitting one or more (D2R) control/data/report transmission(s). The second device/UE may perform a first (D2R) control/data/report transmission in response to reception of a first (R2D) scheduling/control/data transmission.

As shown in the instance of FIG. 18, the 1st BW, the 2nd BW, and the 3rd BW may be utilized for the access procedure. The BW #a, the BW #b, the BW #c, and the BW #d may be utilized for (data and/or control) communication.

Preferably in certain embodiments, in response to reception of an R2D signaling/transmission, the first device/UE can acquire (DL or R2D) timing synchronization. The first device/UE may perform a corresponding D2R transmission based on the timing synchronization or based on the reception time of the R2D signaling/transmission. The first device/UE may perform a D2R transmission based on the timing synchronization or based on the reception time of a closest/nearest R2D signaling/transmission before the D2R transmission.

Note that any of the above and herein methods, alternatives, instances, concepts, examples, and embodiments (e.g., in Concepts A, B, and C) may be combined, in whole or in part, or applied simultaneously or separately.

Various examples and embodiments of the present invention are described below. For the methods, alternatives, concepts, examples, and embodiments detailed above and herein, the following aspects and embodiments are possible.

Preferably in certain embodiments, the concept C may be combined with any contents in concept A and/or Concept B.

Preferably in certain embodiments, the one or more first/second conditions (provided by the (R2D) paging/query information) may comprise (and not limit to) any combination of the following:

### Target Device(s)/UE(s):

The (R2D) paging/query information may provide information related to targeted device(s)/UE(s).
The (R2D) paging/query information may provide (partial or full) device/UE identity or device/UE group identity. The device/UE with matched device/UE identity or device/UE group may be considered as satisfying the condition.

### Target Device/UE Type:

The (R2D) paging/query information may provide information related to the targeted device/UE type.
The (R2D) paging/query information may indicate one or more device/UE types, e.g., Type 1, Type 2a, Type 2b. The device/UE with a matched device/UE type may be considered as satisfying the condition.

### Intended/Targeted Data/Report:

The (R2D) paging/query information may provide information related to an intended/targeted data/report. The intended/targeted data/report may be associated with the device/UE type, identifier (for the device/UE), data type, data size, UE group, distance/range/location information, traffic information (e.g., QoS), priority (e.g., of the UE/device and/or data), service type.
The device/UE with the available data/report matching the intended/targeted data/report may be considered as satisfying the condition.

### Power Level:

The (R2D) paging/query information may provide information related to a threshold/criterion of power level and/or type of the power level. The power level may be/mean or comprise any of a received power of a signal/channel (e.g., Physical Reader (to Ambient IoT) Device Channel (PRDCH) for transmitting the (R2D) paging/query information, or carrier wave signal), expected/derived/determined device/UE transmit power for backscattering (D2R) transmission, expected/derived/determined device/UE transmit power for backscattering (D2R) transmission, amount of the UE's battery power/stored power/available power, power difference between battery power/stored power/available power, and the expected/derived/determined/maximum device/UE transmit power.

The device/UE with an available power level larger than the threshold/criterion may be considered as satisfying the condition.

Preferably in certain embodiments, the access procedure is utilized for ambient IoT devices/UEs.

Preferably in certain embodiments, the device/UE may access or connect to the network/intermediate node via the access procedure. Preferably in certain embodiments, the device/UE may perform (data or control) transmission(s) and reception(s) with the network/intermediate node via the access procedure. The access procedure may comprise a (data or control) communication operation. Alternatively and/or preferably in certain embodiments, the access procedure may not comprise a (data or control) communication operation. Preferably in certain embodiments, the (data or control) communication operation may be/comprise (at least) transmission(s) and/or reception(s) between the device/UE and the network/intermediate node. The device/UE may perform the (data or control) communication operation comprising (at least) receiving a valid (R2D) response associated with a first (D2R) signal/transmission, transmitting a device/UE information after receiving the valid (R2D) response, receiving a specific indication/signaling, transmitting D2R data/signal transmission(s), and/or receiving R2D data/signal transmission(s).

Preferably in certain embodiments, the access procedure may be/mean (or include) an inventory procedure. Preferably in certain embodiments, the access procedure may be performed for inventory.

Preferably in certain embodiments, the (R2D) paging/query information may be/mean (or include) a Message 0 (MSG0) for the access procedure. Preferably in certain embodiments, the (R2D) paging/query information may be/mean (or include) paging information for indicating one or more devices/UEs. Preferably in certain embodiments, the (R2D) paging/query information may be/mean (or include) query information for initiating the access procedure or inventory procedure. Preferably in certain embodiments, the (R2D) paging/query information may be/mean (or include) information for initiating the access procedure or inventory procedure.

Preferably in certain embodiments, a (R2D) paging/query signaling may be an R2D signaling/transmission for transmitting/comprising part of or the full (R2D) paging/query information. The (R2D) paging/query signaling may be a PRDCH for transmitting/comprising part of or the full (R2D) paging/query information.

Preferably in certain embodiments, the (D2R) signal/transmission may be/mean (or include) a Message 1 (MSG1) or Message A (MSGA) for the access procedure.

Preferably in certain embodiments, the (D2R) signal/transmission (for access procedure) may be/mean (or include) a D2R signaling/transmission for transmitting/comprising a temporary device/UE identity. Preferably in certain embodiments, the (D2R) signal/transmission (for access procedure) may be/mean (or include) a D2R signaling/transmission for transmitting/comprising a random number/value generated by the device/UE performing the access procedure. Preferably in certain embodiments, the (D2R) signal/transmission (for access procedure) may be/mean (or include) a D2R signaling/transmission which indicates a (random) number/value generated by the device/UE performing the access procedure. The (random) number/value may be indicated via a field of the D2R signaling/transmission or via a time/frequency/code resource of the D2R signaling/transmission. Preferably in certain embodiments, the (D2R) signal/transmission may be a PDRCH for transmitting/comprising/indicating the temporary device/UE identity or the (random) number/value.

Preferably in certain embodiments, the (R2D) response associated with the (D2R) signal/transmission may be/mean (or include) a Message 2 (MSG2) or Message B (MSGB) for the access procedure.

Preferably in certain embodiments, the (R2D) response associated with the (D2R) signal/transmission may be/mean (or include) a temporary device/UE identity or a (random) number/value. Preferably in certain embodiments, the valid (R2D) response associated with the (D2R) signal/transmission may be/mean (or include) that the temporary device/UE identity or the (random) number/value in the (R2D) response is the same as the temporary device/UE identity or the (random) number/value in the (D2R) signal/transmission. Preferably in certain embodiments, a non-valid (R2D) response associated with the (D2R) signal/transmission may be/mean (or include) that the temporary device/UE identity or the (random) number/value in the (R2D) response is different from the temporary device/UE identity or the (random) number/value in the (D2R) signal/transmission. Preferably in certain embodiments, the (R2D) response associated with the (D2R) signal/transmission may be/mean (or include) an acknowledgment associated with the (D2R) signal/transmission. The valid (R2D) response may be/mean an ACK or positive acknowledgement. The non-valid (R2D) response may be/mean Negative Acknowledge (NACK) or negative acknowledgement.

Preferably in certain embodiments, the (R2D) response may be transmitted via a PRDCH transmission.

Preferably in certain embodiments, the device/UE information may be/mean (or include) a Message 3 (MSG3) for the access procedure.

Preferably in certain embodiments, the device/UE information may be/mean (or include) a device/UE identity (not the temporary UE identity). Preferably in certain embodiments, the device/UE information may be/mean (or include) a device/UE identity provided by a higher layer of the device/UE. Preferably in certain embodiments, the device/UE information may be/mean (or include) an Electronic Product Code (EPC) or any code for identifying the device/UE. Preferably in certain embodiments, the device/UE may transmit the device/UE information if the device receives the valid (R2D) response. The device/UE may not transmit the device/UE information if the device receives the non-valid (R2D) response. Preferably in certain embodiments, the device/UE information may be transmitted via a PDRCH transmission. Preferably in certain embodiments, the PDRCH transmission for transmitting/comprising the device/UE information may comprise any of an assistance information, device/UE type, device/UE capability, available data/report, need of data/report transmission, and/or power information.

Preferably in certain embodiments, the paging/query information or the paging/query signaling may be/mean a message or a signaling for triggering/requesting the (random) access procedure.

Preferably in certain embodiments, the specific indication/signaling may be/mean a specific message or be comprised in a specific message.

Preferably in certain embodiments, the specific indication/signaling may be/mean (or include) a Message 4 (MSG4) for the access procedure.

Preferably in certain embodiments, the specific indication/signaling may comprise part of or the full device/UE information or identifier. Preferably in certain embodiments, the specific indication/signaling may comprise a specific identity for (data or control) communication operation. Preferably in certain embodiments, the specific indication/signaling may be transmitted via a PRDCH transmission. Preferably in certain embodiments, the PRDCH transmission for transmitting/comprising the specific indication/signaling may comprise scheduling information of the (D2R) control/data/report transmission.

Throughout the present disclosure, an identifier may be used to identify a UE. The identifier may be a UE ID (e.g., ue-Identity). The identifier may be a random number/value (e.g., RN16), temporary number, and/or preamble number (e.g., RAPID). The identifier may be a device ID, UE ID, group ID, Contention Resolution Identity, and/or Radio Network Temporary Identifier (RNTI) of the UE. The identifier may be selected, generated, determined by the UE. The identifier may be indicated, predefined or (pre-) configured by the NW. Throughout the present disclosure, the “identifier” and “identity” may be interchangeable.

Preferably in certain embodiments, the (R2D) scheduling/control/data transmission may be transmitted via PRDCH. Preferably in certain embodiments, the (R2D) scheduling/control/data transmission may comprise/indicate the specific identity.

Preferably in certain embodiments, the (D2R) control/data/report transmission may be transmitted via PDRCH. Preferably in certain embodiments, the (D2R) control/data/report transmission may comprise/indicate the specific identity.

Preferably in certain embodiments, the network/intermediate node may perform/support procedure/communication/operation with non-ambient IoT devices/UEs in some frequency bandwidth, which are separated, with at least some frequency gap or guard band, from the first one or more (pairs of) frequency bandwidths for the access procedure of ambient IoT devices/UEs and/or the second one or more (pairs of) frequency bandwidths for the (data or control) communication operation of ambient IoT devices/UEs.

Preferably in certain embodiments, the R2D frequency bandwidth may be/mean (or include) frequency resources used to perform R2D transmissions/receptions. Preferably in certain embodiments, an R2D frequency bandwidth may be/mean (or include) frequency resources used to perform (only) one R2D transmission/reception. Preferably in certain embodiments, the R2D frequency bandwidth may be/mean an R2D frequency resource, e.g., used for performing one R2D transmission/reception. Preferably and/or alternatively in certain embodiments, the network/intermediate node may perform one PRDCH (restricted to be) within one R2D frequency bandwidth. Preferably in certain embodiments, the network/intermediate node may not perform (or prevent from performing) one PRDCH across multiple R2D frequency bandwidths. Preferably in certain embodiments, an R2D frequency bandwidth may be/mean/replace any of a (R2D) bandwidth part or a (R2D) sub-channel or a (R2D) frequency unit. Alternatively, an R2D frequency bandwidth does not mean any of the R2D bandwidth part or R2D spectrum.

Preferably in certain embodiments, the D2R frequency bandwidth may be/mean (or include) frequency resources used for performing D2R transmission/reception. Preferably in certain embodiments, a D2R frequency bandwidth may be/mean (or include) frequency resources used for performing (only) one D2R transmission/reception. Preferably in certain embodiments, the D2R frequency bandwidth may be/mean a D2R frequency resource, e.g., used for performing one D2R transmission/reception. Preferably and/or alternatively in certain embodiments, the network/intermediate node may perform one PDRCH (restricted to be) within one D2R frequency bandwidth. Preferably in certain embodiments, the network/intermediate node may not perform (or prevent from performing) one PDRCH across multiple D2R frequency bandwidths. Preferably in certain embodiments, a D2R frequency bandwidth may be/mean/replace any of a (D2R) bandwidth part or a (D2R) sub-channel or a (D2R) frequency unit. Alternatively, a D2R frequency bandwidth does not mean any of a D2R bandwidth part or D2R spectrum.

Preferably in certain embodiments, the D2R may be/mean or be replaced/changed/represented as from the device/UE to the reader/network/intermediate node. Preferably in certain embodiments, the D2R may be/mean or be replaced/changed/represented as UL.

Preferably in certain embodiments, the R2D may be/mean or be replaced/changed/represented as from the reader/network/intermediate node to the device/UE. Preferably in certain embodiments, the R2D may be/mean or be replaced/changed/represented as DL.

Preferably in certain embodiments, the PDRCH may be/mean or be replaced/changed/represented as a channel/transmission from the device/UE to the reader/network/intermediate node. Preferably in certain embodiments, the PDRCH may be replaced by “physical channel for D2R (data and/or control) transmission”. Preferably in certain embodiments, the PDRCH transmission may be a transmission.

Preferably in certain embodiments, the PRDCH may be/mean or be replaced/changed/represented as a channel/transmission from the reader/network/intermediate node to the device/UE. Preferably in certain embodiments, the PRDCH may be replaced by “physical channel for R2D (data and/or control) transmission”.

Preferably in certain embodiments, the occasion/timing/TTI may be/mean or be replaced/changed/represented as a slot. Preferably in certain embodiments, the occasion/timing/TTI may be/mean or be replaced/changed/represented as a subframe. Preferably in certain embodiments, the occasion/timing/TTI may be/mean or be replaced/changed/represented as a sub-slot or mini-slot. Preferably in certain embodiments, the occasion/timing/TTI may consist of a number (e.g., a predefined/fixed/(pre-) configured or indicated number) of symbols in time domain.

Preferably in certain embodiments, the occasion/timing/TTI may be/mean or be replaced/changed/represented as a transmission occasion. Preferably in certain embodiments, the occasion/timing/TTI may be/mean or be replaced/changed/represented as a reception occasion.

Preferably in certain embodiments, the carrier wave (signal) above may be changed/represented/replaced as a DL signal/R2D or a DL/R2D channel. Preferably in certain embodiments, the carrier wave (signal) may be changed/represented/replaced as any signal for power source/supply (e.g., transmitted from the network node or intermediate node).

Preferably in certain embodiments, the first/second device/UE may receive/detect the carrier wave (signal) in the R2D frequency bandwidth. Preferably and/or alternatively in certain embodiments, the first/second device/UE may receive/detect the carrier wave (signal) in the D2R frequency bandwidth.

Preferably in certain embodiments, the first/second device/UE may perform the D2R transmission via backscatter on the carrier wave (signal), e.g., provided externally or via generated internally by the first/second device/UE.

Preferably in certain embodiments, the network/intermediate node may transmit an indication related to or about whether a (serving or camped on) cell (of the UE or the network/intermediate node) supports more than one D2R frequency bandwidth or not. Preferably in certain embodiments, the UE may receive the indication related to or about whether the (serving or camped on) cell (of the UE or the network/intermediate node) supports more than one D2R frequency bandwidth or not. Preferably in certain embodiments, the indication may be provided/transmitted/comprised in the paging/query information. Preferably in certain embodiments, the indication may be provided/transmitted/comprised in the specific indication/signaling. Alternatively and/or preferably in certain embodiments, the indication may be provided/transmitted/comprised in a configuration provided from the network/intermediate node. Alternatively and/or preferably in certain embodiments, the indication may be specified or (pre-) configured or fixed.

Throughout the present disclosure, the “DL” may be replaced by “Reader to Device (R2D).” A DL transmission may be, be referred to, and/or be supplemented by a transmission from a reader to a device and/or an R2D transmission. A DL data may be, be referred to, and/or be supplemented by a data available on a reader side, a data to be transmitted from a reader to a device, and/or an R2D data. A DL transmission and/or DL data may comprise an indication, configuration, signal/signaling/signalling, and/or message from a reader.

Throughout the present disclosure, the “UL” may be replaced by “Device to Reader (D2R).” A UL transmission may be, be referred to, and/or be supplemented by a transmission from a device to a reader and/or a D2R transmission. A UL data may be, be referred to, and/or be supplemented by a data available on a device side, a data to be transmitted from a device to a reader, and/or a D2R data. A UL transmission and/or UL data may comprise an indication, signal/signaling, and/or message from a device. A UL grant may be one or more resources provided from the reader/NW/intermediate node, used by the device/UE, and/or used to transmit/perform the D2R transmission.

Throughout the present disclosure, the reader may be and/or be replaced by a NW, UE, interrogator, and/or intermediate node. Throughout the present disclosure, the device may be and/or be replaced by a UE, tag, and/or intermediate node. The device may be referred to as an ambient IoT device. The “UE” may comprise a reader, tag, and/or device. The “NW/intermediate node” may comprise a reader and/or interrogator.

The UE/device may receive a carrier wave(s) from a reader. The UE/device may receive a carrier wave(s) from a node other than the reader.

Throughout the present disclosure, the backscattering (BS) may be replaced by “Device to Reader (D2R)” or “UL”. The backscattering transmission may be, be referred to, and/or be supplemented by a transmission from a device to a reader and/or a D2R transmission, e.g., PDRCH.

The UE may be referred to as the UE, a Radio Resource Control (RRC) layer of the UE, a Medium Access Control (MAC) entity of the UE, or a physical layer of the UE.

Throughout the present disclosure, the UE may be an ambient IoT device/UE. The UE may be a device used for ambient IoT. The UE may be a device capable of ambient IoT. The UE may be an NR device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: UE, (ambient IoT) device.

The UE may not be a legacy UE. The legacy UE may be a non-ambient IoT device. The legacy UE may perform different procedures from the ambient IoT UE. The UE may be a legacy UE with capability to perform an ambient IoT procedure.

The network may be a network node. The network may be a base station. The network may be an access point. The network may be an eNB. The network may be a gNB. The network may be a gateway. The network may be an interrogator. The network may be a reader.

Various examples and embodiments of the present invention are described below. For the methods, alternatives, concepts, examples, and embodiments detailed above and herein, the following aspects and embodiments are possible.

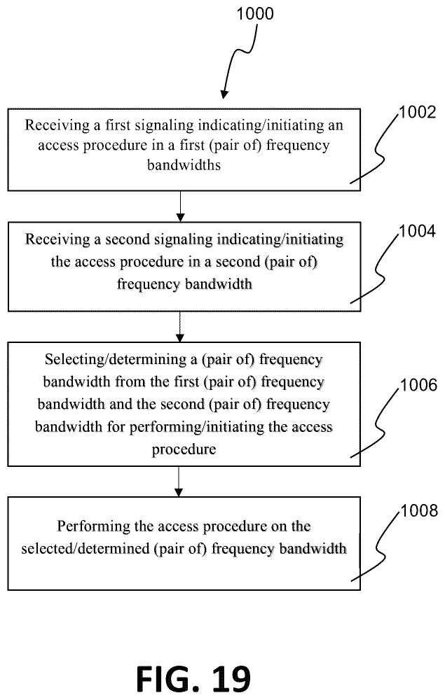

Referring to FIG. 19, with this and other concepts, systems, and methods of the present invention, a method 1000 for a UE in a wireless communication system comprises receiving a first signaling indicating/initiating an access procedure in a first (pair of) frequency bandwidths (step 1002), receiving a second signaling indicating/initiating the access procedure in a second (pair of) frequency bandwidth (step 1004), selecting/determining a (pair of) frequency bandwidth from the first (pair of) frequency bandwidth and the second (pair of) frequency bandwidth for performing/initiating the access procedure (step 1006), and performing the access procedure on the selected/determined (pair of) frequency bandwidth (step 1008).

In various embodiments, the first signaling is/comprises a first paging/query information and/or a first R2D signal. In various embodiments, the second signaling is/comprises a second paging/query information and/or a second R2D signal.

In various embodiments, the first signaling and/or the second signalling indicates (identifier of) the UE.

In various embodiments, the UE satisfies one or more first conditions indicated in the first signaling, and/or the UE satisfies one or more second conditions indicated in the second signaling.

In various embodiments, the UE performs the selection/determination based on whether there is a contention-free access procedure indicated in the first and/or the second signaling.

In various embodiments, the UE performs the selection/determination based on priority information indicated in the first and/or the second signaling.

In various embodiments, the UE performs the selection/determination based on a frequency shift associated with the first and/or the second (pair of) frequency bandwidth.

In various embodiments, the UE performs the selection/determination based on a starting timing of the access procedure in the first and/or the second (pair of) frequency bandwidth.

In various embodiments, the UE performs the selection/determination based on a value associated with the number of the access occasions in the first and/or the second (pair of) frequency bandwidth.

In various embodiments, the access procedure comprises a first D2R signal/transmission and/or a first valid R2D response associated with the first D2R signal/transmission.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling indicating/initiating an access procedure in a first (pair of) frequency bandwidths; (ii) receive a second signaling indicating/initiating the access procedure in a second (pair of) frequency bandwidth; (iii) select/determine a (pair of) frequency bandwidth from the first (pair of) frequency bandwidth and the second (pair of) frequency bandwidth for performing/initiating the access procedure; and (iv) perform the access procedure on the selected/determined (pair of) frequency bandwidth. Moreover, the CPU 308 can execute the program code 312 to perform all of the described actions, steps, and methods described above, below, or otherwise herein.

Referring back to FIGS. 3 and 4, in one or more embodiments from the perspective of a network in a wireless communication system, the device 300 includes a program code 312 stored in memory 310 of the transmitter. The CPU 308 could execute program code 312 to: (i) transmit, to a UE, a first signaling indicating/initiating an access procedure in a first (pair of) frequency bandwidths; (ii) transmit, to the UE, a second signaling indicating/initiating the access procedure in a second (pair of) frequency bandwidth; and (iii) perform an access procedure on a (pair of) frequency bandwidth (selected/determined/indicated by the UE) from the first (pair of) frequency bandwidth and the second (pair of) frequency bandwidth. Moreover, the CPU 308 can execute the program code 312 to perform all of the described actions, steps, and methods described above, below, or otherwise herein.

Various other examples and embodiments of the present invention are described below. For the methods, alternatives, concepts, examples, and embodiments detailed above and herein, the following aspects and embodiments are possible.

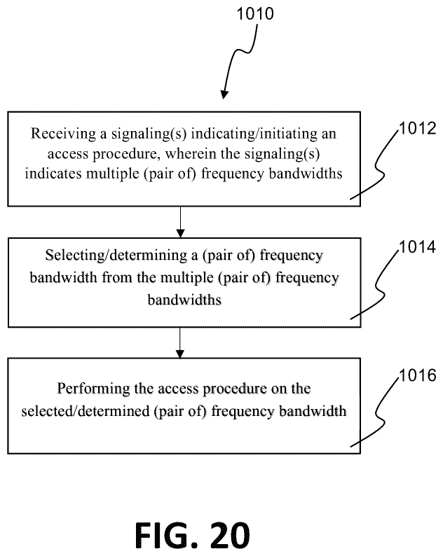

Referring to FIG. 20, with this and other concepts, systems, and methods of the present invention, a method 1010 for a UE in a wireless communication system comprises receiving a signaling(s) indicating/initiating an access procedure, wherein the signaling(s) indicates multiple (pair of) frequency bandwidths (step 1012), selecting/determining a (pair of) frequency bandwidth from the multiple (pair of) frequency bandwidths (step 1014), and performing the access procedure on the selected/determined (pair of) frequency bandwidth (step 1016).

In various embodiments, the signaling is/comprises paging/query information.

In various embodiments, the multiple (pair of) frequency bandwidths comprise at least a second (pair of) frequency bandwidth and a first (pair of) frequency bandwidth.

In various embodiments, the access procedure comprises a first D2R signal/transmission and/or a first valid R2D response associated with the first D2R signal/transmission.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a signaling(s) indicating/initiating an access procedure, wherein the signaling(s) indicates multiple (pair of) frequency bandwidths; (ii) select/determine a (pair of) frequency bandwidth from the multiple (pair of) frequency bandwidths; and (iii) perform the access procedure on the selected/determined (pair of) frequency bandwidth. Moreover, the CPU 308 can execute the program code 312 to perform all of the described actions, steps, and methods described above, below, or otherwise herein.

Referring back to FIGS. 3 and 4, in one or more embodiments from the perspective of a network in a wireless communication system, the device 300 includes a program code 312 stored in memory 310 of the transmitter. The CPU 308 could execute program code 312 to: (i) transmit, to a UE, a signaling(s) indicating/initiating an access procedure, wherein the signaling(s) indicates multiple (pair of) frequency bandwidths; and (ii) perform an access procedure on a (pair of) frequency bandwidth (selected/determined/indicated by the UE) from the multiple (pair of) frequency bandwidths. Moreover, the CPU 308 can execute the program code 312 to perform all of the described actions, steps, and methods described above, below, or otherwise herein.

Various other examples and embodiments of the present invention are described below. For the methods, alternatives, concepts, examples, and embodiments detailed above and herein, the following aspects and embodiments are possible.

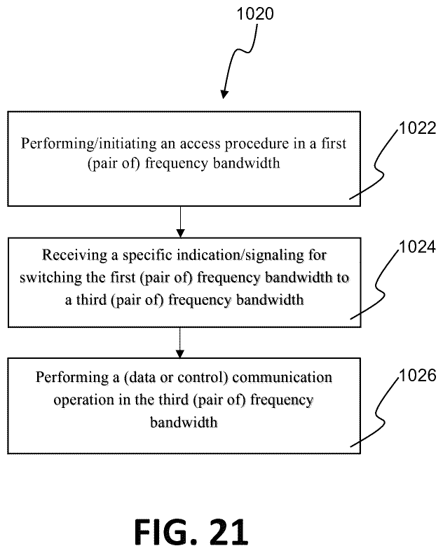

Referring to FIG. 21, with this and other concepts, systems, and methods of the present invention, a method 1020 for a UE in a wireless communication system comprises performing/initiating an access procedure in a first (pair of) frequency bandwidth (step 1022), receiving a specific indication/signaling for switching the first (pair of) frequency bandwidth to a third (pair of) frequency bandwidth (step 1024), and performing a (data or control) communication operation in the third (pair of) frequency bandwidth (step 1026).

In various embodiments, the UE receives the specific indication/signaling after transmitting a (D2R) signal/transmission in the access procedure to a network/intermediate node, and/or the UE receives the specific indication/signaling after transmitting a UE information of the UE in the access procedure to the network/intermediate node, and/or the UE receives the specific indication/signaling after completion of the access procedure.

In various embodiments, the access procedure comprises (at least) a first D2R signal/transmission and/or a first valid R2D response associated with the first D2R signal/transmission.

In various embodiments, the specific indication/signaling comprises information of the third (pair of) frequency bandwidth and/or a switch information. The switch information may be/include whether to switch (pair of) frequency bandwidth.

In various embodiments, the third (pair of) frequency bandwidth is different from the first (pair of) frequency bandwidth.

In various embodiments, the communication operation comprises a second D2R signal(s)/transmission(s) and/or a second R2D signal(s)/transmission(s).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) perform/initiate an access procedure in a first (pair of) frequency bandwidth; (ii) receive a specific indication/signaling for switching the first (pair of) frequency bandwidth to a third (pair of) frequency bandwidth; and (iii) perform a (data or control) communication operation in the third (pair of) frequency bandwidth. Moreover, the CPU 308 can execute the program code 312 to perform all of the described actions, steps, and methods described above, below, or otherwise herein.

Referring back to FIGS. 3 and 4, in one or more embodiments from the perspective of a network in a wireless communication system, the device 300 includes a program code 312 stored in memory 310 of the transmitter. The CPU 308 could execute program code 312 to: (i) perform an access procedure in a first (pair of) frequency bandwidth with at least a UE; (ii) transmit, to the UE, a specific indication/signaling for switching the first (pair of) frequency bandwidth to a third (pair of) frequency bandwidth; and (iii) perform a (data or control) communication operation in the third (pair of) frequency bandwidth with the UE. Moreover, the CPU 308 can execute the program code 312 to perform all of the described actions, steps, and methods described above, below, or otherwise herein.

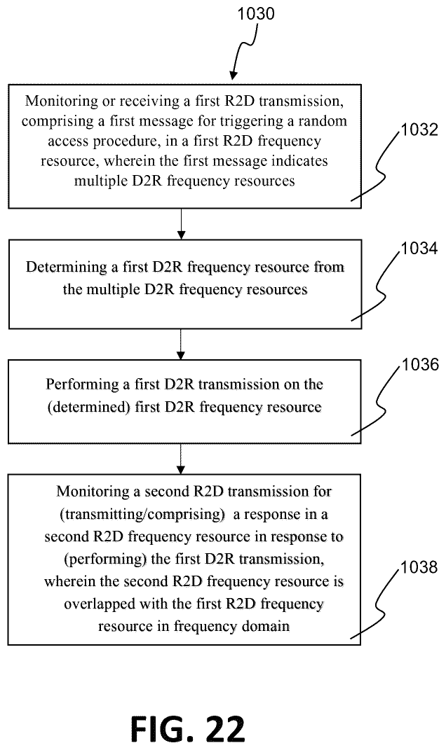

Referring to FIG. 22, with this and other concepts, systems, and methods of the present invention, a method 1030 for a first device in a wireless communication system comprises monitoring or receiving a first R2D transmission, comprising a first message for triggering a random access procedure, in a first R2D frequency resource, wherein the first message indicates multiple D2R frequency resources (step 1032), determining a first D2R frequency resource from the multiple D2R frequency resources (step 1034), performing a first D2R transmission on the (determined) first D2R frequency resource (step 1036), and monitoring a second R2D transmission for (transmitting/comprising) a response in a second R2D frequency resource in response to (performing) the first D2R transmission, wherein the second R2D frequency resource is overlapped with the first R2D frequency resource in frequency domain (step 1038).

In various embodiments, the first device determines the second R2D frequency resource based on the first R2D frequency resource where the first device monitors or receives the first R2D transmission or the first message, and/or a center frequency of the second R2D frequency resource is same as a center frequency of the first R2D frequency resource, and/or the second R2D frequency resource comprises the first R2D frequency resource, and/or the second R2D frequency resource is comprised in the first R2D frequency resource, and/or the second R2D frequency resource is same or identical to the first R2D frequency resource, and/or the first device restricts monitoring of the second R2D transmission for (transmitting/comprising) the response in the second R2D frequency resource, and/or the first device does not monitor the second R2D transmission for (transmitting/comprising) the response in frequency resources outside the second R2D frequency resource, and/or the first device monitors the second R2D transmission for (transmitting/comprising) the response only in the second R2D frequency resource, and/or the first device monitors the second R2D transmission for (transmitting/comprising) the response in the same or identical first R2D frequency resource where the first device receives the first R2D transmission or the first message.

In various embodiments, the first R2D frequency resource means/is a first R2D frequency bandwidth or a first R2D frequency unit, and/or the first R2D frequency resource is within the first R2D frequency bandwidth, and/or the second R2D frequency resource means/is a second R2D frequency bandwidth or a second R2D frequency unit, and/or the second R2D frequency resource is within the second R2D frequency bandwidth, and/or the multiple D2R frequency resources mean multiple D2R frequency bandwidths or multiple D2R frequency units, and/or each of the multiple D2R frequency resources is respectively or separately within each of the multiple D2R frequency bandwidths.

In various embodiments, the first message comprises a paging message for triggering the random access procedure, and/or the first message comprises the paging message for ambient IoT, and/or the first message indicates one or more devices comprising the first device, and/or the first message indicates multiple frequency shifts corresponding to the multiple D2R frequency resources.

In various embodiments, the first message indicates the multiple D2R frequency resources and one or more D2R (timing) occasions, and/or the first device monitors the second R2D transmission for (transmitting/comprising) the response in the second R2D frequency resource in one or more R2D (timing) occasions or within a time duration, and/or the one or more D2R (timing) occasions are not overlapped with the one or more R2D (timing) occasions in time domain.

In various embodiments, the multiple D2R frequency resources are not overlapped with the first R2D frequency resource, and/or the multiple D2R frequency resources are not overlapped with the second R2D frequency resource, and/or the multiple D2R frequency resources are not overlapped with each other in frequency domain.

In various embodiments, the first R2D transmission or the first message is transmitted from a reader, and/or the first device performs the first D2R transmission to the reader, and/or the reader is a network node, an intermediate node, or a second UE.

In various embodiments, the first device is an ambient IoT device or a first UE.

In various embodiments, the method further comprises receiving a third R2D transmission comprising an indication or message for switching or adjusting to a third R2D frequency resource, and (starting to) receiving or monitoring a fourth R2D transmission in the third R2D frequency resource.

In various embodiments, the first device receives the indication or message after transmitting the first D2R transmission in the random access procedure, and/or the first device receives the indication or message after transmitting or providing a device information of the first device in the random access procedure, and/or the first device receives the indication or message after completion of the random access procedure.

In various embodiments, the first device receives the third R2D transmission in the second R2D frequency resource, and/or the indication or message comprises information of the third R2D frequency resource.

In various embodiments, the method further comprises (starting to) performing a communication operation at least in the third R2D frequency resource in response to receiving the indication or message, and/or not performing monitoring in the second R2D frequency resource in response to (receiving) the indication or message.

In various embodiments, the third R2D frequency resource is same or identical to the second R2D frequency resource, and/or the third R2D frequency resource is different or independent from the first R2D frequency resource or the second R2D frequency resource, and/or the third R2D frequency resource is not overlapped with the first R2D frequency resource or the second R2D frequency resource in frequency domain, and/or the third R2D transmission is different from the second R2D transmission or the third R2D transmission is same or identical to the second R2D transmission.

Referring back to FIGS. 3 and 4, in one or more embodiments from the perspective of a first device in a wireless communication system, the device 300 includes a program code 312 stored in memory 310 of the transmitter. The CPU 308 could execute program code 312 to: (i) monitor or receive a first R2D transmission, comprising a first message for triggering a random access procedure, in a first R2D frequency resource, wherein the first message indicates multiple D2R frequency resources; (ii) determine a first D2R frequency resource from the multiple D2R frequency resources; (iii) perform a first D2R transmission on the (determined) first D2R frequency resource; and (iv) monitor a second R2D transmission for (transmitting/comprising) a response in a second R2D frequency resource in response to (performing) the first D2R transmission, wherein the second R2D frequency resource is overlapped with the first R2D frequency resource in frequency domain. Moreover, the CPU 308 can execute the program code 312 to perform all of the described actions, steps, and methods described above, below, or otherwise herein.

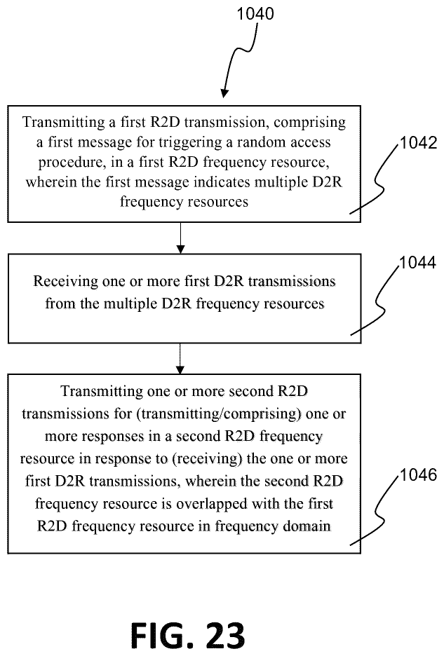

Referring to FIG. 23, with this and other concepts, systems, and methods of the present invention, a method 1040 for a reader in a wireless communication system comprises transmitting a first R2D transmission, comprising a first message for triggering a random access procedure, in a first R2D frequency resource, wherein the first message indicates multiple D2R frequency resources (step 1042), receiving one or more first D2R transmissions from the multiple D2R frequency resources (step 1044), and transmitting one or more second R2D transmissions for (transmitting/comprising) one or more responses in a second R2D frequency resource in response to (receiving) the one or more first D2R transmissions, wherein the second R2D frequency resource is overlapped with the first R2D frequency resource in frequency domain (step 1046).

In various embodiments, the reader determines the second R2D frequency resource based on the first R2D frequency resource where the first R2D transmission or the first message is transmitted, and/or a center frequency of the second R2D frequency resource is same as a center frequency of the first R2D frequency resource, and/or the second R2D frequency resource comprises the first R2D frequency resource, and/or the second R2D frequency resource is comprised in the first R2D frequency resource, and/or the second R2D frequency resource is same or identical to the first R2D frequency resource, and/or the reader restricts transmission of the one or more second R2D transmissions for (transmitting/comprising) the one or more responses in the second R2D frequency resource, and/or the reader is not allowed to transmit the one or more second R2D transmissions for (transmitting/comprising) the one or more responses in frequency resources outside the second R2D frequency resource, and/or the reader transmits the one or more second R2D transmissions for (transmitting/comprising) the one or more responses only in the second R2D frequency resource, and/or the reader transmits the one or more second R2D transmissions for (transmitting/comprising) the one or more responses in the same or identical first R2D frequency resource where the reader transmits the first R2D transmission or the first message.

In various embodiments, the first R2D frequency resource means/is a first R2D frequency bandwidth or a first R2D frequency unit, and/or the first R2D frequency resource is within the first R2D frequency bandwidth, and/or the second R2D frequency resource means/is a second R2D frequency bandwidth or a second R2D frequency unit, and/or the second R2D frequency resource is within the second R2D frequency bandwidth, and/or the multiple D2R frequency resources mean multiple D2R frequency bandwidths or multiple D2R frequency units, and/or each of the multiple D2R frequency resources is respectively or separately within each of the multiple D2R frequency bandwidths.

In various embodiments, the first message comprises a paging message for triggering the random access procedure, and/or the first message comprises the paging message for ambient IoT, and/or the first message indicates one or more devices, and/or the first message indicates multiple frequency shifts corresponding to the multiple D2R frequency resources.

In various embodiments, the first message indicates the multiple D2R frequency resources and one or more D2R (timing) occasions, and/or the reader transmits the one or more second R2D transmissions for (transmitting/comprising) the one or more responses in the second R2D frequency resource in one or more R2D (timing) occasions or within a time duration, and/or the one or more D2R (timing) occasions are not overlapped with the one or more R2D (timing) occasions in time domain.

In various embodiments, the multiple D2R frequency resources are not overlapped with the first R2D frequency resource, and/or the multiple D2R frequency resources are not overlapped with the second R2D frequency resource, and/or the multiple D2R frequency resources are not overlapped with each other in frequency domain.

In various embodiments, the one or more first D2R transmissions are transmitted from the one or more devices.

In various embodiments, the first R2D transmission and/or the first message is transmitted to the one or more devices.

In various embodiments, the reader is a network node, an intermediate node, or a UE.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a first R2D transmission, comprising a first message for triggering a random access procedure, in a first R2D frequency resource, wherein the first message indicates multiple D2R frequency resources; (ii) receive one or more first D2R transmissions from the multiple D2R frequency resources; and (iii) transmit one or more second R2D transmissions for (transmitting/comprising) one or more responses in a second R2D frequency resource in response to (receiving) the one or more first D2R transmissions, wherein the second R2D frequency resource is overlapped with the first R2D frequency resource in frequency domain. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a first device, comprising:
monitoring or receiving a first Reader-to-Device (R2D) transmission, comprising a first message for triggering a random access procedure, in a first R2D frequency resource, wherein the first message indicates multiple Device-to-Reader (D2R) frequency resources;
determining a first D2R frequency resource from the multiple D2R frequency resources;
performing a first D2R transmission on the first D2R frequency resource; and
monitoring a second R2D transmission for a response in a second R2D frequency resource in response to performing the first D2R transmission, wherein the second R2D frequency resource is overlapped with the first R2D frequency resource in frequency domain.

2. The method of claim 1, wherein:
the first device determines the second R2D frequency resource based on the first R2D frequency resource where the first device monitors or receives the first R2D transmission or the first message,
a center frequency of the second R2D frequency resource is same as a center frequency of the first R2D frequency resource,
the second R2D frequency resource comprises the first R2D frequency resource,
the second R2D frequency resource is comprised in the first R2D frequency resource,
the second R2D frequency resource is same or identical to the first R2D frequency resource,
the first device restricts monitoring of the second R2D transmission for the response in the second R2D frequency resource,
the first device does not monitor the second R2D transmission for the response in frequency resources outside the second R2D frequency resource,
the first device monitors the second R2D transmission for the response only in the second R2D frequency resource, and/or
the first device monitors the second R2D transmission for the response in the same or identical first R2D frequency resource where the first device receives the first R2D transmission or the first message.

3. The method of claim 1, wherein:
the first R2D frequency resource means a first R2D frequency bandwidth or a first R2D frequency unit,
the first R2D frequency resource is within the first R2D frequency bandwidth,
the second R2D frequency resource means a second R2D frequency bandwidth or a second R2D frequency unit,
the second R2D frequency resource is within the second R2D frequency bandwidth,
the multiple D2R frequency resources mean multiple D2R frequency bandwidths or multiple D2R frequency units, and/or
each of the multiple D2R frequency resources is respectively or separately within each of the multiple D2R frequency bandwidths.

4. The method of claim 1, wherein:
the first message comprises a paging message for triggering the random access procedure,
the first message comprises the paging message for ambient Internet of Things (IoT),
the first message indicates one or more devices comprising the first device, and/or
the first message indicates multiple frequency shifts corresponding to the multiple D2R frequency resources.

5. The method of claim 1, wherein:
the first message indicates the multiple D2R frequency resources and one or more D2R occasions,
the first device monitors the second R2D transmission for the response in the second R2D frequency resource in one or more R2D occasions or within a time duration, and/or
the one or more D2R occasions are not overlapped with the one or more R2D occasions in time domain.

6. The method of claim 1, wherein:
the multiple D2R frequency resources are not overlapped with the first R2D frequency resource,
the multiple D2R frequency resources are not overlapped with the second R2D frequency resource, and/or
the multiple D2R frequency resources are not overlapped with each other in frequency domain.

7. The method of claim 1, wherein:
the first R2D transmission or the first message is transmitted from a reader,
the first device performs the first D2R transmission to the reader, and/or
the reader is a network node, an intermediate node, or a User Equipment (UE).

8. The method of claim 1, further comprising:
receiving a third R2D transmission comprising an indication or message for switching or adjusting to a third R2D frequency resource; and
receiving or monitoring a fourth R2D transmission in the third R2D frequency resource.

9. The method of claim 8, wherein:
the first device receives the indication or message after transmitting the first D2R transmission in the random access procedure,
the first device receives the indication or message after transmitting or providing a device information of the first device in the random access procedure, and/or
the first device receives the indication or message after completion of the random access procedure.

10. The method of claim 8, wherein the first device receives the third R2D transmission in the second R2D frequency resource, and/or wherein the indication or message comprises information of the third R2D frequency resource.

11. The method of claim 8, further comprising:
performing a communication operation at least in the third R2D frequency resource in response to receiving the indication or message; and/or
not performing monitoring in the second R2D frequency resource in response to receiving the indication or message.

12. The method of claim 8, wherein:
the third R2D frequency resource is same or identical to the second R2D frequency resource,
the third R2D frequency resource is different or independent from the first R2D frequency resource or the second R2D frequency resource,
the third R2D frequency resource is not overlapped with the first R2D frequency resource or the second R2D frequency resource in frequency domain, and/or
the third R2D transmission is different from the second R2D transmission or the third R2D transmission is same or identical to the second R2D transmission.

13. A method for a reader, comprising:
transmitting a first Reader-to-Device (R2D) transmission, comprising a first message for triggering a random access procedure, in a first R2D frequency resource, wherein the first message indicates multiple Device-to-Reader (D2R) frequency resources;
receiving one or more first D2R transmissions from the multiple D2R frequency resources; and
transmitting one or more second R2D transmissions for one or more responses in a second R2D frequency resource in response to receiving the one or more first D2R transmissions, wherein the second R2D frequency resource is overlapped with the first R2D frequency resource in frequency domain.

14. The method of claim 13, wherein:
the reader determines the second R2D frequency resource based on the first R2D frequency resource where the first R2D transmission or the first message is transmitted,
a center frequency of the second R2D frequency resource is same as a center frequency of the first R2D frequency resource,
the second R2D frequency resource comprises the first R2D frequency resource,
the second R2D frequency resource is comprised in the first R2D frequency resource,
the second R2D frequency resource is same or identical to the first R2D frequency resource,
the reader restricts transmission of the one or more second R2D transmissions for the one or more responses in the second R2D frequency resource,
the reader is not allowed to transmit the one or more second R2D transmissions for the one or more responses in frequency resources outside the second R2D frequency resource,
the reader transmits the one or more second R2D transmissions for the one or more responses only in the second R2D frequency resource, and/or
the reader transmits the one or more second R2D transmissions for the one or more responses in the same or identical first R2D frequency resource where the reader transmits the first R2D transmission or the first message.

15. The method of claim 13, wherein:
the first R2D frequency resource means a first R2D frequency bandwidth or a first R2D frequency unit,
the first R2D frequency resource is within the first R2D frequency bandwidth,
the second R2D frequency resource means a second R2D frequency bandwidth or a second R2D frequency unit,
the second R2D frequency resource is within the second R2D frequency bandwidth,
the multiple D2R frequency resources mean multiple D2R frequency bandwidths or multiple D2R frequency units, and/or
each of the multiple D2R frequency resources is respectively or separately within each of the multiple D2R frequency bandwidths.

16. The method of claim 13, wherein:
the first message comprises a paging message for triggering the random access procedure,
the first message comprises the paging message for ambient Internet of Things (IoT),
the first message indicates one or more devices, and/or
the first message indicates multiple frequency shifts corresponding to the multiple D2R frequency resources.

17. The method of claim 13, wherein:
the first message indicates the multiple D2R frequency resources and one or more D2R occasions,
the reader transmits the one or more second R2D transmissions for the one or more responses in the second R2D frequency resource in one or more R2D occasions or within a time duration, and/or
the one or more D2R occasions are not overlapped with the one or more R2D occasions in time domain.

18. The method of claim 13, wherein:
the multiple D2R frequency resources are not overlapped with the first R2D frequency resource,
the multiple D2R frequency resources are not overlapped with the second R2D frequency resource, and/or
the multiple D2R frequency resources are not overlapped with each other in frequency domain.

19. The method of claim 13, wherein the one or more first D2R transmissions are transmitted from one or more devices, and/or wherein the reader is a network node, an intermediate node, or a User Equipment (UE).
